(19) United States
(12) Patent Application Publication
(10) Pub. No.: US 2005/0273277 A1
(43) Pub. Date: Dec. 8, 2005

(54) Vehicle fatigue life and durability monitoring system and methodology

(75) Inventors: James Andrew Ridnour, Powell, TN (US); Jeffrey S. Freeman, Blaine, TN (US)

Correspondence Address: JENKINS, WILSON & TAYLOR, P. A., 3100 TOWER BLVD, SUITE 1400, DURHAM, NC, 27707, US

(73) Assignee: University of Tennessee Research Foundation, Inc.

(21) Appl. No.: 11/036,830

(22) Filed: Jan. 14, 2005

Related U.S. Application Data
(60) Provisional application No. 60/536,306, filed on Jan. 14, 2004.

(51) Int. Cl. G01L 1/00

(52) U.S. Cl. 702/42

(57) ABSTRACT

Apparatuses and methods for determining the useful life status of a structure, such as a vehicular trailer, by predicting failure at a specific location on the structure are disclosed. The system includes one or more sensors placed at one or more selected locations on the structure, the selected locations being apart from the specific location, for generating data signals related to one or more variables measured at the selected locations. A network is included for gathering and combining the data signals generated by the one or more sensors. A processor is included for comparing the data signals with a predetermined expected failure value in order to predict failure at the specific location on the structure, thereby determining the useful life status of the structure.

### RELATED APPLICATION

This application claims the benefit of U.S. Provisional Patent Application Ser. No. 60/536,306, filed Jan. 14, 2004; the disclosure of which is incorporated herein by reference in its entirety.

### GOVERNMENT INTEREST

The subject matter disclosed herein was made with U.S. Government support under Grant No. DMDO5-01-P-0999 awarded by U.S. Army AMSAA. The U.S. Government has certain rights in the presently disclosed subject matter.

### TECHNICAL FIELD

The subject matter disclosed herein relates generally to vehicle durability monitoring, and more particularly to directly predicting fatigue life of a vehicle by determining the stress/strain at a failure location from a series of sensors placed at strategic locations on the vehicle.

### RELATED ART

Vehicle durability, which defines the useful life of a vehicle, is a high priority for some consumers. Life consumption monitoring can be used to determine fatigue damage by directly or indirectly monitoring the loads placed on critical vehicle components that are susceptible to failure from fatigue damage. The current state of the art is to indirectly determine the fatigue life of a vehicle from the operational modes of the vehicle. By contrast, applicants' invention as described and claimed herein directly determines the fatigue life of a vehicle using a model to determine the stress/strain at the failure location of the vehicle from a series of sensors strategically placed on the vehicle.

More specifically, applicants' invention can predict strain at hot spot or failure locations using measured accelerations from sensors positioned at other locations on the vehicle. This is fundamentally different than other vehicle failure prediction technologies currently known in the art.

In general, presently known vehicle fatigue failure technologies known in the art are of two types. One approach is to predict the amount of time spent performing specific operational modes. The modes are then compared to a list of previously determined limits for each of the operational modes in order to estimate the time to failure. Another approach is to perform some type of pattern recognition to detect changes in the time domain or frequency domain response. Depending on the application, these changes can be used to predict impending failure of the vehicle.

In the first methodology, the determination of the operational modes is done using accelerometers and/or other vehicle mounted transducers, sometimes coupled with the measurement of operator inputs. A wide variety of methods, including regression analysis, neural networks, and magnitude comparison of specific frequencies have been used to relate the sensor information to the operational mode. None of these methods have been particularly successful in predicting vehicle life-consumption. The second methodology referenced above has proven useful in situations where the point of failure is known a priori, such as bearing failures of rotation machinery. Time-series analysis methods are widely accepted by industry for these types of applications. Modal-based (frequency domain) methods have been successful in determining when damage is present in a structure, and possibly the geometric location of the damage. However, modal identification is usually performed in a controlled environment and is not a practical solution for ground vehicle applications due to the cost and time per vehicle.

Relevant patents of interest include the following: U.S. Pat. Nos. 6,647,161; 6,480,792; 6,399,939; 4,764,882; 4,590,804; and 4,255,978. All of these representative patents relate to ongoing monitoring of fatigue through a variety of methods, but these patents do not address the prediction of future fatigue issues through detailed analysis of correlated data from different parts of the vehicle. Applicants have developed such a technology, and it is believed to be unexpectedly and surprisingly superior to all known vehicle fatigue life predictive technologies.

Applicants believe that there is a long-felt need for the highly accurate vehicle fatigue life and durability monitoring system and methodology of the present invention as described and claimed hereinbelow.

### SUMMARY OF THE INVENTION

A system has been discovered for determining the useful life status of a structure by predicting failure at a specific location on the structure. The system includes one or more sensors placed at one or more selected locations on the structure, the selected locations being apart from the failure location. The one or more sensors generate data signals related to one or more variables measured at the selected locations. A network is provided for gathering and combining the data signals generated by the one or more sensors, and a processor is provided for comparing the data signals with a predetermined expected failure value in order to predict failure at the specific failure location on the structure and thereby provide information relating to the useful life status of the structure.

Also, a method is provided by the discovery for determining the useful life status of a structure by predicting failure at a specific location on the structure. The method includes the steps of providing a structure such as a vehicle. Next, one or more sensors are placed at one or more selected locations on the structure wherein the selected locations are separate and apart from the specific failure location. Next, data generals are generated in relation to one ore more variables that are measured at the selected locations on the structure, and the generated data signals are gathered and combined. Finally, the data signals are compared with a predetermined expected failure value in order to predict structural failure at the specific location on the structure and thereby provide information regarding the useful life status of the structure.

It is therefore an object to provide a system and method that provides for real time life consumption monitoring of a vehicle.

It is another object to provide a system and method for predicting the fatigue life of a vehicle with one or more sensors placed at selected locations on the vehicle which provide predictive data regarding the fatigue life of a specific failure location on the vehicle.

Objects having been stated hereinabove, and which are achieved in whole or in part by the subject matter disclosed herein, other objects will become evident as the description proceeds when taken in connection with the accompanying drawings as best described hereinbelow.

### BRIEF DESCRIPTION OF THE DRAWINGS

FIG. 1A and 1B are top and side schematic views, respectively, of the vehicle fatigue life and durability monitoring system applied to a high mobility trailer vehicle (HMT);

FIG. 2 is a drawing of a strain gauge rosette at the failure location of the HMT;

FIG. 3 is a drawing of accelerometers and strain gauges on the drawbar of the HMT;

FIG. 4 is a drawing of the HMT testing instrumentation on the cargo box;

FIG. 5 is a drawing of the tri-axial accelerometer and rate gyro at the trailer CG location;

FIG. 6 is a graph of the longitudinal strain averages for each rosette direction;

FIG. 7 is a graph of the longitudinal strain peaks for each rosette direction;

FIG. 8 is a graph of the longitudinal strain RMS for each rosette direction;

FIG. 9 is a graph of the longitudinal strain percentiles for each rosette direction (brakes disabled);

FIG. 10 is a graph of the longitudinal strain percentiles for each rosette direction (brakes enabled);

FIG. 11 is a graph of comparing strain and principal strain;

FIG. 12 is a graph of the average vertical accelerations for several trailer locations;

FIG. 13 is a graph of the average transverse accelerations for several trailer locations;

FIG. 14 is a graph of the average longitudinal accelerations for several trailer locations;

FIG. 15 is a graph of the vertical RMS accelerations for several trailer locations;

FIG. 16 is a graph of the transverse RMS accelerations for several trailer locations;

FIG. 17 is a graph of the longitudinal RMS accelerations for several trailer locations;

FIG. 18 is a graph of the peak vertical accelerations for several trailer locations;

FIG. 19 is a graph of the peak transverse accelerations for several trailer locations;

FIG. 20 is a graph of the peak longitudinal accelerations for several trailer locations;

FIG. 21 is a graph of the vertical acceleration statistics for several trailer locations (brakes disabled);

FIG. 22 is a graph of the vertical acceleration statistics for several trailer locations (brakes enabled);

FIG. 23 is a graph of the transverse acceleration statistics for several trailer locations (brakes disabled);

FIG. 24 is a graph of the transverse acceleration statistics for several trailer locations (brakes enabled);

FIG. 25 is a graph of the longitudinal acceleration statistics for several trailer locations (brakes disabled);

FIG. 26 is a graph of the longitudinal acceleration statistics for several trailer locations (brakes enabled);

FIG. 27 is a graph of the trailer CG pitch rate statistics;

FIG. 28 is a graph of the trailer CG roll rate statistics;

FIG. 29 is a graph of the trailer CG yaw rate statistics;

FIG. 30 is a graph of the trailer CS shock displacement statistics;

FIG. 31 is a graph of the trailer RS shock displacement statistics;

FIG. 32 is a graph of the trailer master cylinder pressure statistics;

FIG. 33 is a graph of the trailer CS wheel cylinder pressure statistics;

FIG. 34 is a graph of the trailer RS wheel cylinder pressure statistics;

FIG. 35 is a graph of the principal strain 1 for experimental and simulated data;

FIG. 36 is a graph of the principal strain 2 for experimental and simulated data;

FIG. 37 is a graph of the PSD of principal strain 1 for experimental and simulated data;

FIG. 38 is a graph of the PSD of principal strain 2 for experimental and simulated data;

FIG. 39 is a graph of the PSD conversion Fortran subroutine;

FIG. 40 is a graph of the Belgian Block terrain data;

FIG. 41 is a graph of the Perryman #3 terrain data;

FIG. 42 is a graph of the Belgian Block FFT;

FIG. 43 is a graph of the Perryman #3 FFT;

FIG. 44 is a graph of the Belgian Block PSD;

FIG. 45 is a graph of the Perryman #3 PSD;

FIG. 46 is a drawing of the typical hydraulic surge brake hitch assembly;

FIG. 47 is a graph of the surge brake response for Belgian Block at 15 mph with brakes enabled;

FIG. 48 is a graph of the surge brake response for Belgian Block at 15 mph with brakes disabled;

FIG. 49 is a graph of the surge brake response for Perryman #3 test course at 15 mph with brakes enabled;

FIG. 50 is a graph of the surge brake response for Perryman #3 at 15 mph with brakes disabled;

FIG. 51 is a graph of the residual plot for Belgian Block at 15 mph with brakes enabled longitudinal strain regression model, with interaction terms and brake pressure data included;

FIG. 52 is a graph of the residual plot for Belgian Block at 15 mph with brakes enabled longitudinal strain regression model, with interaction terms and brake pressure data removed;

FIG. 53 is a graph of the residual plot for Belgian Block at 15 mph with brakes enabled longitudinal strain regression model, without interaction terms and brake pressure data included;

FIG. 54 is a graph of the residual plot for Belgian Block at 15 mph with brakes enabled longitudinal strain regression model, without interaction terms and brake pressure data removed;

FIG. 55 is a graph of the residual plot for Belgian Block at 15 mph with brakes disabled longitudinal strain regression model, with interaction terms included and brake pressure data removed;

FIG. 56 is a graph of the residual plot for Belgian Block at 15 mph with brakes disabled longitudinal strain regression model, without interaction terms and brake pressure data removed;

FIG. 57 is a graph of the residual plot for Belgian Block at 15 mph with brakes disabled and enabled longitudinal strain regression model with interaction terms, brake pressure data and class included;

FIG. 58 is a graph of the residual plot for Belgian Block at 15 mph with brakes disabled and enabled longitudinal strain regression model with interaction terms, brake pressure data removed and class included;

FIG. 59 is a graph of the residual plot for Belgian Block at 15 mph with brakes disabled and enabled longitudinal strain regression model with interaction terms, brake pressure data included and class removed;

FIG. 60 is a graph of the residual plot for Belgian Block at 15 mph with brakes disabled and enabled longitudinal strain regression model with interaction terms, brake pressure data and class removed;

FIG. 61 is a graph of the percent of information explained by each PC for Belgian Block at 15 mph;

FIG. 62 is a graph of PC1 vs. PC2 for Belgian Block at 15 mph with brakes enabled;

FIG. 63 is a graph of the average strain prediction error for Belgian Block at 15 mph with brakes enabled;

FIG. 64 is a graph of the correlation coefficient between Z scores and training data for Belgian Block at 15 mph with brakes enabled;

FIG. 65 is a graph of the percent of information explained by each PC for Perryman #3 at 15 mph with brakes enabled;

FIG. 66 is a graph of PC1 vs. PC2 for Perryman #3 at 15 mph with brakes enabled;

FIG. 67 is a graph of the average strain prediction error for Perryman #3 at 15 mph with brakes enabled;

FIG. 68 is a graph of the correlation coefficient between Z scores and training data for Perryman #3 at 15 mph with brakes enabled;

FIG. 69 is a graph of the percent of information explained by each PC for Perryman #3 at 15 mph with brakes enabled, half of data;

FIG. 70 is a graph of PC1 vs. PC2 for Perryman #3 at 15 mph, brakes enabled, half of data;

FIG. 71 is a graph of the average strain prediction error for Perryman #3 at 15 mph with brakes enabled, half of data;

FIG. 72 is a graph of the correlation coefficient between Z scores and training data for Perryman #3 at 15 mph with brakes enabled, half of data;

FIG. 73 is a graph of the percent of information explained by each PC for Perryman #3 at 15 mph with brakes disabled;

FIG. 74 is a graph of PC1 vs. PC2 for Perryman #3 at 15 mph with brakes disabled;

FIG. 75 is a graph of the average strain prediction error for Perryman #3 at 15 mph with brakes disabled;

FIG. 76 is a graph of the correlation coefficient between Z scores and training data for Perryman #3 at 15 mph with brakes enabled, half of data;

FIG. 77 is a graph of the regression output for Belgian Block at 15 mph with brakes disabled, decimated by 6 using all variables;

FIG. 78 is a graph of the regression output for Belgian Block at 15 mph with brakes enabled, decimated by 6 using all variables;

FIG. 79 is a graph of the error in single variable prediction for Belgian Block decimated by 6;

FIG. 80 is a graph of the PSD for longitudinal strain for Belgian Block at 15 mph;

FIG. 81 is a graph of the regression output for Belgian Block at 15 mph with the brakes disabled and decimated by 25, using all variables;

FIG. 82 is a graph of the regression output for Belgian Block at 15 mph with the brakes enabled and decimated by 25, using all variables;

FIG. 83 is a graph of the error in single variable prediction for Belgian Block at 15 mph, data decimated by 25;

FIG. 84 is a graph of the regression output for Perryman #3 at 15 mph with brakes disabled and decimated by 25, using all variables;

FIG. 85 is a graph of the regression output for Perryman #3 at 15 mph with brakes enabled and decimated by 25, using all variables;

FIG. 86 is a graph of the error in single variable prediction for Perryman #3 at 15 mph, decimated by 25;

FIG. 87 is a graph of the effects of filter cutoff frequency on average error from Belgian Block at 15 mph with brakes disabled and decimated by 25;

FIG. 88 is a graph of the effects of filter cutoff frequency on average error from Belgian Block at 15 mph with brakes enabled and decimated by 25;

FIG. 89 is a graph of the effects of filter cutoff frequency on average error from Perryman #3 at 15 mph with brakes disabled and decimated by 25;

FIG. 90 is a graph of the effects of filter cutoff frequency on average error from Perryman #3 at 15 mph with brakes enabled and decimated by 25;

FIG. 91 is a graph of the effects of filter cutoff frequency on strain data from Perryman #3 at 15 mph with brakes disabled and decimated by 25;

FIG. 92 is a graph of the effects of filter cutoff frequency on strain data from Perryman #3 at 15 mph with brakes enabled and decimated by 25;

FIG. 93 is a graph of S-N curve fitted for WAFO;

FIG. 94 is a graph of the rainflow cycle count;

FIG. 95 is a graph of the rainflow amplitude distribution;

FIG. 96 is a graph of the effects of cutoff frequency on fatigue life prediction;

FIG. 97 is a graph of the effects of cutoff frequency on fatigue life prediction, given and predicted strains;

FIG. 98 is a graph of the fatigue life of the data set after filtering compared to the predicted fatigue life after filtering;

FIG. 99 is a graph of the effects of cutoff frequency on fatigue life prediction error from original estimate using filtered training data;

FIG. 100 is a graph of the effects of cutoff frequency on fatigue life prediction error from original estimate using filtered accelerations and unfiltered strain training data;

FIG. 101 is a graph of the model output for Perryman #3 at 15 mph without brakes;

FIG. 102 is a graph of the model output for Perryman #3 at 15 mph with brakes;

FIG. 103 is a graph of the model output for Belgian Block at 15 mph without brakes;

FIG. 104 is a graph of the model output for Belgian Block at 15 mph with brakes;

FIG. 105 is a graph of the model output for concatenated data set;

FIG. 106 is a graph of the simulated output for concatenated data set for various SS models; and

FIG. 107 is a graph of the simulated and measured SS model output for concatenated data set.

### DETAILED DESCRIPTION

A list of abbreviations and a list of references used in the Detailed Description are provided at the end of the Detailed Description in order to provide a better understanding of the invention described herein.

### I. Preferred Embodiment

### A. Background

Vehicle durability, which defines the useful life of a vehicle, is a high priority for accurately measuring. Life consumption monitoring can be used to determine fatigue damage by directly or indirectly monitoring the loads placed on critical vehicle components that are susceptible to failure from fatigue damage. The current state of the art is to indirectly determine the fatigue life from the operational modes of the vehicle. The present invention provides a system and method for directly determining the fatigue life using a model that determines the stress/strain at the failure location from a series of strategically placed sensors on the vehicle.

To monitor the fatigue life, the failure locations must be determined from modeling, simulation, experimentation and/or operational failure. Sensor types and locations are then determined that relate to the failure of the part. A model and appropriate signal filtering is created that relates the sensor data to the stress, strain and/or loading at the failure location. From the stress and/or strain, the fatigue life and thus the durability of the vehicle is then determined.

Using a model or a series of models that relate the sensor data to the fatigue life, the durability can be monitored online or the data can be recorded for analysis. The monitoring can be as simple as having an indicator light turn on at a predetermined failure criteria or can be used to monitor the overall health of the vehicle. The model used for the experimentation described hereinafter is a M1101 high mobility trailer (HMT) military vehicle that is normally towed behind a military high mobility multi-purpose wheeled vehicle (HMMWV).

As originally designed, the HMT is known to have experienced fatigue failure of the draw bar. Thus, for the testing described in detail hereinafter, experimental data was taken from an HMT traveling over known test courses. The data was used to validate a computer simulation and to determine the feasibility of life consumption monitoring. Multivariate regressions and principal component analysis (PCA) were used to determine which sensors most accurately reflect the loads on the draw bar at the failure point. Regression and dynamic models were made after the proper decimation and filtering of the data was determined. The models were then used to predict the fatigue life of the trailer. Using the model developed, the fatigue life of the HMT traveling over a known test course can be determined within a small average error online from a set of sensors placed on the vehicle with the data recorded at a predetermined frequency. This will allow for life consumption monitoring of the vehicle in accordance with the system and method of the invention.

### B. Fatigue Prediction System and Method

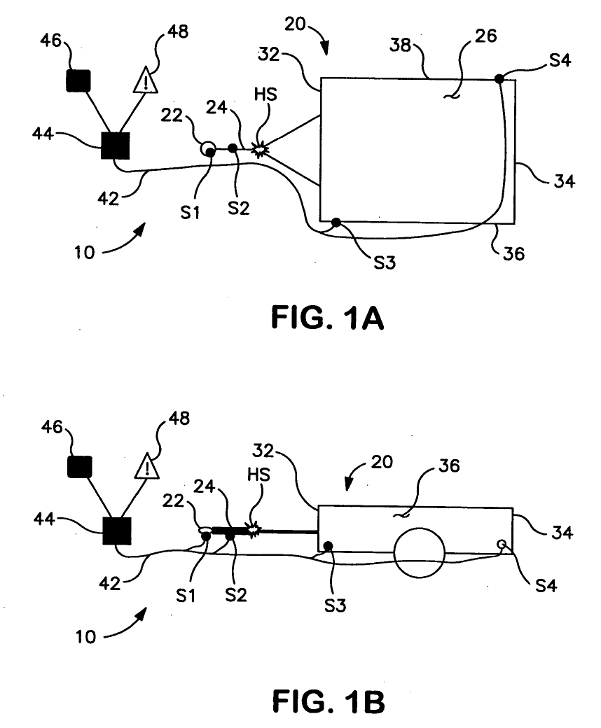

Referring now to FIGS. 1A and 1B, a preferred embodiment of the system according to the present invention is shown generally as 10. System 10 is capable of predicting failure at a specific location or “hot spot” HS on a structure, such as a vehicular trailer or high mobility trailer (HMT) generally shown as 20. Trailer 20 includes a lunette 22, drawbar 24, and a box container 26 having a front edge 32, rear edge 34, road-side edge 36 and curb-side edge 38.

System 10 includes sensors S1, S2, S3, S4 that are placed at selected locations on structure 20 apart from specific hot spot location HS, for generating data signals related to one or more variables measured at the selected locations. In the preferred embodiment, sensors S1, S2 are placed on the lunette and drawbar, respectively, for vertical direction measurement and sensors S3, S4 are placed on the road-side front and curb-side rear edges, respectively, for longitudinal direction measurement.

System 10 further includes a network 42, which may include a plurality of wires or the like, for gathering and combining the data signals generated by sensors S1, S2, S3, S4. Upon gathering and combining of the data signals, network 42 relays this information to processor 44, where the data signals are compared with a predetermined expected failure value in order to predict failure at specific hot spot location HS on structure 20. This comparison data may also be used to determine the remaining useful life of structure 20 based upon the percentage calculated until failure. For example, if the data signals generated by sensors S1, S2, S3, S4 amount as a percentage to only 50% of the predetermined expected failure value, then it can be approximated that structure 20 has a 50% remaining useful life.

System 10 may further comprise a display 46 for observing the data signals and the predetermined expected failure value and may also comprise a threshold indicator 48 for producing a warning, such as a visible or audible warning, when the data signals approach or are at least equal to the predetermined expected failure value. For instance, system 10 may include a lamp indicator that produces a visual warning when the data signals amount as a percentage to 95% of the predetermined expected failure value, thus alerting the user that specific hot spot location HS is approaching failure and therefore the remaining useful life of structure 20 is limited.

### II. Experimental Testing Methodology

### A. Method To Be Used to Determine Best Sensors and Location

In order to determine the most appropriate sensor for collecting data needed for predicting the fatigue life of the trailer, an analysis of experimental data was performed. The experimental data was taken from a HMT traveling over a known test course. The data was taken for 45 test runs at 8 speeds, over 6 test courses that have known terrain profiles, and with the trailer brakes both enabled and disabled. The data sets used in the current analysis are for the Belgian Block course at 15 mph and the Perryman #3 course at 15 mph, with the brakes both enabled and disabled.

The trailer was instrumented with 59 sensors, which included strain gauges, accelerometers, rate gyros, shock absorber displacements, brake pressures, and ground speed. The failure at the drawbar corresponds to the forces on the drawbar, which can be determined from the strain gauge data. The failure location has also been determined by DRAW.

Multivariate regressions (Neter et al., 1996) and principal component analysis (PCA) (Hines, 1998) will be used to determine which sensors most accurately reflect the loads on the drawbar at the failure point.

From the regression model created using the appropriate sensors, the fatigue life will be calculated using the Wave Analysis for Fatigue and Oceanography (WAFO) software package. WAFO (WAFO Group, 2000) uses a stress-based approach to fatigue life calculation, which is appropriate for the high cycle fatigue present in monitoring vehicle fatigue. WAFO uses the Wohler curve fit and the Palgrem-Miner rule to calculate fatigue damage from rainflow counting and the S-N curve, as described below.

Appropriate re-sampling of the data will be made using decimation and filtering will be made using a Butterworth filter. These techniques are discussed below. From the regression and fatigue calculations, an appropriate dynamic model will be made to determine the strain at the failure point from the series determined by the regression analysis.

Regression Analysis

Multivariate regressions are used for determining the linear relationship between a dependent variable (i.e. strain) based upon a set of independent variables (i.e. data channels). Regression analysis is used for description, control, and prediction of data. To determine the relationship between the input data and the strain, at the expected point of failure, a regression analysis was performed. The linear regression model has the general form:
Y=β₀+X^{T}β+ε=β₀+X₁β₁+X₂β₂+ . . . +ε (1)
where Y is the response (output) variable, X is the independent (input) matrix, β₁ are the model parameters, X₁ are the independent (input) variables, and ε is an error term.

Interaction effects can also be added to the regression model. An interaction effect is the effect one predictor variable X₁ has on the interaction between another predictor variable X₂ and the response variable Y. With the addition of pair-wise interaction effects, the regression model has the addition of all possible pairs if predictor variables are multiplied together and added to X. The linear regression model with interaction terms has the form:
Y=β₀+X^{T}β+ε=β₀+X₁β₁X₂β₂+X₁X₂β₁₂+ . . . +ε. (2)

The goodness-of-fit for a regression model can be measured by the coefficient of determination, R², which is simply the proportion of variance between the measured and predicted values of the response variable, Y. It reflects the ratio of the regression sum of squares to the total sum of squares, and is given by:

$${R}^{2} = \frac{{\sum }_{i = 1}^{n} {( {Y}_{hi} - {Y}_{m} )}^{2}}{{\sum }_{i = 1}^{n} [ {( {Y}_{hi} - {Y}_{m} )}^{2} + {( {Y}_{i} - {Y}_{hi} )}^{2} ]} \qquad ( 3 )$$

where the regression sum of squares is the squared sum of the differences between the fitted value, Yₕᵢ, and the mean of the fitted values, Yₘ, for n observations and the error sum of squares is the squared sum differences between the observation, Yᵢ, and the mean of the fitted values, Yₘ. The total sum of squares measures the uncertainty of predicting Y, when the predictor variables are not considered. The total sum of squares is the sum of both the error and regression sum of squares. It measures the variation in the measured values, Y, when the predictor variables X are considered. The closer the value of R² is to unity, the closer the observations Y are to the regression model and the greater the degree of linear association between the input variables, X, and the predicted response variable, Y.

The R² value is a measurement of the goodness of fit of the model, but it is also necessary to determine the accuracy of the regression model in terms of error in prediction. The error can be determined by simply comparing the predicted values from the model with the data it is predicting. This gives an average error that can be used to determine the accuracy of the model. The accuracy is usually tested by dividing the data set into halves. One half of the data set is used to create the model and the second half is used for testing the model.

Principal Component Analysis (PCA)

Principal component analysis identifies variables or groups of variables that represent the behavior of the system. Each principal component (PC) is a linear combination of the original data and thus forms a vector basis for the data. The transformed vectors are uncorrelated and orthogonal, which allow them to be used in regressions without collinearity problems, effectively removing interactions.

Since there are an infinite number of ways to construct the vector basis, the principal component technique defines the basis to be constructed such that the first principal component describes the direction of maximum variance, and each succeeding principal component is defined to be orthogonal to all previous principal components and to have the maximum variance of all remaining choices. By neglecting the PCs that do not contain a significant amount of variability, a systematic reduction in the size of the input data can be made without losing significant information in the data.

In the context of this analysis, the input space X, which consists of all the accelerometer, rate gyro, linear position and brake pressure data, is transformed into an orthogonal space Z using a transformation matrix a:
{z}=[a]{x} (4)
This transformation is performed sequentially by first creating a variable z, that is a linear combination of the input data channels, xⱼ, and has maximum variance with respect to the data.

$${z}_{1} = {a}_{11} {x}_{1} + {a}_{12} {x}_{2} + ⋯ + {a}_{1 p} {x}_{p} = {\sum }_{j = 1}^{p} {a}_{1 j} {x}_{j} \qquad ( 5 )$$

A second variable, z₂, is then created. This variable has maximum variance with respect to the remaining data, and is uncorrelated (ie. orthogonal) to z₁.

$${z}_{2} = {a}_{21} {x}_{1} + {a}_{22} {x}_{2} + ⋯ + {a}_{2 p} {x}_{p} = {\sum }_{j = 1}^{p} {a}_{2 j} {x}_{j} \qquad ( 6 )$$

This process continues until p uncorrelated principal components are found and are arranged in order of decreasing variance. The values of the PC scores show how each input variable is weighted. The percent explained by each principal component shows how much variance is explained by each PC.

$$\% explained = \frac{{variance}_{j}}{{\sum }_{j = 1}^{p} {variance}_{j}} \cdot 100 \% \qquad ( 7 )$$

The principal components are calculated from the covariance matrix. The principal components are the eigenvectors of the covariance matrix with the first eigenvector corresponding to the largest eigenvalue (λ) and therefore the most variance. The latent variables are the eigenvalues of the covariance matrix. The eigenvectors are orthogonal, and the sum of the eigenvalues equals the total variance of the original data. From the eigenvalues the amount of information explained by each PC can be computed.

$$\% explained = \frac{{λ}_{j}}{{\sum }_{j = 1}^{p} {λ}_{j}} \cdot 100 \% \qquad ( 8 )$$

Singular value decomposition (SVD) is used for PCA because it is a method of calculating the eigenvectors and eigenvalues that is considered to be computationally efficient and stable. SVD decomposes a matrix X into a diagonal matrix L that contains the singular values which are the square roots of the eigenvalues of X^{T}X and are arranged in decreasing order, an orthogonal vector space A of the standardized PC scores, and an orthogonal vector space U of right singular values which are the eigenvectors, PCs, and result in the same matrix as the eigenvector matrix of the covariance.
{X}={A}{L}{U}^{T} (9)
The PC scores can be calculated by multiplying A by L.
{z}={A}{L} (10)
Fatigue Life Calculation

To develop an equation for damage at a given stress level, as it relates to the S-N curve, the techniques of rainflow counting will be combined with the Wohler fit to the S-N curve and the Palmgren-Miner fatigue damage rule. Rainflow counting (WAFO Group, 2000; Dowling, 1999) is used to divide variable amplitude loading into a series of cycles of maximums, Mₖ, and minimums, mₖ^{RFC}, that give the amplitude for a given cycle, sₖ^{RFC}:
sₖ^{RFC}=Mₖ−mₖ^{RFC} (11)
The S-N curve is determined experimentally by testing material samples at a constant cyclic stress, S, until failure. The number of cycles until failure, N, are recorded and plotted against the corresponding stress for each test. The Wohler curve fits the S-N curve as a function N(s), where s is a given stress amplitude.
N(s)=K⁻¹s^{-β} for s>s_{∞} and ∞ for s≦s_{∞} (12)
The Palmgren-Miner linear damage accumulation theory states that damage is the sum of the number of cycles to failure at each stress level. Failure occurs when D(t)=1.

$$D ( t ) = {\sum }_{{t}_{k} ≦ t} \frac{1}{N ( {s}_{k} )} \qquad ( 13 )$$

Combining the Wohler curve (12) and the Pamigren-Miner rule (13) with the rainflow cycle distribution, we have an equation for damage at a given stress level, as it relates to the fit of the S-N curve.

$$D ( t ) = K {\sum }_{{t}_{k} ≦ t} {s}_{k}^{β} \qquad ( 14 )$$

Using the amplitudes from the rainflow cycle, sₖ^{RFC}, we have the following damage estimation for a given S-N curve and loading.

$$D ( t ) = K {\sum }_{{t}_{k} ≦ t} {( {s}_{k}^{RFC} )}^{β} \qquad ( 15 )$$

Decimation and Filtering

The decimation function in Matlab is used to filter and re-sample the data at a given level, R, which is 1/R times the original sample rate, Fs. The function uses an eighth order Chebyshev type-1 low pass filter with a cutoff frequency set at the 80% of the new Nyquist frequency, 0.8*(Fs/2)/R. Once the data is filtered it is re-sampled to the given level.

The filter used for further filtering of the data was an 8 pole low pass digital Butterworth filter. The filter was applied with a zero-phase forward and reverse digital filter. This results in no phase distortion and magnitude modified by the square of the filter's magnitude response.

### B. Data Collection and DADS Validation of Sensor Data Collected

Test Setup

The data used for the analysis of the HMT; was collected by the United States Army at the U.S. Army Aberdeen Test Center (ATC). The data was collected for 45 test runs at 8 speeds, over 6 test courses that have known terrain profiles, and with the trailer brakes both enabled and disabled. The trailer was instrumented with 59 sensors, listed in Table 1, that included strain gauges, accelerometers, rate gyros, shock absorber displacements, brake pressures, and ground speed.

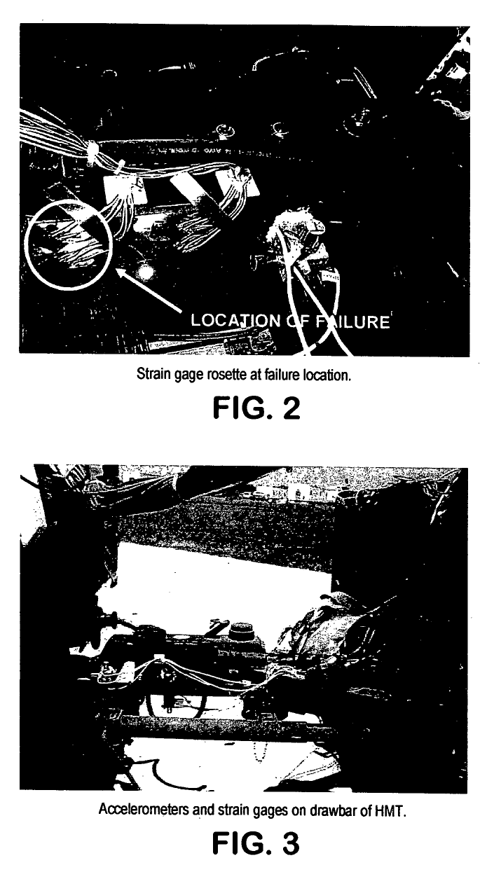

The strain gauge rosettes were located at several points on the trailer. The strain gauge rosettes monitored strains in the transverse, 45 degree, and longitudinal directions. A total of eight strain gauge rosettes were used. Four of the strain gauge rosettes were located on the bottom of the drawbar. The analyses in this application used the data from one rosette located on the bottom of the drawbar near the failure point, as shown in FIG. 2.

Four single axis accelerometers were located at the frame attachment point for both the curbside (CS) and roadside (RS) suspension road arms, or close to the axle location on the road arms. The axis of the axle accelerometers changes due to movement of the suspension.

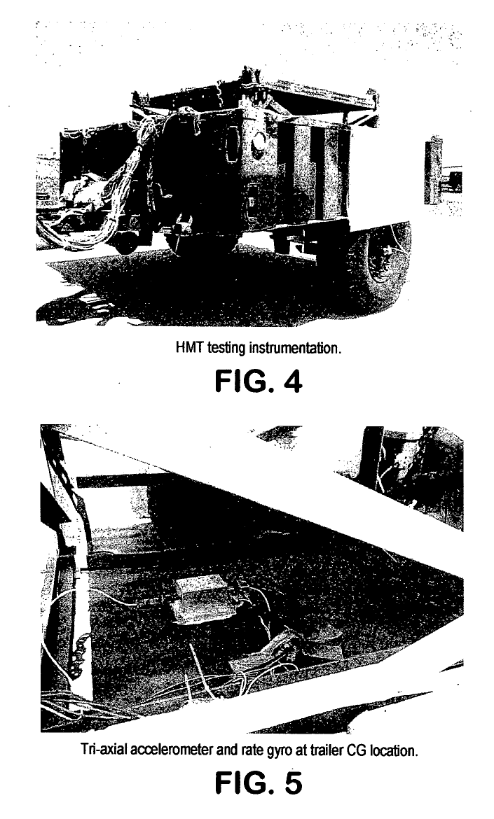

Seven tri-axial and four single axis accelerometers were used during the trailer testing. As can be seen in FIG. 3, one of the tri-axial accelerometers was located on the lunette, and another on the trailer tongue. Significant differences between these two sets of transducers should only exist for experimental runs where the surge brake was active. Four tri-axial accelerometers were located at the corners of the cargo box, as shown in FIG. 4. A rate gyro was used to measure the roll, pitch and yaw rates at the CG of the trailer, with a final tri-axial accelerometer to measure center of gravity (CG) accelerations, as shown in FIG. 5.

Linear displacement transducers were used to measure shock absorber displacements and three pressure transducers were used to monitor brake pressures. The pressure transducers were located at the master cylinder, left wheel cylinder, and right wheel cylinder, respectively.

TABLE 1
Data acquisition system channel assignments.

| Channel # | Description | |
|---|---|---|
| 5 | Bottom Drawbar | Transverse strain |
| 6 | Center | 45 degree strain |
| 7 | | Longitudinal strain |
| 8 | Bottom Drawbar | Transverse strain |
| 9 | Center | 45 degree strain |
| 10 | Aft | Longitudinal strain |
| 11 | Bottom Drawbar | Transverse strain |
| 12 | Curbside | 45 degree strain |
| 13 | Edge | Longitudinal strain |
| 14 | Bottom Drawbar | Transverse strain |
| 15 | Curbside | 45 degree strain |
| 16 | Aft Edge | Longitudinal strain |
| 17 | Top Triangle Plate | Transverse strain |
| 18 | Corner | 45 degree strain |
| 19 | | Longitudinal strain |
| 20 | Bottom Triangle Plate | Transverse strain |
| 21 | Corner | 45 degree strain |
| 22 | | Longitudinal strain |
| 23 | Left Angle Plate | Vertical strain |
| 24 | Lower | 45 degree strain |
| 25 | | Longitudinal strain |
| 26 | Left Angle Plate | Vertical strain |
| 27 | Upper | 45 degree strain |
| 28 | | Longitudinal strain |
| 29 | Curbside Axle Acceleration | |
| 30 | Curbside Frame Acceleration | |
| 31 | Roadside Axle Acceleration | |
| 32 | Roadside Frame Acceleration | |
| 33 | Lunette Acceleration | Vertical (z) |
| 34 | | Transverse (y) |
| 35 | | Longitudinal (x) |
| 36 | Tongue Acceleration | Vertical (z) |
| 37 | | Transverse (y) |
| 38 | | Longitudinal (x) |
| 39 | Trailer CG Acceleration | Vertical (z) |
| 40 | | Transverse (y) |
| 41 | | Longitudinal (x) |
| 42 | Curbside Acceleration | Vertical (z) |
| 43 | Forward | Transverse (y) |
| 44 | | Longitudinal (x) |
| 45 | Curbside Acceleration | Vertical (z) |
| 46 | Aft | Transverse (y) |
| 47 | | Longitudinal (x) |
| 48 | Roadside Acceleration | Vertical (z) |
| 49 | Forward | Transverse (y) |
| 50 | | Longitudinal (x) |
| 51 | Roadside Acceleration | Vertical (z) |
| 52 | Aft | Transverse (y) |
| 53 | | Longitudinal (x) |
| 54 | Trailer CG | Vertical (z) |
| 55 | | Transverse (y) |
| 56 | | Longitudinal (x) |
| 57 | Curbside Shock Displacement | |
| 58 | Roadside Shock Displacement | |
| 59 | Longitudinal Ground Speed | |
| 60 | (not used) | |
| 61 | Master Cylinder Brake Pressure | |
| 62 | Curbside Wheel Brake Pressure | |
| 63 | Roadside Wheel Brake Pressure | |

Test Data

The data used for the analysis in this application was for the tests on the Belgian Block and Perryman #3 courses. The data collected over the two courses was for the brakes both enabled and disabled at a speed of 15 mph. The file names for the test runs used are shown in Table 2.

The Belgian Block Course is paved with uneven granite blocks that simulate a cobblestone road. The granite blocks are on average 13 cm (5 in) square. The course varies with a peak of approximately 8 cm (3 in). The course is approximately 1.2 km (0.75 ml) in length. The data from this course was used because it creates a random vehicle motion.

The Perryman #3 course is a cross-country course. It is a rough course composed of native soil that includes Sassafras loam and Sassafras silt loam. Dust is severe when the course is dry. Much of the course is rough due to many years of testing tank-type vehicles.

The data was collected at a frequency of 1262.626 Hz. The data was filtered with low-pass anti-aliasing filters. The cutoff frequency of the filter differed by the type of sensor being used on that channel, as shown in Table 3. The data was then stored in a comma delimited format with 59 columns, one for each data channel. The data files were stored in the format shown in Table 4.

TABLE 2
Test matrix data file names.

| Course/Speed | Brakes | Test Run |
|---|---|---|
| Belgian Block/15 mph | Off | Run010 |
| | On | Run013 |
| Perryman #3/15 mph | Off | Run055 |
| | On | Run052 |

TABLE 3
Analog low-pass anti-aliasing cutoff frequencies.

| Transducer Type | Filter Cutoff Frequency |
|---|---|
| Strain gauge | 100 Hz |
| Accelerometer | 200 Hz |
| Rate gyro | 20 Hz |
| Linear position | 20 Hz |

TABLE 4
Experimental data file format.

| Col # | Description | Units |
|---|---|---|
| 1 | Time | sec |
| 2 | Btm Drwbr Cntr (T) strain | μ inch |
| 3 | Btm Drwbr Cntr (45) strain | μ inch |
| 4 | Btm Drwbr Cntr (L) strain | μ inch |
| 5 | Btm Drwbr Cntr Aft (T) strain | μ inch |
| 6 | Btm Drwbr Cntr Aft (45) strain | μ inch |
| 7 | Btm Drwbr Cntr Aft (L) strain | μ inch |
| 8 | Btm Drwbr CS Edge (T) strain | μ inch |
| 9 | Btm Drwbr CS Edge (45) strain | μ inch |
| 10 | Btm Drwbr CS Edge (L) strain | μ inch |
| 11 | Btm Drwbr CS Edge Aft (T) strain | μ inch |
| 12 | Btm Drwbr CS Edge Aft (45) strain | μ inch |
| 13 | Btm Drwbr CS Edge Aft (L) strain | μ inch |
| 14 | Top Triang Plate Corner (T) strain | μ inch |
| 15 | Top Triang Plate Corner (45) strain | μ inch |
| 16 | Top Triang Plate Corner (L) strain | μ inch |
| 17 | Btm Triang Plate Corner (T) strain | μ inch |
| 18 | Btm Triang Plate Corner (45) strain | μ inch |
| 19 | Btm Triang Plate Corner (L) strain | μ inch |
| 20 | Left Angle Plate Lower (V) strain | μ inch |
| 21 | Left Angle Plate Lower (45) strain | μ inch |
| 22 | Left Angle Plate Lower (L) strain | μ inch |
| 23 | Left Angle Plate Upper (V) strain | μ inch |
| 24 | Left Angle Plate Upper (45) strain | μ inch |
| 25 | Left Angle Plate Upper (L) strain | μ inch |
| 26 | CS Axle Accel (V) | g's |
| 27 | CS Frame Accel (V) | g's |
| 28 | RS Axle Accel (V) | g's |
| 29 | RS Frame Accel (V) | g's |
| 30 | Lunette Accel (V) | g's |
| 31 | Lunette Accel (T) | g's |
| 32 | Lunette Accel (L) | g's |
| 33 | Tongue Accel (V) | g's |
| 34 | Tongue Accel (T) | g's |
| 35 | Tongue Accel (L) | g's |
| 36 | Trailer CG Accel (V) | g's |
| 37 | Trailer CG Accel (T) | g's |
| 38 | Trailer CG Accel (L) | g's |
| 39 | CS Forward Accel (V) | g's |
| 40 | CS Forward Accel (T) | g's |
| 41 | CS Forward Accel (L) | g's |
| 42 | CS Aft Accel (V) | g's |
| 43 | CS Aft Accel (T) | g's |
| 44 | CS Aft Accel (L) | g's |
| 45 | RS Forward Accel (V) | g's |
| 46 | RS Forward Accel (T) | g's |
| 47 | RS Forward Accel (L) | g's |
| 48 | RS Aft Accel (V) | g's |
| 49 | RS Aft Accel (T) | g's |
| 50 | RS Aft Accel (L) | g's |
| 51 | Trailer CG Pitch Rate | deg/sec |
| 52 | Trailer CG Roll Rate | deg/sec |
| 53 | Trailer CG Yaw Rate | deg/sec |
| 54 | CS Shock Absorber Disp | Inches |
| 55 | RS Shock Absorber Disp | inches |
| 56 | Surge Brake Pressure | psi |
| 57 | CS Wheel Brake Pressure | psi |
| 58 | RS Wheel Brake Pressure | psi |
| 59 | Long. Ground Speed | mph |

Data Reduction Results

Representative data reduction results are presented for data collected on the Perryman cross-country #3 course at a nominal speed of 15 mph with the surge brakes activated and deactivated, respectively. The data has been decimated to a sampling frequency that is close to twice the cutoff frequencies listed in Table 3, for each sensor type. Strain gauge data is only shown for the failure location, bottom drawbar center aft. All other data channels are shown, except for ground speed. The statistics for the data were then calculated, as requested by the U.S. Army. The statistics calculated included the average, standard deviation, root mean square (RMS), +peak, −peak, +99.9%, −99.9%, +99%, −99%, +90%, and −90%.

Strain Data

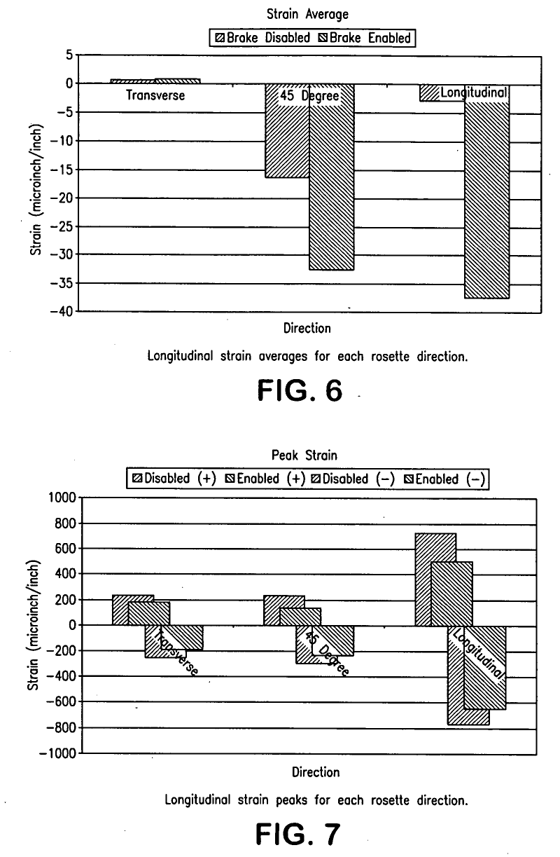

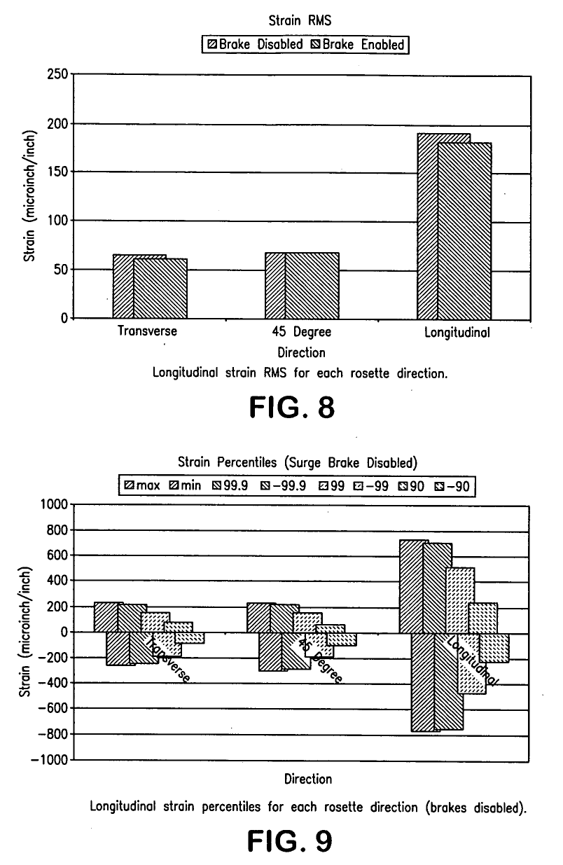

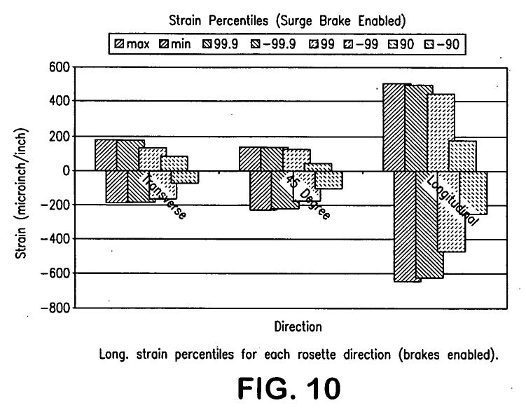

The statistics for strain are shown in Table 5 and FIGS. 6 through 10. Table 6 shows the statistics for the principal strains. The experimental principal strain statistics are shown, due to the fact that the NASTRAN analysis of the DADS simulation returns principal strains. The principal strains will be used to validate the simulation.

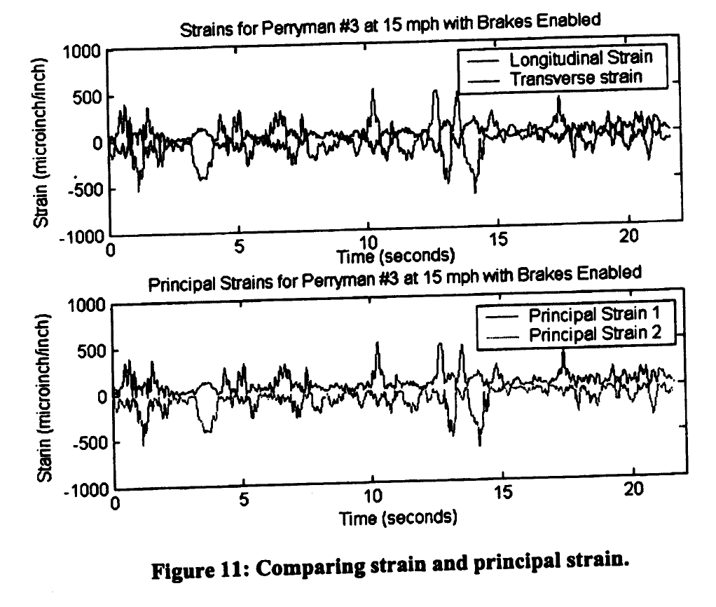

From Table 5 and the figures, it can be seen that the longitudinal strain has a much greater amplitude than the other strains. From the Tables 5 and 6, the peak and percentile strains for the first principal strain, ε₁, match the positive portions of the transverse and longitudinal strains. The peak and percentile strains for the second principal strain, ε₂, match the negative portions of the transverse and longitudinal strains. From FIG. 11, it can be seen that the longitudinal strain amplitude is well above the transverse strain amplitude. The longitudinal strain is also perpendicular to the direction of crack growth, determined from the broken drawbar, at the failure point. The longitudinal strain is the primary contributor to the positive and negative peaks in the principal strains. From Table 6 and FIG. 11, it can be seen that the first principal strain only accounts for the positive strains in the longitudinal direction, and the second the negative. Therefore, if the only one principal strain is used for calculation, either the positive or negative portion of the strains will be ignored, and will reduce the peak to valley strain values of the cycle. From this, it can be determined that the longitudinal strain or the combined first and second principal strains should be used for any fatigue life predictions.

TABLE 5
Strain amplitude distribution data.

| | | | Std | | | | | | | | | | |
|---|---|---|---|---|---|---|---|---|---|---|---|---|---|
| Description | | Ave | Dev | RMS | +Peak | −Peak | +99.9 | +99.9 | +99 | −99 | +90 | −90 | Brakes |
| Btm Cntr Aft | (T) | 0.903 | 61.25 | 61.25 | 180 | −189 | 176 | −187 | 132 | −167 | 80.5 | −75.3 | ON |
| | (45) | −32.6 | 59.48 | 67.82 | 136 | −232 | 135 | −225 | 120 | −177 | 39.65 | −107 | |
| | (L) | −37.2 | 178.1 | 181.9 | 505 | −648 | 495 | −627 | 442 | −473 | 176 | −256 | |
| Btm Cntr Aft | (T) | 0.692 | 65.27 | 65.27 | 233 | −255 | 221 | −240 | 155 | −180 | 81.9 | −81.5 | OFF |
| | (45) | −16.3 | 66.48 | 68.44 | 235 | −297 | 227 | −283 | 154 | −185 | 64.8 | −97.3 | |
| | (L) | −2.75 | 191 | 191 | 728 | −770 | 704 | −749 | 514 | −477 | 238 | −226 | |

TABLE 6
Principal strain amplitude distribution data.

| | | | Std | | | | | | | | | | |
|---|---|---|---|---|---|---|---|---|---|---|---|---|---|
| Description | | Ave | Dev | RMS | +Peak | −Peak | +99.9 | −99.9 | +99 | −99 | +90 | −90 | Brakes |
| Btm Cntr Aft | (ε₁) | 79.6 | 86.59 | 118 | 506 | −39.8 | 498 | −27.6 | 443 | −16.9 | 179 | 3.9 | ON |
| | (ε₂) | −116 | 104 | 156 | −12.59 | −648 | −13.5 | −627 | −16.1 | −474 | −25.5 | −258 | |
| | (α) | 0.019 | 0.253 | 0.253 | 0.783 | −0.78 | 0.77 | −0.76 | 0.69 | −0.68 | 0.33 | −0.28 | |
| Btm Cntr Aft | (ε₁) | 99.59 | 106 | 146 | 728 | −39.2 | 705 | −27.6 | 515 | −8.36 | 241 | 11.89 | OFF |
| | (ε₂) | −102 | 103 | 144 | −0.66 | −770 | −4.54 | −749 | −7.31 | −478 | −17.2 | −232 | |
| | (α) | 0.023 | 0.258 | 0.259 | 0.783 | −0.79 | 0.781 | −0.78 | 0.721 | 0.7 | 0.313 | −0.27 | |

Accelerometer Data

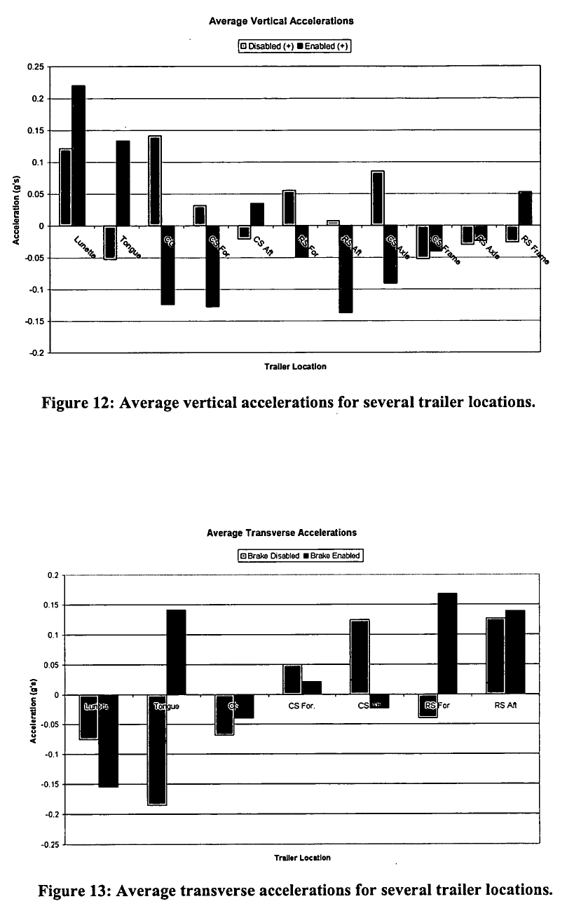

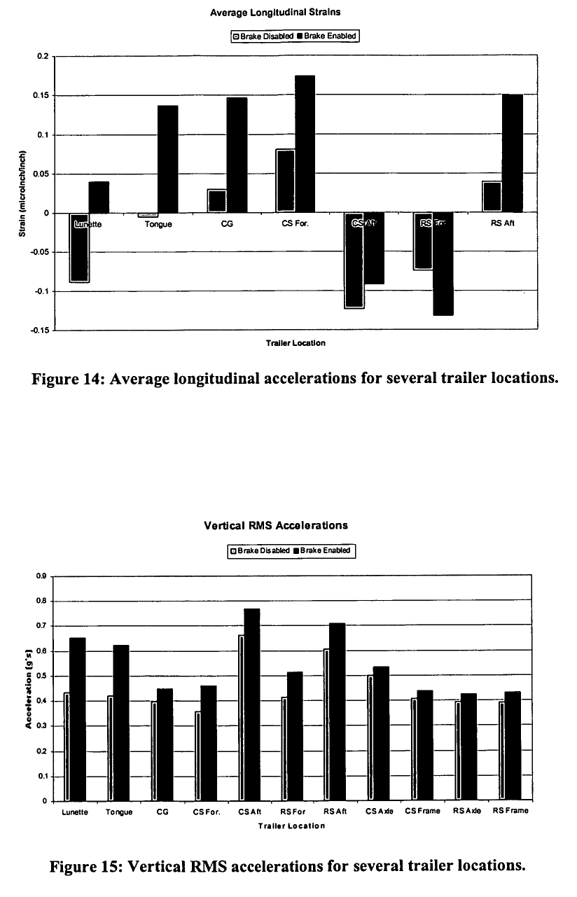

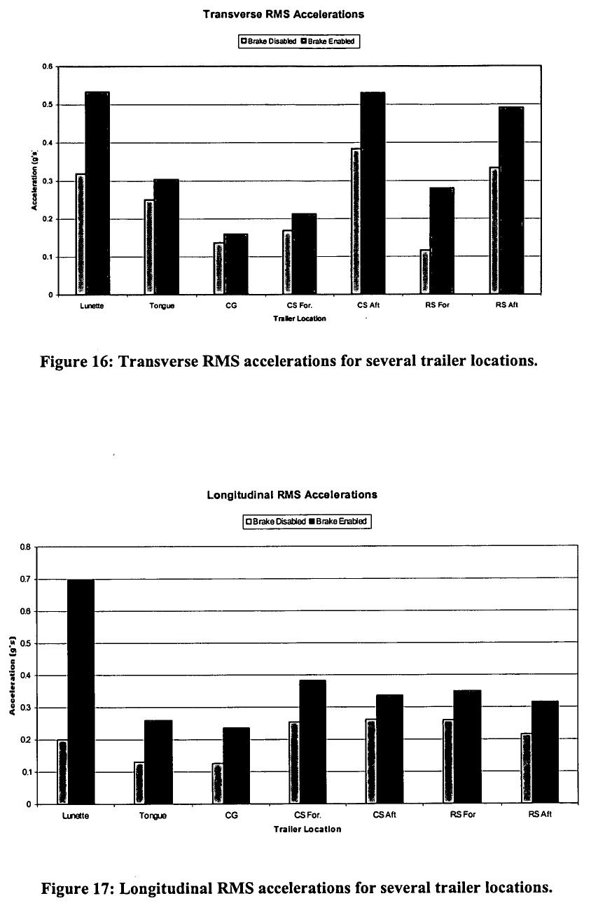

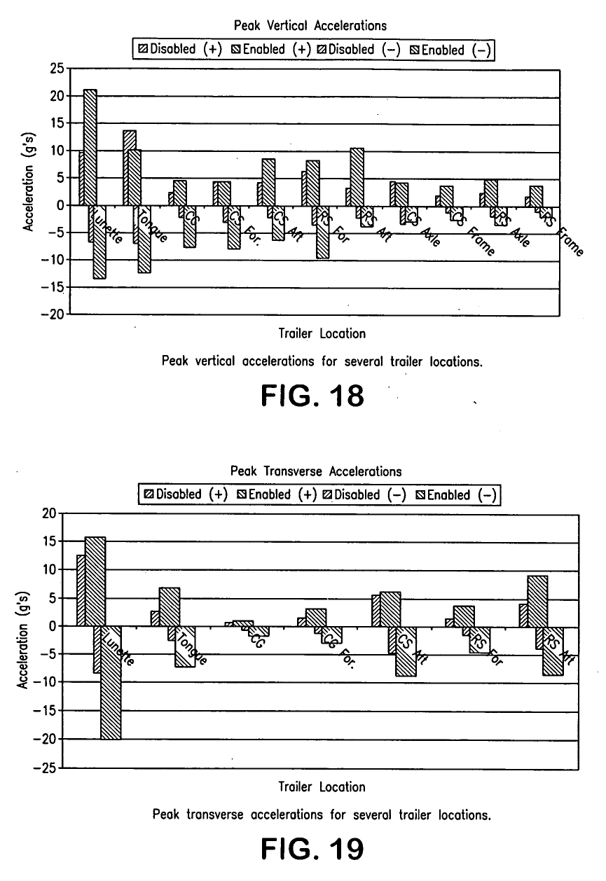

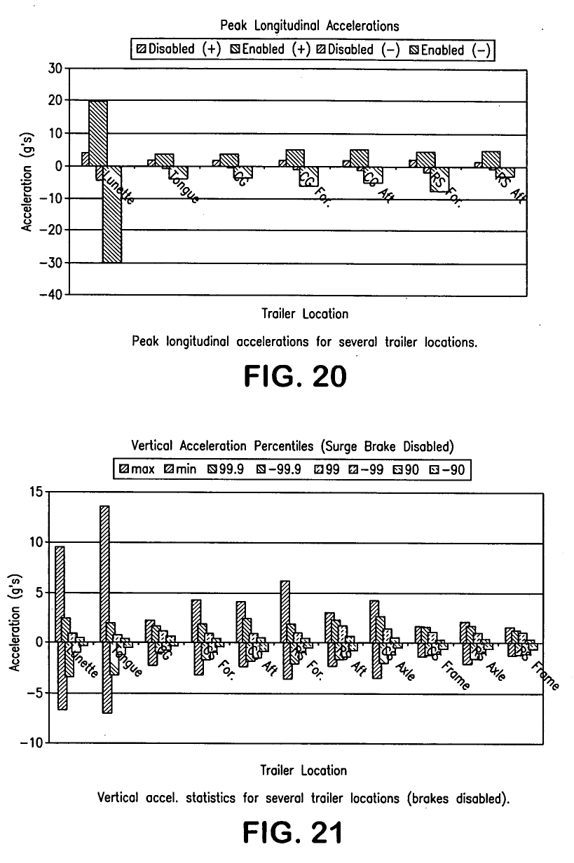

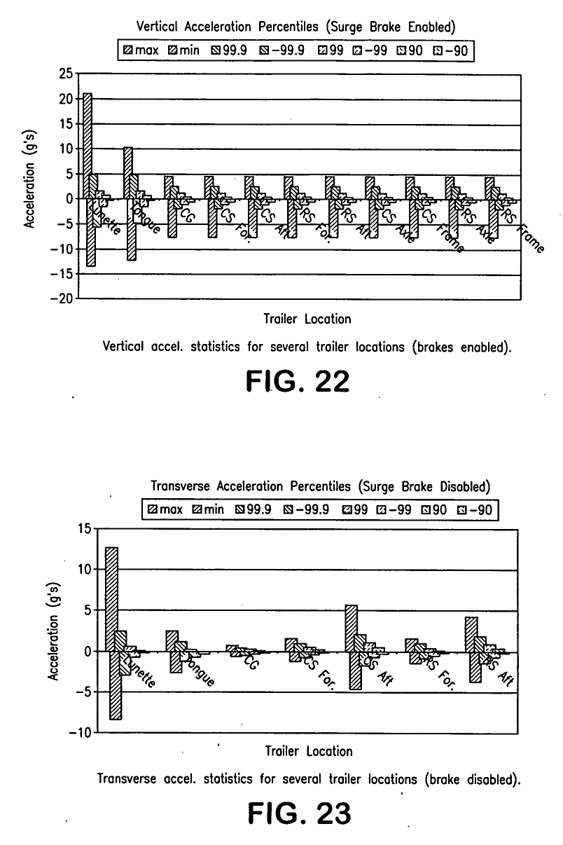

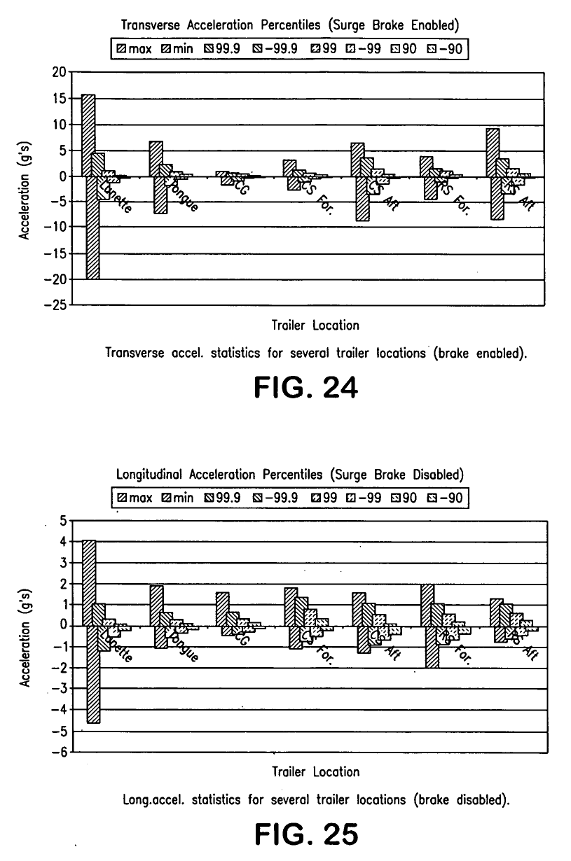

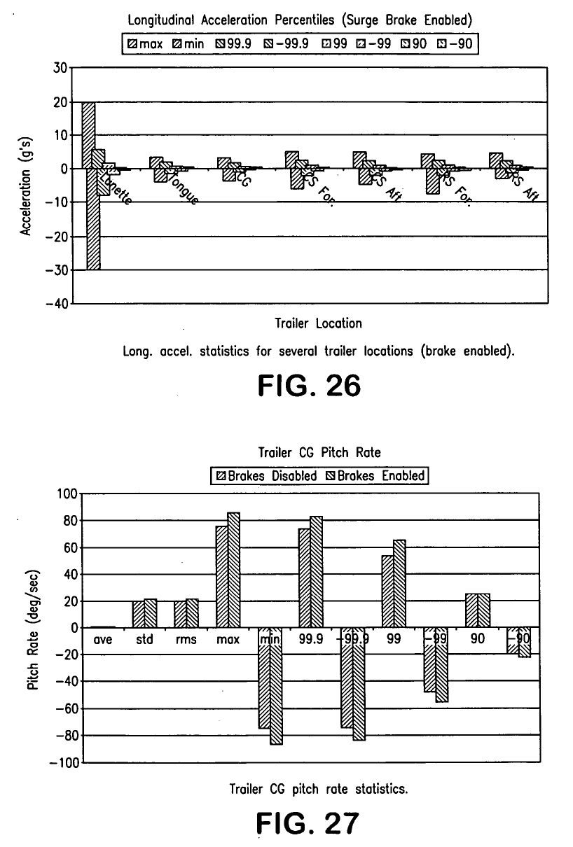

Statistics about the accelerometer data amplitude distribution for the Perryman #3 test course at 15 mph are given in Tables 7 and 8 for the brakes disabled, and enabled respectively. The statistics can be seen graphically in FIGS. 12 through 26. As expected the mean acceleration are less than 0.25 g. The RMS values are greater for the test data with the brakes enabled than the test data with the brakes disabled. The minimum values are lower for all trailer locations for the test data with the brakes enabled and the maximum values are greater for all locations, except the tongue, for the brakes enabled case.

TABLE 7
Acceleration amplitude distribution data (brakes disabled).

| | | | Std | | | | | | | | | |
|---|---|---|---|---|---|---|---|---|---|---|---|---|
| Description | | Ave | Dev | RMS | +Peak | −Peak | +99.9 | −99.9 | +99 | −99 | +90 | −90 |
| Lunette | (V) | 0.12168 | 0.4581 | 0.4332 | 9.5711 | −6.713 | 2.4536 | −3.396 | 0.9296 | −0.972 | 0.5233 | −0.271 |
| | (T) | −0.075 | 0.3101 | 0.319 | 12.632 | −8.396 | 2.4542 | −2.975 | 0.5986 | −0.735 | 0.0754 | −0.231 |
| | (L) | −0.0889 | 0.1779 | 0.1989 | 4.0817 | −4.615 | 1.0331 | −1.193 | 0.3298 | −0.548 | 0.0693 | −0.256 |
| Tongue | (V) | −0.0525 | 0.4156 | 0.4189 | 13.57 | −6.954 | 1.996 | −3.129 | 0.7836 | −1.199 | 0.357 | −0.453 |
| | (T) | −0.185 | 0.1688 | 0.2504 | 2.5198 | −2.636 | 1.142 | −1.176 | 0.2237 | −0.629 | −0.032 | −0.34 |
| | (L) | −0.0053 | 0.1311 | 0.1312 | 1.9064 | −1.041 | 0.661 | −0.585 | 0.3064 | −0.352 | 0.138 | −0.161 |
| CG | (V) | 0.1415 | 0.3706 | 0.3967 | 2.2667 | −2.208 | 1.6796 | −0.887 | 1.2249 | −0.666 | 0.6607 | −0.295 |
| | (T) | −0.0683 | 0.118 | 0.1363 | 0.7149 | −0.594 | 0.4068 | −0.467 | 0.2534 | −0.352 | 0.0749 | −0.209 |
| | (L) | 0.0299 | 0.121 | 0.1266 | 1.6047 | −0.479 | 0.636 | −0.399 | 0.3406 | −0.269 | 0.1781 | −0.118 |
| CS For. | (V) | 0.0317 | 0.3561 | 0.3575 | 4.3396 | −3.145 | 1.88 | −1.615 | 0.961 | −0.815 | 0.4544 | −0.371 |
| | (T) | 0.0499 | 0.1613 | 0.1689 | 1.5647 | −1.258 | 0.9982 | −0.728 | 0.4733 | −0.366 | 0.2247 | −0.128 |
| | (L) | 0.0808 | 0.2411 | 0.2543 | 1.8408 | −1.099 | 1.3538 | −0.716 | 0.7839 | −0.512 | 0.3503 | −0.2 |
| CS Aft | (V) | −0.0208 | 0.662 | 0.6623 | 4.1594 | −2.302 | 3.2007 | −1.793 | 2.1049 | −1.432 | 0.7118 | −0.779 |
| | (T) | 0.1244 | 0.3633 | 0.3834 | 5.6734 | −4.693 | 2.0413 | −1.754 | 1.1053 | −0.799 | 0.515 | −0.264 |
| | (L) | −0.1234 | 0.2317 | 0.2625 | 1.5709 | −1.232 | 1.0813 | −0.908 | 0.5811 | −0.639 | 0.1405 | −0.390 |
| RS For | (V) | 0.0553 | 0.4088 | 0.4125 | 6.2374 | −3.551 | 2.0098 | −2.037 | 1.0706 | −0.909 | 0.544 | −0.408 |
| | (T) | −0.0394 | 0.1727 | 0.1171 | 1.5752 | −1.381 | 0.9449 | −0.84 | 0.4047 | −0.478 | 0.15 | −0.234 |
| | (L) | −0.0745 | 0.2486 | 0.2596 | 1.975 | −1.936 | 1.1045 | −0.863 | 0.6167 | −0.657 | 0.2317 | −0.365 |
| RS Aft | (V) | 0.0075 | 0.6042 | 0.6042 | 3.1227 | −2.227 | 2.3379 | −1.563 | 1.7719 | −1.345 | 0.7346 | −0.699 |
| | (T) | 0.1265 | 0.3075 | 0.3325 | 4.2607 | −3.694 | 1.864 | −1.409 | 0.9809 | −0.642 | 0.4597 | −0.204 |
| | (L) | 0.0394 | 0.2106 | 0.2142 | 1.3207 | −0.732 | 1.0818 | −0.579 | 0.65451 | −0.432 | 0.3096 | −0.194 |
| CS Axle | (V) | 0.0852 | 0.4934 | 0.5007 | 4.3174 | −3.36 | 2.7369 | −1.972 | 1.5695 | −1.07 | 0.6409 | −0.459 |
| CS Frame | (V) | −0.0525 | 0.4021 | 0.4055 | 1.8081 | −1.272 | 1.6858 | −1.094 | 1.2094 | −0.947 | 0.4166 | −0.523 |
| RS Axle | (V) | −0.0301 | 0.3931 | 0.3943 | 2.2952 | −2.017 | 1.7752 | −1.456 | 1.1079 | −0.908 | 0.4299 | −0.497 |
| RS Frame | (V) | −0.0261 | 0.3909 | 0.3917 | 1.6563 | −1.128 | 1.4053 | −1.035 | 1.1184 | −0.935 | 0.4417 | −0.481 |

TABLE 8
Acceleration amplitude distribution data (brakes enabled).

| | | | Std | | | | | | | | | |
|---|---|---|---|---|---|---|---|---|---|---|---|---|
| Description | | Ave | Dev | RMS | +Peak | −Peak | +99.9 | −99.9 | +99 | −99 | +90 | −90 |
| Lunette | (V) | 0.2202 | 0.6183 | 0.6521 | 21.071 | −13.44 | 4.802 | −5.761 | 1.5933 | −1.45 | 0.6616 | −0.202 |
| | (T) | −0.1545 | 0.5104 | 0.5332 | 15.779 | −20.02 | 4.5127 | −4.447 | 1.0028 | −1.346 | 0.0511 | −0.366 |
| | (L) | 0.0399 | 0.6974 | 0.6985 | 19.735 | −29.83 | 5.7253 | −7.924 | 1.5271 | −1.671 | 0.2877 | −0.217 |
| Tongue | (V) | 0.13324 | 0.6087 | 0.6231 | 10.218 | −12.37 | 4.929 | −4.901 | 1.5916 | −1.559 | 0.5915 | −0.306 |
| | (T) | 0.14123 | 0.2694 | 0.3041 | 6.8436 | −7.215 | 2.2118 | −1.804 | 0.8591 | −0.576 | 0.3469 | −0.069 |
| | (L) | 0.13663 | 0.2205 | 0.2594 | 3.4864 | −3.999 | 1.9519 | −1.549 | 0.7293 | −0.412 | 0.3091 | −0.05 |
| CG | (V) | −0.1242 | 0.4284 | 0.446 | 4.5005 | −7.643 | 2.5262 | −1.976 | 1.1257 | −1.112 | 0.3346 | −0.578 |
| | (T) | −0.0395 | 0.1547 | 0.1597 | 0.9022 | −1.751 | 0.5993 | −0.930 | 0.3599 | −0.442 | 0.1384 | −0.207 |
| | (L) | 0.1465 | 0.1861 | 0.2368 | 3.447 | −3.808 | 1.7097 | −1.096 | 0.6771 | −0.255 | 0.311 | −0.019 |
| CS For. | (V) | −0.1274 | 0.4411 | 0.4591 | 4.3337 | −7.979 | 2.3179 | −2.677 | 1.0904 | −1.29 | 0.3406 | −0.566 |
| | (T) | 0.021 | 0.2111 | 0.2121 | 3.1715 | −2.835 | 1.1754 | −1.185 | 0.6102 | −0.556 | 0.2416 | −0.192 |
| | (L) | 0.1736 | 0.3394 | 0.3812 | 5.0471 | −6.094 | 2.6709 | −2.045 | 1.1309 | −0.645 | 0.4848 | −0.148 |
| CS Aft | (V) | 0.0349 | 0.7652 | 0.766 | 8.4154 | −6.358 | 5.4353 | −3.009 | 2.3397 | −1.709 | 0.834 | −0.771 |
| | (T) | −0.0232 | 0.5302 | 0.5307 | 6.2574 | −8.565 | 3.6121 | −3.545 | 1.3968 | −1.564 | 0.4568 | −0.484 |
| | (L) | −0.0918 | 0.3226 | 0.3354 | 4.8301 | −4.944 | 2.3277 | −2.099 | 0.8744 | −0.817 | 0.2134 | −0.396 |
| RS For | (V) | −0.0498 | 0.5111 | 0.5135 | 8.202 | −9.584 | 2.807 | −2.972 | 1.3539 | −1.406 | 0.4688 | −0.56 |
| | (T) | 0.1679 | 0.224 | 0.2799 | 3.7841 | −4.518 | 1.3926 | −1.066 | 0.7736 | −0.445 | 0.4001 | −0.057 |
| | (L) | −0.1321 | 0.3325 | 0.3485 | 4.3677 | −7.58 | 2.2229 | −2.075 | 0.7561 | −0.903 | 0.1827 | −0.439 |
| RS Aft | (V) | −0.1377 | 0.6953 | 0.7088 | 10.413 | −3.875 | 5.4252 | −2.643 | 1.8761 | −1.662 | 0.6125 | −0.876 |
| | (T) | 0.139 | 0.4711 | 0.4912 | 9.1632 | −8.374 | 3.4472 | −3.448 | 1.4288 | −1.771 | 0.531 | −0.246 |
| | (L) | 0.1491 | 0.2769 | 0.3144 | 4.6166 | −3.07 | 2.1879 | −1.412 | 0.9581 | −0.446 | 0.434 | −0.111 |
| CS Axle | (V) | −0.0911 | 0.5322 | 0.534 | 4.1965 | −2.985 | 2.9817 | −2.303 | 1.5491 | −1.344 | 0.4993 | −0.669 |
| CS Frame | (V) | −0.0405 | 0.4357 | 0.4376 | 3.5915 | −2.647 | 2.5291 | −1.442 | 1.2945 | −1.021 | 0.4558 | −0.522 |
| RS Axle | (V) | −0.024 | 0.423 | 0.4236 | 4.7063 | −3.578 | 3.0029 | −1.643 | 1.2476 | −0.909 | 0.4925 | −0.446 |
| RS Frame | (V) | 0.0528 | 0.4271 | 0.4303 | 3.6333 | −2.039 | 2.6487 | −1.256 | 1.3515 | −0.878 | 0.5483 | −0.437 |

Rate-Gyro Data

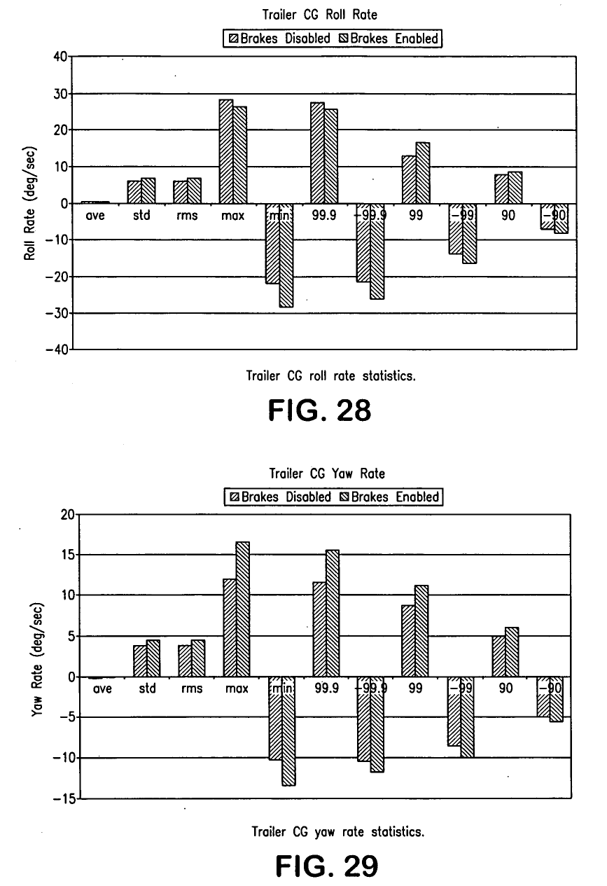

Statistics about the rate-gyro data amplitude distribution for the Perryman #3 test course at 15 mph are given in Tables 9 and 10 for the brakes disabled, and enabled respectively. The statistics can be seen graphically in FIGS. 27 through 29. From the tables and figures, it can be seen that the CG pitch rate was significantly higher than the CG roll and yaw rates for the brakes both disabled and enabled.

TABLE 9
Rate-gyro distribution data (brakes disabled).

| | | Std | | | | | | | | | |
|---|---|---|---|---|---|---|---|---|---|---|---|
| Description | Ave | Dev | RMS | +Peak | −Peak | +99.9 | −99.9 | +99 | −99 | +90 | −90 |
| CG Pitch Rate | 0.5326 | 19.625 | 19.626 | 75.409 | −74.89 | 73.886 | −74.23 | 53.694 | −47.98 | 25.099 | −20.37 |
| CG Roll Rate | 0.2818 | 5.8499 | 5.852 | 28.269 | −21.98 | 27.15 | −21.57 | 12.766 | −13.87 | 7.5439 | −7.346 |
| CG Yaw Rate | −0.238 | 3.8906 | 3.8965 | 12.066 | −10.37 | 11.649 | −10.36 | 8.8219 | −8.525 | 4.9595 | −4.928 |

TABLE 10
Rate-gyro distribution data (brakes enabled).

| | | Std | | | | | | | | | |
|---|---|---|---|---|---|---|---|---|---|---|---|
| Description | Ave | Dev | RMS | +Peak | −Peak | +99.9 | −99.9 | +99 | −99 | +90 | −90 |
| CG Pitch Rate | 0.5062 | 21.129 | 21.13 | 86.102 | −86.51 | 82.994 | −83.46 | 65.056 | −55.19 | 24.919 | −22.35 |
| CG Roll Rate | 0.1854 | 6.816 | 6.817 | 26.256 | −28.47 | 25.406 | −26.22 | 16.541 | −16.64 | 8.6564 | −8.413 |
| CG Yaw Rate | −0.033 | 4.5215 | 4.5206 | 16.61 | −13.42 | 15.613 | −11.70 | 11.204 | −9.906 | 6.0071 | −5.589 |

Linear Displacement Transducer Data

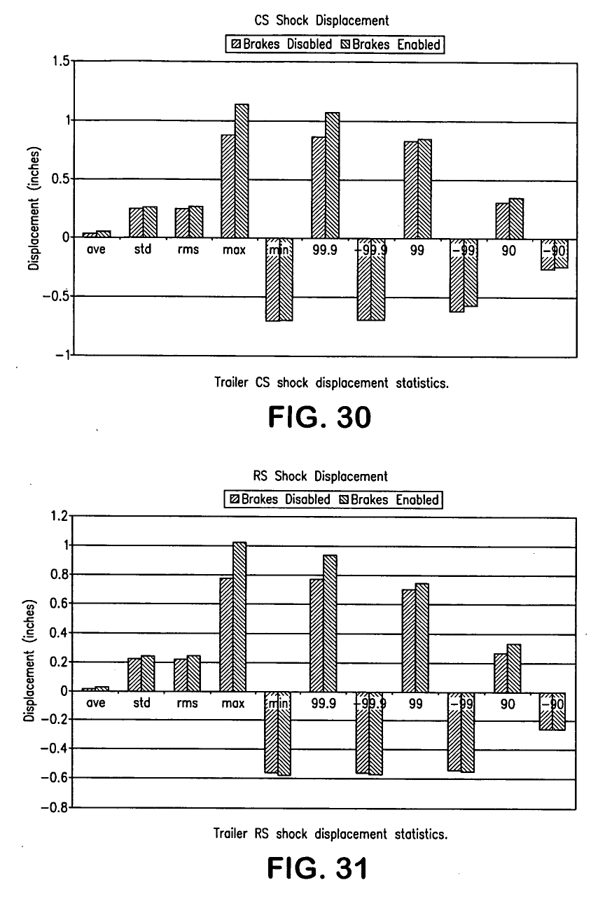

Statistics about the rate-gyro data amplitude distribution for the Perryman #3 test course at 15 mph are given in Tables 11 and 12 for the brakes disabled, and enabled respectively. The statistics can be seen graphically in FIGS. 30 and 31. From the tables and figures, it can be seen that both the CS and RS shock displacements were greater for the test data for the brakes enabled than for the brakes disabled test data.

TABLE 11
Linear displacement distribution data (brakes disabled).

| | | Std | | | | | | | | | |
|---|---|---|---|---|---|---|---|---|---|---|---|
| Description | Ave | Dev | RMS | +Peak | −Peak | +99.9 | −99.9 | +99 | −99 | +90 | −90 |
| CS Shock | 0.0305 | 0.24631 | 0.2481 | 0.8698 | −0.703 | 0.86805 | −0.692 | 0.82091 | −0.618 | 0.3067 | −0.254 |
| Displacement | | | | | | | | | | | |
| RS Shock | 0.0132 | 0.2217 | 0.222 | 0.7777 | −0.555 | 0.77536 | −0.552 | 0.70989 | −0.533 | 0.2702 | −0.25 |
| Displacement | | | | | | | | | | | |

TABLE 12
Linear displacement distribution data (brakes enabled).

| | | Std | | | | | | | | | |
|---|---|---|---|---|---|---|---|---|---|---|---|
| Description | Ave | Dev | RMS | +Peak | −Peak | +99.9 | −99.9 | +99 | −99 | +90 | −90 |
| CS Shock | 0.0538 | 0.2594 | 0.2649 | 1.1323 | −0.7 | 1.0674 | −0.691 | 0.845 | −0.57 | 0.35244 | −0.246 |
| Displacement | | | | | | | | | | | |
| RS Shock | 0.0258 | 0.2417 | 0.243 | 1.0241 | −0.571 | 0.9407 | −0.558 | 0.7497 | −0.542 | 0.33093 | −0.252 |
| Displacement | | | | | | | | | | | |

Pressure Transducer Data

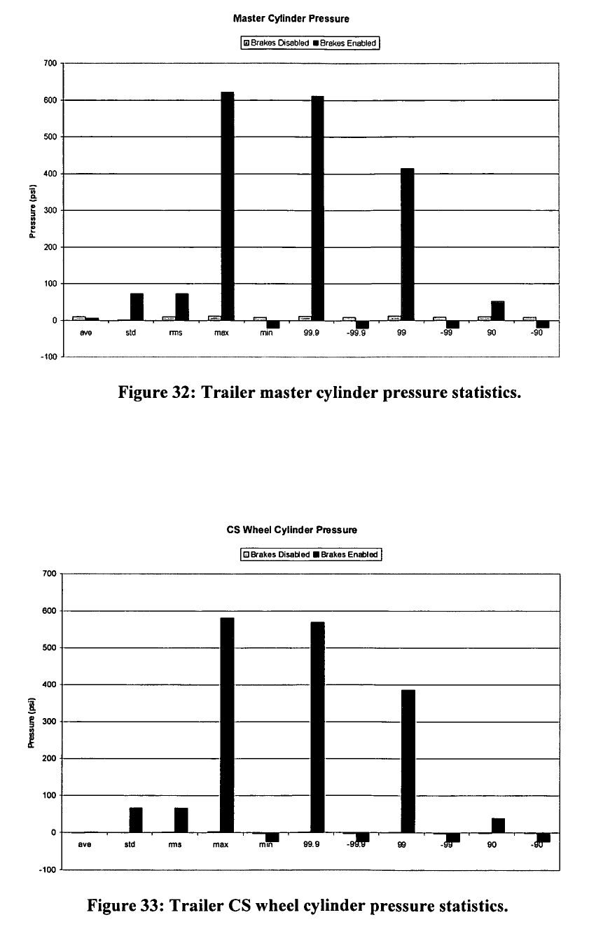

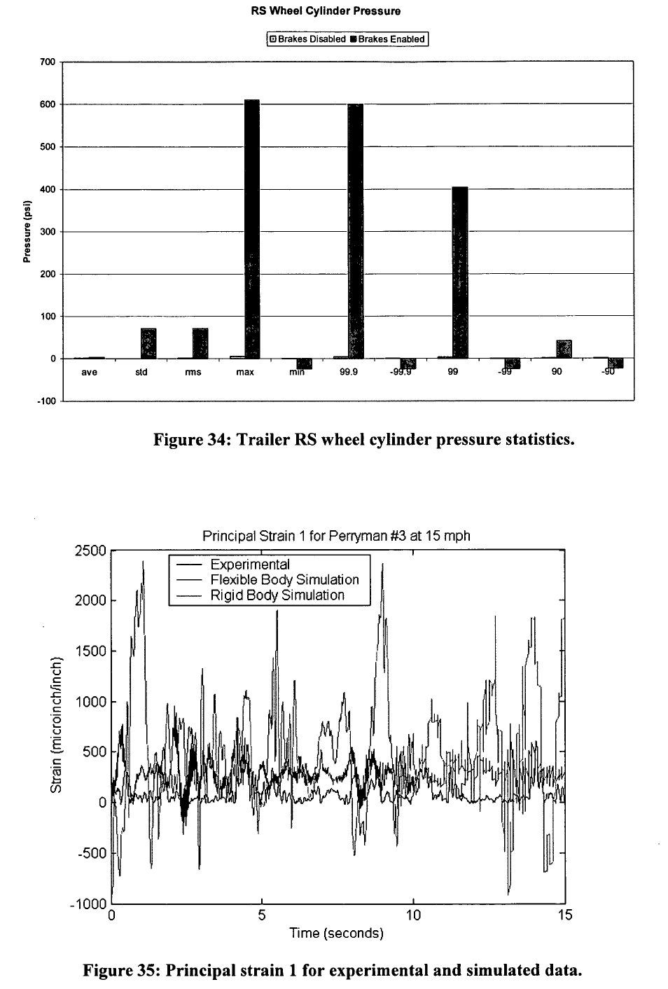

Statistics about the rate-gyro data amplitude distribution for the Perryman #3 test course at 15 mph are given in Tables 13 and 14 for the brakes disabled, and enabled respectively. The statistics can be seen graphically in FIGS. 32 through 34. The surge brake statistics will be discussed hereinafter.

TABLE 13
Brake pressure distribution data (brakes disabled).

| | | Std | | | | | | | | | |
|---|---|---|---|---|---|---|---|---|---|---|---|
| Description | Ave | Dev | RMS | +Peak | −Peak | +99.9 | −99.9 | +99 | −99 | +90 | −90 |
| Master | 9.4367 | 0.4364 | 9.4468 | 11.717 | 8.1985 | 11.372 | 8.3904 | 10.855 | 8.6425 | 9.9773 | 8.9646 |
| Cylinder | | | | | | | | | | | |
| Pressure | | | | | | | | | | | |
| CS Wheel | −1.495 | 0.5439 | 1.5905 | 3.8995 | −2.072 | 2.8229 | −1.951 | 1.7807 | −1.745 | −1.562 | −1.62 |
| Brake | | | | | | | | | | | |
| Pressure | | | | | | | | | | | |
| RS Wheel | 1.1399 | 0.3615 | 1.1958 | 5.283 | 0.5786 | 4.6211 | 0.733 | 3.1368 | 0.91659 | 1.1409 | 1.048 |
| Brake | | | | | | | | | | | |
| Pressure | | | | | | | | | | | |

TABLE 14
Other amplitude distribution data (brakes enabled).

| | | Std | | | | | | | | | |
|---|---|---|---|---|---|---|---|---|---|---|---|
| Description | Ave | Dev | RMS | +Peak | −Peak | +99.9 | −99.9 | +99 | −99 | +90 | −90 |
| Master | 6.1166 | 72.906 | 73.159 | 622.15 | −22.07 | 611.6 | −21.71 | 413.97 | −21.06 | 51.59 | −20.49 |
| Cylinder | | | | | | | | | | | |
| Pressure | | | | | | | | | | | |
| CS Wheel | 2.3007 | 67.735 | 67.772 | 581.19 | −24.25 | 569.13 | −24.06 | 385.65 | −23.71 | 39.852 | −23.03 |
| Brake | | | | | | | | | | | |
| Pressure | | | | | | | | | | | |
| RS Wheel | 3.2322 | 71.075 | 71.145 | 609.93 | −24.41 | 598.56 | −24.23 | 404.17 | −23.78 | 41.719 | −23.1 |
| Brake | | | | | | | | | | | |
| Pressure | | | | | | | | | | | |

DADS Validation

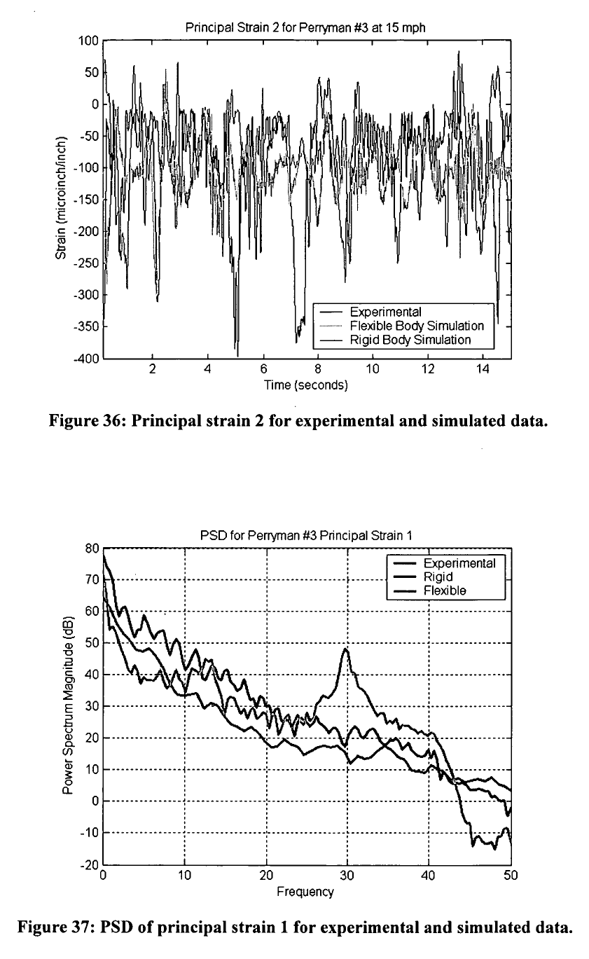

Rigid and flexible body DADS simulations were made of the Perryman #3 course at 15 mph. The loads from DADS were then used by NASTRAN to calculate the principal strains at various locations on the trailer. One of the locations was at the failure point on the drawbar. The statistics for 15 seconds of data for the experimental and simulated strains, for both the rigid and flexible body models can be found in Table 15 and FIGS. 35 and 36. It is important to recognize that the experimental and simulated data were not taken at the same point on the test course. From the table and figures, it can be seen that the flexible body model more closely represents the experimental data in the time domain. For principal strain 1, the flexible body model has a magnitude that is double the experimental data, as reflected in all the statistics. The data from the flexible body model more closely represents the experimental data for principal strain 2, with a reduction in the standard deviation and range. The time data from the model does not adequately represent the experimental data.

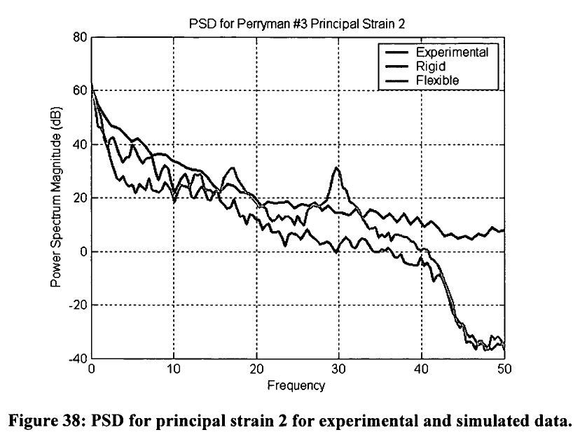

To further examine the models, the frequency content must be analyzed. From FIGS. 37 and 38 it can bee seen that the PSDs of the rigid and flexible body models have higher magnitudes, but the models do adequately represent the frequency content of the experimental strain data, except for a peak at 30 Hz for the flexible body model. The rolloff after 40 Hz for the simulated data is a function of the sampling frequency and not the model.

TABLE 15
DADS validation statistics.

| | Principal Strain 1 | | | Principal Strain 2 | | |
|---|---|---|---|---|---|---|
| Statistics | Exp. | Rigid | Flexible | Exp. | Rigid | Flexible |
| Mean | 94.7697 | 523.2 | 285.1 | −99.6982 | −68.72 | −106 |
| Standard | 102.3792 | 590.1 | 135 | 96.3041 | 65.94 | 42.18 |
| Deviation | | | | | | |
| RMS | 139.5106 | 788.4728 | 315.4487 | 138.6049 | 95.2253 | 114.0718 |
| Maximum | 605.2628 | 2390 | 956 | −5.186 | 89.46 | 55.78 |
| Minimum | −39.1682 | −918 | −318 | −770.1156 | −289.3 | −306.9 |
| Range | 644.431 | 3308 | 1274 | 775.3016 | 378.76 | 362.68 |

### C. PSD Conversion of Data from Sensors

Introduction

The PSD is a widely recognized means of representing random processes in the frequency domain. For terrain monitoring, it compresses the spatial data of the profilometer by representing it as a PSD magnitude vs. wavelength. The vertical axis of the PSD has units of elevation cubed per cycle, while the horizontal axis has units of cycles per unit length. For the PSD to be used by DADS, it will have to be converted back to spatial data. This will give a normally distributed model for the course that was used to collect data for the PSD. The conversion of the PSD to data in the spatial domain, that has an equivalent frequency content to the original data set, is an initial step in determining if stored terrain data can be used with the DADS program.

PSD

A PSD is the representation of the frequency, co, content of a time, t, signal W(t) (Ljung and Glad, 1994). The Fourier transform of the signal, W(ω), can be used to calculate the PSD.
W(ω)=ƒ_{∞}^{∞}W(t)e^{-iωt}dt (16)

The Fourier transform is a complex number having a magnitude and a phase. The magnitude is the square root of the sum of the squares of the real and imaginary parts of the transform.
|W(ω)|={square root over (Re(W(ω))²+Im(W(ω))²)} (17)

The phase angle, φ(ω), is the inverse tangent of the ratio of the imaginary and real parts of the transform.

$$ϕ ( ω ) = {tan}^{- 1} \frac{Im ( W ( ω ) )}{Re ( W ( ω ) )} \qquad ( 18 )$$

For signals with finite energy, the PSD can be defined as the square of the magnitude of the Fourier transform.
Φ_{ω}=|W(ω)|² (19)

This value is then usually divided by product of the sampling frequency, fₛ, and signal length L. Other denominators may be used, since they are scaling factors.

$${Φ}_{ω} = \frac{\vert W ( ω ) {\vert}^{2}}{{f}_{s} \cdot L} \qquad ( 20 )$$

The energy of the signal, Φ_{ω}, has dimensions of power/frequency and is measured between ω₁ and ω₂.
PSD=∫_{ω}_{₁}^{ω}^{₂}Φ_{ω}(ω)dω (21)
PSD Conversion Method

To return the PSD to a statistical equivalent of the original data, the PSD must first be multiplied by the denominator that was originally used, which is fₛ*L.
|W(ω)|²=fₛ·L·Φ_{ω} (22)
The square root of the converted data can be taken and the Fourier transform inversed. If the length of the signal, L, cannot be determined from the stored PSDs, the product of the sampling frequency, fₛ, and the window size, T, will be used for L. This modifies the denominator in equation (22).
|W(ω)|²=fₛ·T·Φ_{ω} (23)

Since only the magnitude of the Fourier transform is used when calculating the PSD; the phase angles, φ(ω), for the data points are lost. Without the phase angles an inverse Fourier transform cannot be used to return the data to its original form. To eliminate this problem, a set of random phase angles, between zero and one, must be created to reconstruct a statistical equivalent of the Fourier transform of the original data. The phase angles are then applied to both the real and imaginary parts of the signal.
Re(W(ω))=\sqrt{fₛ·T*Φ(ω)}*cos(φ(ω)) (24)
Im(W(ω))=−\sqrt{fₛ·T*Φ(ω)}*sin(φ(ω)) (25)
W(ω)=Re(W(ω))+Im(W(ω)) (26)

An inverse Fourier transform can then be performed to get a statistical equivalent of the original data W(t). The inverse of the Fourier transform is calculated by:

$$W ( t ) = \frac{1}{2 π} {\int }_{- ∞}^{∞} {W ( ω )}^{ⅈω t} ⅆ ω \qquad ( 27 )$$

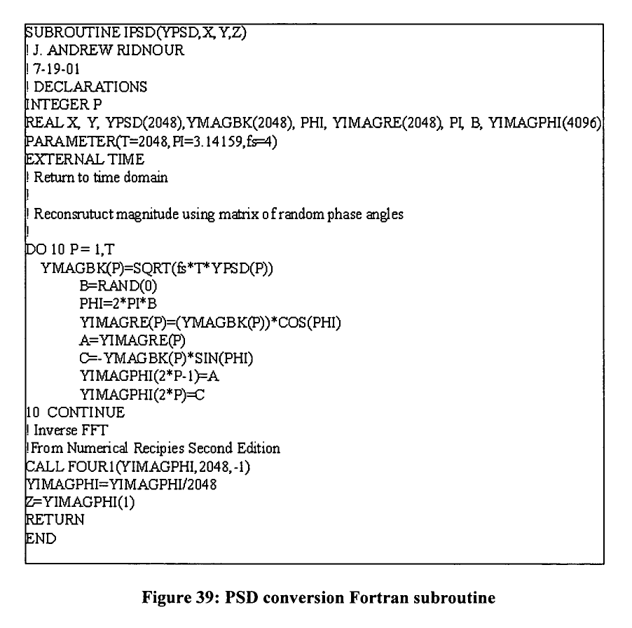

The subroutines used by DADS must be written in Fortran. A subroutine, shown in FIG. 39, was created in Fortran to inverse the PSD, for later used in DADS. This subroutine uses a window size of 2048 and a sampling frequency of 4 samples/ft. Since the signal length is not known for the known ATC PSDs, the window value is also used as the signal length.

The subroutine first reads in the PSD data. Each data point is then multiplied by the denominator, fₛ*T, and the square root of the product is taken. A random number is then created using the random number generator in Fortran. The random number is then multiplied by 2π, to generate the phase angle. The phase angle is then applied to the real and imaginary parts of the signal using the cosine and sine functions, respectively, which allow the Fourier transform to be inversed. The inverse FFT routine from the Numerical Recipes Book (Press et al., 1992) is then used to inverse the Fourier transform.

PSD Conversion Results

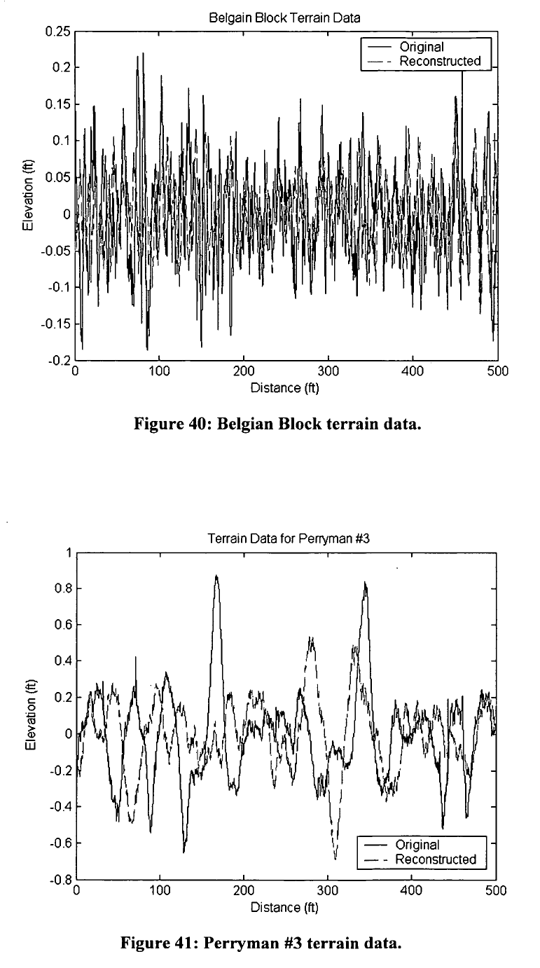

PSDs of terrain data from both the Belgian Block and Perryman #3 test courses were used to test the PSD inversion method and routine. The univariate statistics for the reconstructed data are shown in Table 16. The reconstructed terrain data is shown in FIGS. 40 and 41 for the Belgian Block and Perryman #3 test courses, respectively. For the Belgian Block test course, the difference between the original and reconstructed mean, standard deviation, and range, was 1.481E-5 ft (14.55%), 0.00194 ft (3.20%), and 0.3845 ft (73.97%), respectively. For the Perryman #3 data, the difference between the original and reconstructed mean, standard deviation, and range, was −0.0005 ft (38.46%), 0.0766 ft (4.765%), and 0.9029 ft (16.476%), respectively. The difference in the mean values was expected since the terrain data is randomly reconstructed. The small differences in standard deviation were also expected since the standard deviation relates to the variation in the data. The large differences in range are due to the fact the signal length for the PSD was not known, and was assumed to be the window. This is acceptable since the main goal is to represent the frequency content of the original data. Once the PSD subroutine is implemented in DADS, simulation results will be available to determine the effect of the reduction in range.

TABLE 16
Univariate statistics for terrain data.

| | Perryman #3 | | Belgian Block | |
|---|---|---|---|---|
| | Original | Reconstructed | Original | Reconstructed |
| Mean | −0.0013 | −0.0018 | 1.0181E−4 | 8.7E−5 |
| Standard Dev. | 0.2358 | 0.3124 | 0.06284 | 0.0609 |
| Range | 1.6076 | 0.7047 | 0.5198 | 0.1353 |

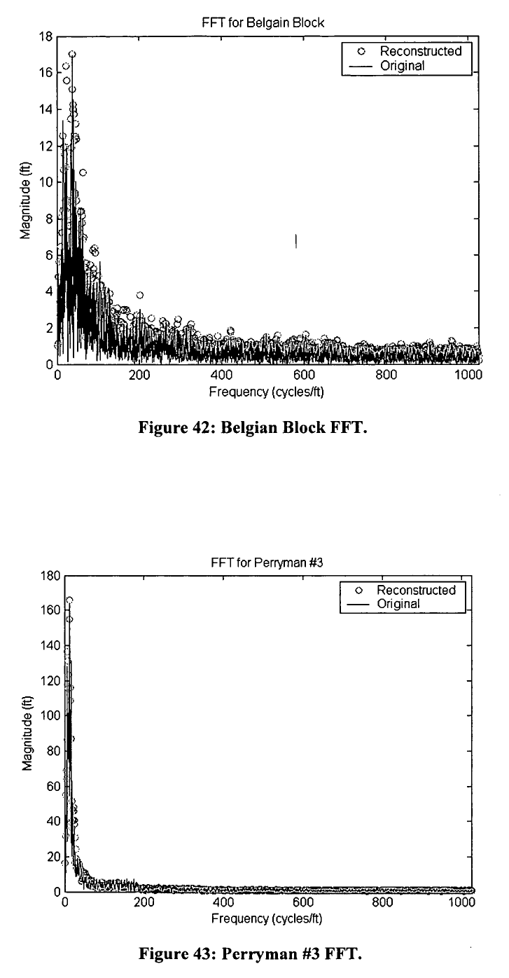

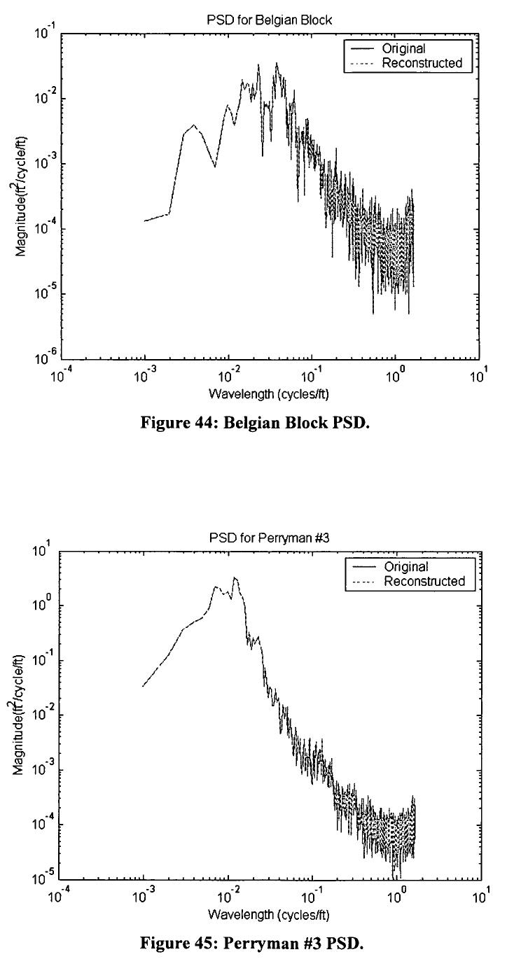

The frequency of the terrain that is transferred to the trailer is thought to be more important in determining the durability. To check the frequency content of the re-created signal, the FFT and PSD of the original and reconstructed signals were compared, as shown in FIGS. 42 through 45. From the figures it can be seen that the terrain data can be reconstructed with an equivalent of the frequency content of the original terrain data.

### D. Surge Brake Analysis to Eliminate Sensor Data Variables Not Relevant to Strains at Failure Location

To optimize the current DADS model, it is important to determine which sensor data variables are not relevant to the strains at the location of the drawbar failure. By determining the non-relevant variables, they can be eliminated. Of particular interest, in this case, are the surge brake pressures on the trailer. In the current methodology, it was suspected that the hydraulic surge brake was contributing to fatigue failures of the trailer drawbar. By determining if the brake pressure variables are relevant, having a significant effect on the strains, we can determine if the brake activation has an effect on the life of the trailer. If the brake pressure variables do not have an effect on the strains, a model of the brake is not required in the simulation.

The trailer was instrumented and tested at the U.S. Army Aberdeen Test Center (ATC). Testing was performed, both with a normally operational surge brake system, and with the system physically disabled. Of interest in this chapter, are the statistical effects of the braking system on the trailer drawbar strains in the region of failure.

Hydraulic Surge Brake Operation

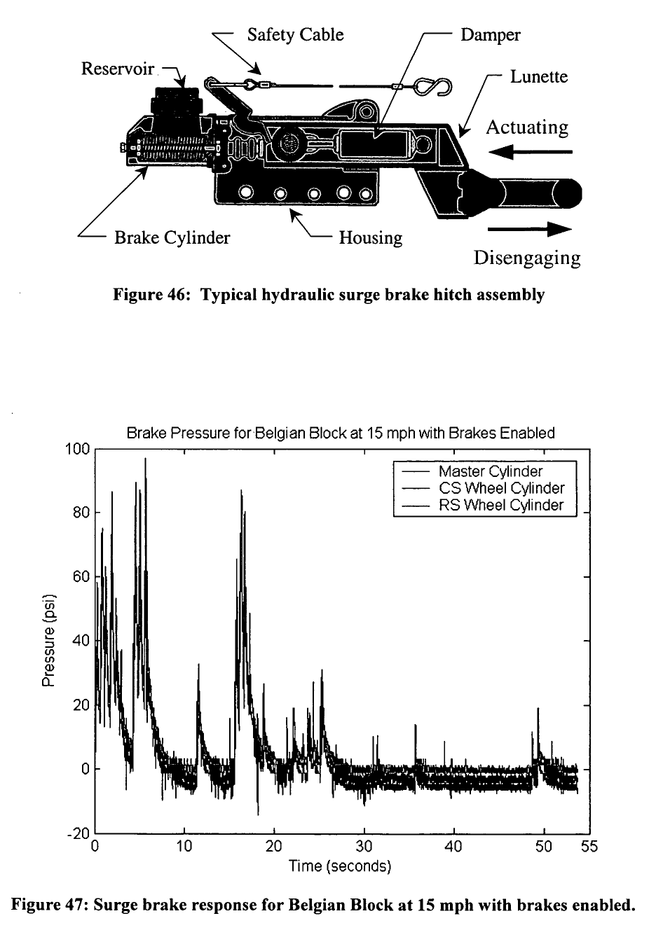

Hydraulic surge brakes are actuated by a force acting on the trailer hitch between the tow vehicle and trailer. Only negative forces, due to braking or deceleration of the tow vehicle, or in some instances backing in reverse, can actuate the brake system. A typical surge brake hitch assembly is shown in FIG. 46. When actuated, the lunette translates with respect to the housing and presses on the brake cylinder, causing hydraulic pressure to be transmitted to the drum brakes. The damper controls the rate of actuation, both engaging and disengaging, so that the brakes do not operate as a ‘bang-bang’ system.

Test Data

Both the Belgian Block and Perryman #3 for runs with the brakes both enabled and disabled was used for this analysis. A listing of the instrumentation channels from the test data appears in Table 17. For the purposes of this application, the data channels were divided into three groups; input channels, output channels, and ignored channels. The output channels consisted of the strain gauge rosette located closest to the predicted point of failure. This is identified as the bottom drawbar center-aft rosette in the table. Other strain gauge channels, as well as the tow vehicle speed were ignored. This left the accelerometers, rate gyros, pressure transducers, and position transducers to represent the input variables to the system.

TABLE 17
Listing of Data Acquisition Channels and Grouping.

| # | Description | Group |
|---|---|---|
| 1 | Time | Ignored |
| 2 | Btm Drwbr Cntr (T) Strain | Ignored |
| 3 | Btm Drwbr Cntr (45) Strain | Ignored |
| 4 | Btm Drwbr Cntr (L) Strain | Ignored |
| 5 | Btm Drwbr Cntr Aft (T) | Output |
| | Strain | |
| 6 | Btm Drwbr Cntr Aft (45) | Output |
| | Strain | |
| 7 | Btm Drwbr Cntr Aft (L) | Output |
| | Strain | |
| 8 | Btm Drwbr CS Edge (T) | Ignored |
| | Strain | |
| 9 | Btm Drwbr CS Edge (45) | Ignored |
| | Strain | |
| 10 | Btm Drwbr CS Edge (L) | Ignored |
| | Strain | |
| 11 | Btm Drwbr CS Edge Aft | Ignored |
| | (T) Strain | |
| 12 | Btm Drwbr CS Edge Aft | Ignored |
| | (45) Strain | |
| 13 | Btm Drwbr CS Edge Aft | Ignored |
| | (L) Strain | |
| 14 | Top Triang Plate Corner | Ignored |
| | (T) Strain | |
| 15 | Top Triang Plate Corner | Ignored |
| | (45) Strain | |
| 16 | Top Triang Plate Corner | Ignored |
| | (L) Strain | |
| 17 | Btm Triang Plate Corner | Ignored |
| | (T) Strain | |
| 18 | Btm Triang Plate Corner | Ignored |
| | (45) Strain | |
| 19 | Btm Triang Plate Corner | Ignored |
| | (L) Strain | |
| 20 | Left Angle Plate Lower (V) | Ignored |
| | Strain | |
| 21 | Left Angle Plate Lower | Ignored |
| | (45) Strain | |
| 22 | Left Angle Plate Lower (L) | Ignored |
| | Strain | |
| 23 | Left Angle Plate Upper (V) | Ignored |
| | Strain | |
| 24 | Left Angle Plate Upper | Ignored |
| | (45) Strain | |
| 25 | Left Angle Plate Upper (L) | Ignored |
| | Strain | |
| 26 | Curbside Axle Vert. | Input |
| | Accel. | |
| 27 | Curbside Frame Vert | Input |
| | Accel | |
| 28 | Roadside Axle Vert. | Input |
| | Accel. | |
| 29 | Roadside Frame Vert. | Input |
| | Accel. | |
| 30 | Lunette Vert Accel | Input |
| 31 | Lunette Trans. Accel. | Input |
| 32 | Lunette Long. Accel. | Input |
| 33 | Tongue Vert. Accel. | Input |
| 34 | Tongue Trans. Accel. | Input |
| 35 | Tongue Long. Accel. | Input |
| 36 | CG Vert. Accel. | Input |
| 37 | CG Trans. Accel. | Input |
| 38 | CG Long. Accel. | Input |
| 39 | Curbside Front Vert. | Input |
| | Accel. | |
| 40 | Curbside Front Trans. | Input |
| | Accel. | |
| 41 | Curbside Front Long. | Input |
| | Accel. | |
| 42 | Curbside Rear Vert. | Input |
| | Accel. | |
| 43 | Curbside Rear Trans. | Input |
| | Accel. | |
| 44 | Curbside Rear Long. | Input |
| | Accel. | |
| 45 | Roadside Front Vert. | Input |
| | Accel. | |
| 46 | Roadside Front Trans. | Input |
| | Accel. | |
| 47 | Roadside Front Long. | Input |
| | Accel. | |
| 48 | Roadside Rear Vert. | Input |
| | Accel. | |
| 49 | Roadside Rear Trans. | Input |
| | Accel. | |
| 50 | Roadside Rear Long. | Input |
| | Accel. | |
| 51 | Pitch Rate | Input |
| 52 | Roll Rate | Input |
| 53 | Yaw Rate | Input |
| 54 | Curbside Shock | Input |
| | Length | |
| 55 | Roadside Shock | Input |
| | Length | |
| 56 | Master Cylinder Press. | Input |
| 57 | Curbside Brake Press. | Input |
| 58 | Roadside Brake Press. | Input |
| 59 | Tow Vehicle Speed | Ignored |

Four test runs were used for analysis of the surge brake. The test runs were on the Belgian Block and Perryman #3 test courses with the tow vehicle/trailer speed at nominally 15 mph. Two test runs were performed on each test course. On one of the test runs for each course, the brake system was operating normally. On the second run, the brake system was disabled by fixing the lunette, preventing the actuation of the brake master cylinder.

The brakes pressure variables are for the master cylinder, RS wheel cylinder, and CS wheel cylinder. The strains are the transverse, 45 degree, and longitudinal strains for the center drawbar aft location. The brake pressure data from all four test runs, which includes the runs with the brakes disabled, was analyzed to look for errors and potential analysis problems.

Belgian Block

For the test data from the Belgian Block test course at 15 mph with the brakes enabled. Table 18 shows the brake pressures to be highly correlated. Although the CS wheel cylinder pressure has lower mean and minimum values than the RS wheel cylinder, indicating a possible bias in the system. Ideally, the losses between the master and wheel cylinders should be equivalent.

As you can see from Table 19 and FIG. 47, the brake pressures are highly correlated and have the same changes in magnitude. Although the RS wheel cylinder pressure is not as highly correlated with the master cylinder, also indicating a possible bias in the system. The friction losses between the master and wheel cylinders should only cause a pressure drop between the master and wheel cylinders, and the wheel cylinders should have the same pressures.

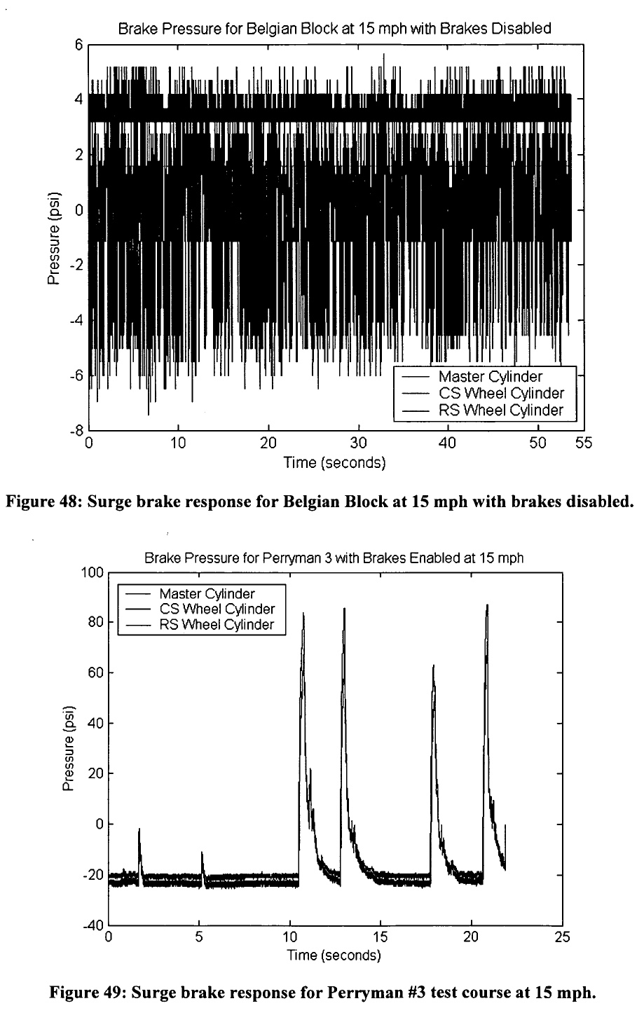

For the test data from the Belgian Block at 15 mph with the brakes disabled, the wheel cylinder pressures were not constant, as shown in Table 20 and FIG. 48. This was not expected since the surge brake was disabled and the brake pressures should remain constant. The variations in the master cylinder and RS wheel cylinder pressures were very small and can be contributed to the sensor noise in data collection. The CS wheel cylinder pressure variation was enough to affect the regression model, but not activate the brake. It cannot be determined if the variation in the CS wheel cylinder pressure was from the sensor, noise, or the brake dragging slightly. The surge brake was not activating since the master cylinder and RS wheel cylinder pressures remained constant. There was also a calibration problem as seen in Belgian Block at 15 mph with brakes enabled, as expected, since the runs with brakes disabled and enabled were consecutive, and had the same calibration. Due to the effect of the CS wheel cylinder pressure on the model, the brake pressure variables were then removed from the model. The errors in brake pressures also explain some of the results from the analysis of Belgian Block at 15 mph with brakes enabled, and validates the assumptions of errors in the pressure data.

TABLE 18
Statistics for brake pressures for Belgian Block
at 15 mph with brakes enabled.

| | Minimum (psi) | Mean (psi) | Maximum (psi) |
|---|---|---|---|
| Master Cylinder | −3.6135 | 7.7645 | 91.7407 |
| CS Wheel Cylinder | −10.4465 | 2.1369 | 76.6134 |
| RS Wheel Cylinder | −4.9795 | 4.9117 | 75.3901 |

TABLE 19
Correlation coefficient between brake pressures for
Belgian Block at 15 mph with brakes enabled.

| | Master | CS Wheel | RS Wheel |
|---|---|---|---|
| | Cylinder | Cylinder | Cylinder |
| Master Cylinder | 1.0000 | 0.9889 | 0.9639 |
| CS Wheel Cylinder | 0.9889 | 1.0000 | 0.9857 |
| RS Wheel Cylinder | 0.9639 | 0.9857 | 1.0000 |

TABLE 20
Statistics for brake pressures for Belgian Block
at 15 mph with brakes disabled.

| | Minimum (psi) | Mean (psi) | Maximum (psi) |
|---|---|---|---|
| Master Cylinder | 3.0166 | 3.5226 | 4.8359 |
| CS Wheel Cylinder | −6.5763 | −0.2867 | 4.5523 |
| RS Wheel Cylinder | 0.1862 | 1.5529 | 1.7714 |

Perryman #3

For the test data from the Perryman #3 test course at 15 mph with the brakes enabled, an analysis of the data shows, in Table 21, that there was a pressure loss (as would be expected) between the master and wheel cylinders, and there was also a calibration problem. As you can see from Table 22 and FIG. 49, the brake pressures are well correlated and have the same changes in magnitude. The range for the wheel cylinder pressures is 89.647 psi and 98.77 psi for the CS and RS wheel cylinders, respectively. These values indicating a possible difference in actuation between the CS and RS wheel cylinders. The range for the master cylinder pressure was 110.122. The friction losses between the master and wheel cylinders should only cause a pressure drop between the master and wheel cylinders and the wheel cylinders should have the same pressures.

For the test data from the Perryman #3 test course at 15 mph with the brakes disabled, an analysis of the data shows, in Table 23, that the brake pressure did not remain constant, and there was also a calibration problem. The calibration problem would be expected since the Perryman #3 runs at 15 mph with the brakes both disabled and enabled were consecutive and had the same calibration.

It cannot be determined if the variation in the brake pressures were from the sensor, noise, or the brake dragging slightly. As you can see from Table 24 and FIG. 50, the brake pressures are not very well correlated and do not have the same changes in magnitude, which would indicate the pressure variations are probably due to noise in the system and not partial actuation. These pressure variations could affect the regression model and the variables should be removed from the model. The range for the wheel cylinder pressures is 6.791 psi and 6.22 psi for the CS and RS wheel cylinders, respectively. These values indicate no brake actuation for both wheel cylinders.

TABLE 21
Statistics for brake pressures for Perryman #3 test course
at 15 mph with brakes enabled.

| | Minimum (psi) | Mean (psi) | Maximum (psi) |
|---|---|---|---|
| Master Cylinder | −23.232 | −13.1417 | 86.89 |
| CS Wheel Cylinder | −21.9140 | −16.1996 | 67.7330 |
| RS Wheel Cylinder | −25.4010 | −15.9754 | 73.3690 |

TABLE 22
Correlation coefficient between brake pressures for Perryman #3 test
course at 15 mph with brakes enabled.

| | Master | CS Wheel | RS Wheel |
|---|---|---|---|
| | Cylinder | Cylinder | Cylinder |
| Master Cylinder | 1.0000 | 0.9886 | 0.9804 |
| CS Wheel Cylinder | 0.9886 | 1.0000 | 0.9963 |
| RS Wheel Cylinder | 0.9804 | 0.9963 | 1.0000 |

TABLE 23
Statistics for brake pressures for Perryman #3
at 15 mph with brakes disabled.

| | Minimum (psi) | Mean (psi) | Maximum (psi) |
|---|---|---|---|
| Master Cylinder | 6.6650 | 9.5471 | 12.146 |
| CS Wheel Cylinder | −2.6010 | −1.5177 | 4.19 |
| RS Wheel Cylinder | 0.0550 | 1.1530 | 6.165 |

TABLE 24
Correlation coefficient between brake pressures for Perryman #3 at 15
mph with brakes disabled.

| | Master | CS Wheel | RS Wheel |
|---|---|---|---|
| | Cylinder | Cylinder | Cylinder |
| Master Cylinder | 1.0000 | 0.346 | 0.242 |
| CS Wheel Cylinder | 0.346 | 1.0000 | 0.0587 |
| RS Wheel Cylinder | 0.242 | 0.0587 | 1.0000 |

Analysis Method

The four test runs measured by ATC need to be evaluated to compare the effects of the surge brake on the measured strain. Assuming that the brake torques, which are generated by the brake pressure, have a direct relationship to the measured strain, a regression model can be developed to represent this relationship. However, other measured responses, such as longitudinal acceleration may also affect the relationship. Given that 59 channels of data were measured for each run, and 33 of those were considered as input variables, the task of determining which of the data channels was relevant to the observed response (strain) and which were non-relevant was required to reduce the size of the dataset.

The non-relevant variables were determined by using principal component analysis and multivariate regression. Several regression models were created:
Brakes enabled, brake pressure data included in regression.
Brakes enabled, brake pressure data removed from regression.
Brakes disabled, brake pressure data removed from regression.
Concatenated dataset, combining both brakes enabled and disabled.
   The regression models were developed using both the data as measured, and using the principal component variables, which form an uncorrelated, orthogonal set of predictor variables.
   Regression Analysis for Belgian Block (Brakes Enabled)

The non-relevant variables were determined by using multivariate regression. Regression analysis is used for description, control, and prediction of data. SAS and Matlab were used to perform the statistical analyses. The data was stored in a matrix form with one column for each data channel. To simplify the regression equations in SAS the channels used the variable names shown in Table 25.

A multivariate regression that included pairwise interaction effects was created to determine if there were any significant interactions between the input variables. The models for transverse, 45 degree, and longitudinal strain had overall R² values of 0.8666, 0.8952, and 0.9086, respectively.

Three regression models, without interaction effects, were created to initially determine which variables contained the least amount of significant information. The first strain model created was for the transverse strain. The variable for ground speed was eliminated before the models were created. Using a stepwise regression model we can see that the R² value for the model using all 33 independent variables is 0.7879 and with the brake pressure data eliminated the R² is 0.7832. It is interesting to note that if ground speed is eliminated, the R² value does not change. If the RS longitudinal lunette acceleration, CG pitch rate, CG roll rate, and CG yaw rate are also eliminated the R² value is 0.7716. This pattern continues throughout the model, with the reduction in variables not reducing R by a significant amount by each reduction, until only highly correlated variables are left. Note that the R² value of the entire model decreased significantly with the removal of the terms for interaction effects.

TABLE 25
Column and variable numbers for data channels of reduced data sets.

| Col | Var | Description | Units |
|---|---|---|---|
| 1 | F1 | Btm Drwbr Cntr Aft ε (T) | μ inch |
| 2 | F2 | Btm Drwbr Cntr Aft ε | μ inch |
| | | (45) | |
| 3 | F3 | Btm Drwbr Cntr Aft ε (L) | μ inch |
| 4 | F4 | CS Axle Accel (V) | g's |
| 5 | F5 | CS Frame Accel (V) | g's |
| 6 | F6 | RS Axle Accel (V) | g's |
| 7 | F7 | RS Frame Accel (V) | g's |
| 8 | F8 | Lunette Accel (V) | g's |
| 9 | F9 | Lunette Accel (T) | g's |
| 10 | F10 | Lunette Accel (L) | g's |
| 11 | F11 | Tongue Accel (V) | g's |
| 12 | F12 | Tongue Accel (T) | g's |
| 13 | F13 | Tongue Accel (L) | g's |
| 14 | F14 | Trailer CG Accel (V) | g's |
| 15 | F15 | Trailer CG Accel (T) | g's |
| 16 | F16 | Trailer CG Accel (L) | g's |
| 17 | F17 | CS Forward Accel (V) | g's |
| 18 | F18 | CS Forward Accel (T) | g's |
| 19 | F19 | CS Forward Accel (L) | g's |
| 20 | F20 | CS Aft Accel (V) | g's |
| 21 | F21 | CS Aft Accel (T) | g's |
| 22 | F22 | CS Aft Accel (L) | g's |
| 23 | F23 | RS Forward Accel (V) | g's |
| 24 | F24 | RS Forward Accel (T) | g's |
| 25 | F25 | RS Forward Accel (L) | g's |
| 26 | F26 | RS Aft Accel (V) | g's |
| 27 | F27 | RS Aft Accel (T) | g's |
| 28 | F28 | RS Aft Accel (L) | g's |
| 29 | F29 | Trailer CG Pitch Rate | deg/sec |
| 30 | F30 | Trailer CG Roll Rate | deg/sec |
| 31 | F31 | Trailer CG Yaw Rate | deg/sec |
| 32 | F32 | CS Shock Disp | inches |
| 33 | F33 | RS Shock Disp | inches |
| 34 | F34 | Surge Brake Press. | psi |
| 35 | F35 | CS Wheel Brake Press. | psi |
| 36 | F36 | RS Wheel Brake Press. | psi |
| 37 | F37 | Long. Ground Speed | mph |
| 38 | off | Added Class Variable | n/a |

The second strain model created was for the 45 degree strain. Using a stepwise regression model we can see that the R² value for the model using all 33 independent variables is 0.8016 and with the brake pressure data eliminated the R² is 0.7957. It is interesting to note that if ground speed is eliminated, the R² value does not change. If longitudinal lunette acceleration, transverse CS aft acceleration, CG pitch rate, CG roll rate, and CG yaw rate are also eliminated the R² value drops to 0.7862.

The third strain model created was for the longitudinal strain. Using a stepwise regression model we can see that the R value for the model using all 33 independent variables is 0.8143 and with the brake pressure data eliminated the R² is 0.8081. If the CG roll and yaw rates are then eliminated, the R² drops to 0.8072. If longitudinal lunette acceleration, and CG pitch rate are also eliminated the R value drops to 0.7951. If transverse lunette acceleration and longitudinal ground speed are eliminated, the R² drops to 0.7941.

A multivariate regression with interactions was again created with the brake pressure variables eliminated. The model for transverse, 45 degree, and longitudinal strains had overall R² values of 0.8577, 0.8818, and 0.8975, respectively. The fit of the regression models was also analyzed by looking at the residuals. Since the regression models for longitudinal strain are of particular interest in the prediction of fatigue life and failure of the trailer they will be used for the analyses.

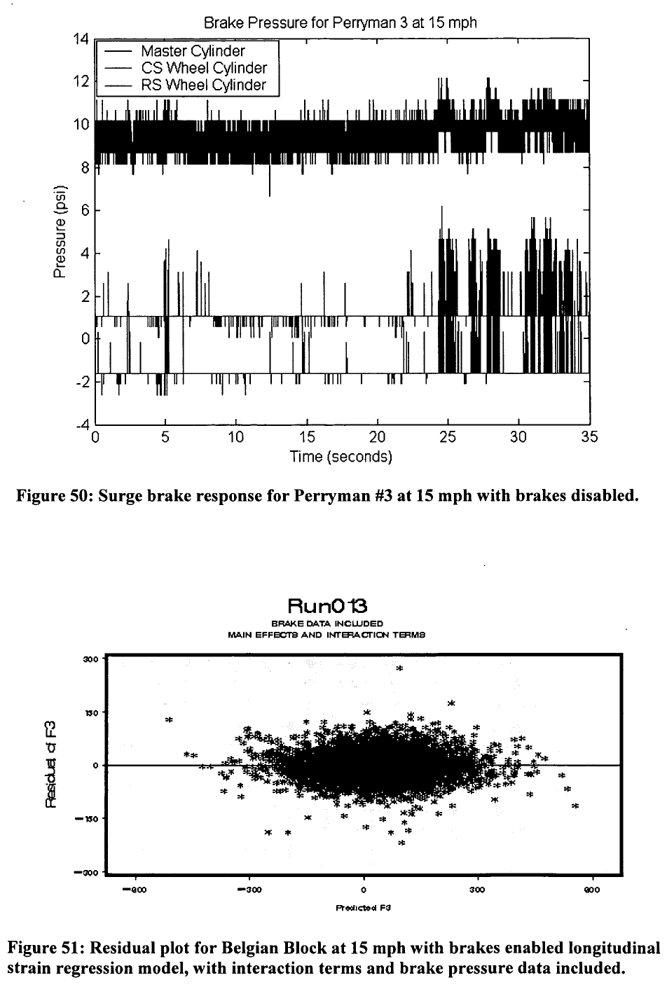

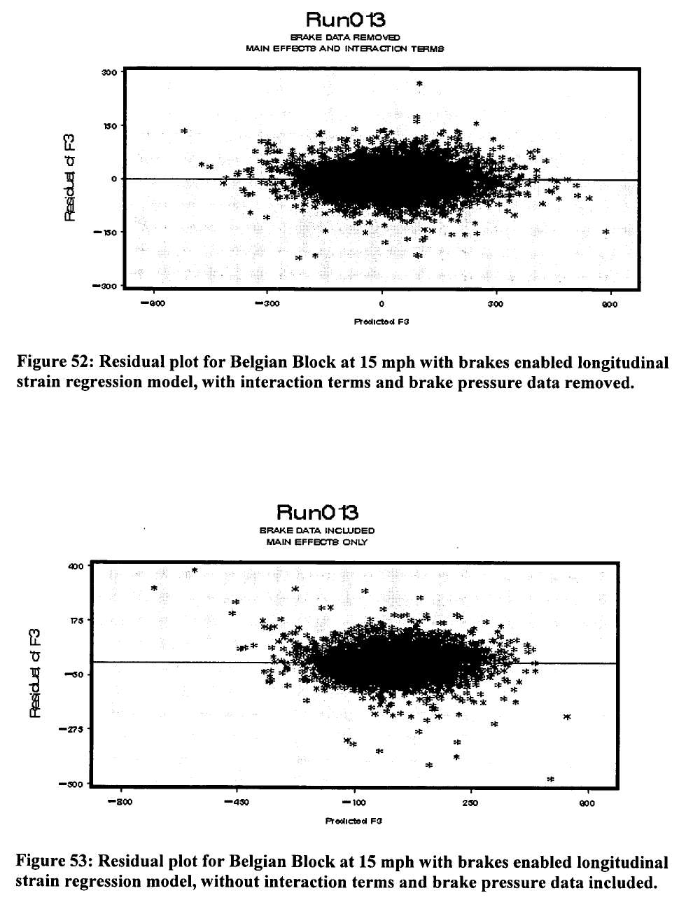

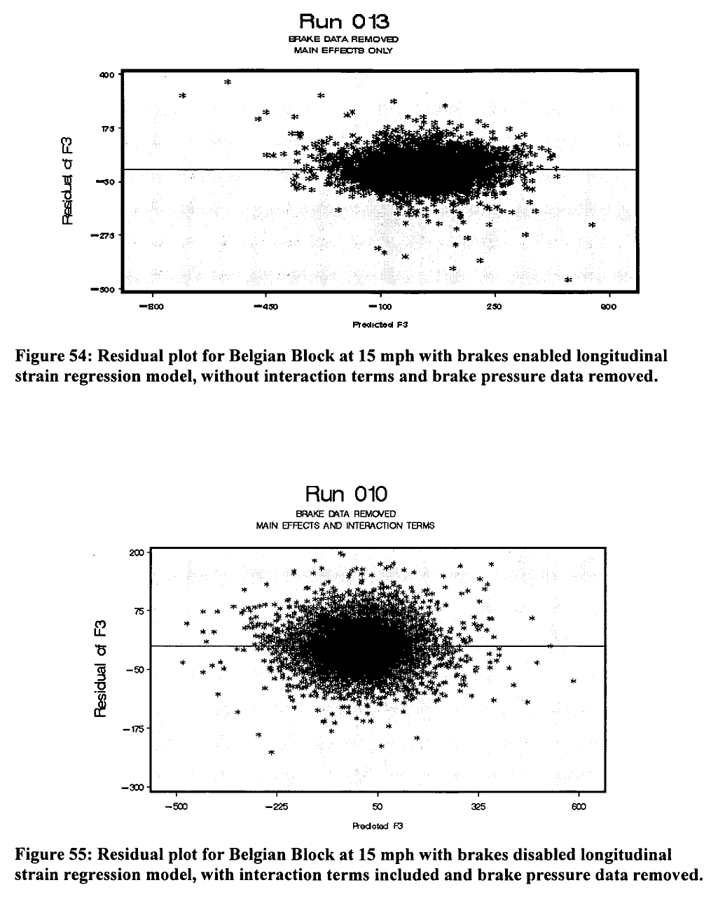

As shown in FIG. 51, the linear regression model that included the brake pressure data and interaction terms is an appropriate model. Comparing FIGS. 51 and 52, it can be seen that the removal of the brake pressure data had little effect on the fit of the regression model. From FIG. 53 it can be seen that the linear model is also appropriate with the interaction terms removed, but the fit is not as accurate. Comparing FIG. 53 and FIG. 54, it can be seen that the removal of the brake pressure data also had little effect on the fit on the regression model with the interaction effects removed. Some outliers could be seen in all the residual plots.

The equations for longitudinal strain regression models for Belgian Block at 15 mph with the brakes enabled, without interaction effects included, and the brake pressure variables both included and removed are shown in Equations (28) and (29), respectively.
The predicted model is F3=221.3+0.662*F10−261.0*F11+61.27*F12+1696*F14+1715*F13−236.1*F19+152.3*F20+36.11*F21+527.8*F15−1926*F16+175.2*F17−359.4*F18+317.8*F22−269.3*F23−425.0*F24−55.99*F25+323.4*F26+95.04*F27−2.095*F29−631.7*F28+0.746*F30−0.419*F31+84.63*F32+0.399*F33−3.240*F37+13.32*F4−861.0*F5+10.83*F6+18.71*F8−6.666*F9−966.9*F7+0.895*F34+3.458*F35−3.968*F36. (28)
The predicted model is F3=232.4+3.034*F10−250.9*F11+65.60*F12+1711*F14+1662*F13−301.9*F19+173.7*F20+15.64*F21+511.2*F15−1918*F16+162.7*F17−192.1*F18+356.5*F22−252.4*F23−548.0*F24−46.33*F25+310.3*F26+90.16*F27−2.021*F29−575.0*F28+0.782*F30−0.224*F31+95.16*F32+17.19*F33−4.686*F37+14.48*F4−888.7*F5+10.71*F6+19.24*F8−6.318*F9−976.4*F7. (29)
From Equation (28), it can be seen that the brake pressure data parameters (F34, F35, F36) are small in comparison to the other parameters. The other parameters with large values do not drastically change when the brake pressure parameters are removed, as shown in Equation (29). The equations for models with interaction effects are not useful for comparison due to their length and complexity.

As shown in Table 26, the models with interaction effects had higher R² values than the models without interaction terms. The R² values for the models with the brake pressure data included had only slightly higher R values than the models without the brake pressure data. For the models with interaction terms, elimination of the brake pressure data only reduced the R value by an average of 0.00967. For the models without interaction terms, elimination of the brake pressure data only reduced the R² value by an average of 0.005567. Therefore, the brake pressure data can be eliminated without having a significant effect on the model. This shows that the enabling or disabling of the surge brake does not have a significant effect on the life of the trailer.

TABLE 26
R² values for all models for Belgian Block at 15 mph with brakes enabled.

| | With Brake Pressures | | No Brake Pressures | |
|---|---|---|---|---|
| | Interaction | No Interaction | Interaction | No Interaction |
| Transverse | 0.8666 | 0.7879 | 0.8577 | 0.7832 |
| 45 Degree | 0.8926 | 0.8015 | 0.8818 | 0.7957 |
| Longitudinal | 0.9068 | 0.8143 | 0.8975 | 0.8081 |

Regression Analysis for Belgian Block (Brakes Disabled)

A second analysis was performed to help explain and validate the findings from the analysis of Belgian Block at 15 mph with brakes enabled. For this analysis the data taken from the Belgian Block course with the surge brake disabled at 15 mph was used. This run was selected due to the fact it corresponds to Belgian Block at 15 mph with brakes enabled.

The initial analysis was performed using a multivariate regression without interactions for Belgian Block at 15 mph with brakes disabled. The results of the regression models for Belgian Block at 15 mph with brakes disabled are shown in Table 27. The results that are labeled ‘with brake pressures’ are only for showing the effect of the sensor error, since the brake pressures should have been constant and would have no effect on the regression model. Table 27 shows the R² values for the regression models for Belgian Block at 15 mph with brakes disabled, and the benefit of adding interaction terms to the models. The overall R values for Belgian Block at 15 mph with brakes disabled were lower than the R values for Belgian Block at 15 mph with brakes enabled, shown in Table 26. The models for Belgian Block at 15 mph with brakes disabled that included interaction terms and no brake pressure data had overall R² values of 0.8049, 0.8133, and 0.8269, for transverse, 45 degree, and longitudinal strains, respectively. Without interaction terms the models for transverse, 45 degree, and longitudinal strains, had R² values of 0.7280, 0.7259, and 0.7373, respectively. The same models with interaction terms and brake pressure variables eliminated for Belgian Block at 15 mph with brakes enabled had overall R² values of 0.8577, 0.8818, and 0.8975, for transverse, 45 degree, and longitudinal strains, respectively. Without interaction terms and brake pressure variables the models for Belgian Block at 15 mph with brakes enabled transverse, 45 degree, and longitudinal strains, had R² values of 0.7879, 0.7957, and 0.8081, respectively. The average difference in the overall R² value for the models with interaction terms and brake pressure variables removed between Belgian Block at 15 mph with brakes disabled and 13 was 0.06397 and 0.0668 for the models with no interaction terms and brake pressure variables removed. The equation for the longitudinal strain regression model for Belgian Block at 15 mph with brakes disabled, without interaction effects included, and the brake pressures removed is shown in Equation (30).

TABLE 27
R² values for all Belgian Block at 15 mph with brakes disabled
regression models.

| | With Brake Pressures | | No Brake Pressures | |
|---|---|---|---|---|
| | Interaction | No Interaction | Interaction | No Interaction |
| Transverse | 0.8121 | 0.7283 | 0.8049 | 0.7280 |
| 45 Degree | 0.8206 | 0.7264 | 0.8133 | 0.7259 |
| Longitudinal | 0.8338 | 0.7383 | 0.8269 | 0.7373 |

The predicted model is: F3=221.0+34.90*F10−329.2*F11+2410*F13+1840*F14+522.9*F15−4163*F16+48.82*F12+222.2*F17−598.7*F18+48.15*F19+14.13*F20+113.3*F21+596.0*F22−229.2*F23−128.0*F24+59.68*F25+55.26*F26−107.1*F27+116.0*F28−2.521*F29+0.434*F30+0.0979*F31+113.6*F32+43.28*F33−2.712*F37+12.18*F4−828.0*F5+12.36*F6−760.9*F7+20.62*F8−10.34*F9. (30)

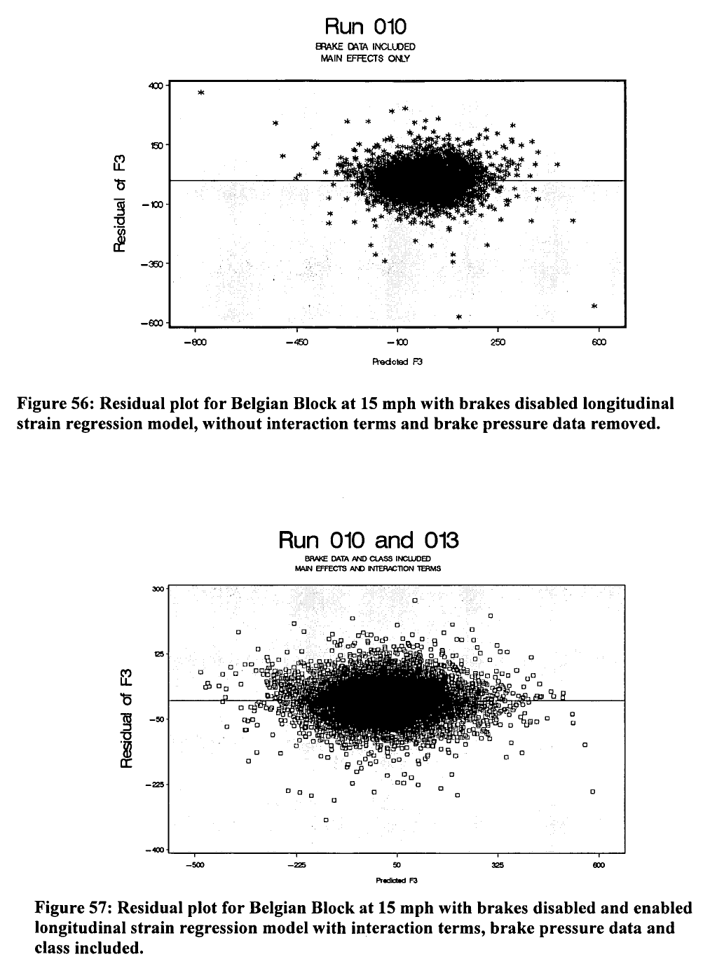

The fit of the regression models for the Belgian Block test data at 15 mph, with the brakes disabled, was also analyzed by looking at the residuals. Since the regression models for longitudinal strain are of particular interest in the prediction of fatigue life and failure of the trailer they again will be used for the analyses. Since the brake pressure should have been constant, containing no information, and the pressures would not have actuated the brake; the fit of the regression model was only analyzed for the models without brake pressure data. As shown in FIG. 55, the linear regression model that included the interaction terms is an appropriate model. Comparing FIG. 55 and FIG. 56, it can be seen that the removal of the brake pressure data had little effect on the fit of the regression model. Some outliers could be seen in both models.

Regression with Concatenated Data for Belgian Block

To determine if the reduced R² values were due to information lost with the surge brake disabled and if the disabling of the surge brake had a significant effect on the strains, a third data set was analyzed. The third data set was created by combining the data from both the Belgian Block tests at 15 mph, with brakes enabled and disabled. The brake pressures in Belgian Block at 15 mph with brakes disabled were all set to zero to minimize the effect of the error from the brake pressure data. The runs were also separated into classes based on whether the surge brake was enabled or disabled. By adding classes, the effect of the surge brake being enabled or disabled can be directly analyzed.

A multivariate regression with interactions was created for the third data set using all 33 independent variables and 1 classification variable. The models for transverse, 45 degree, and longitudinal strains had R² values of 0.8194, 0.8351, and 0.8512, respectively. The models showed significant interaction effects between the class variable and several other independent variables. With these interaction effects, the main effect of the classification variable could not be determined.

To determine the effect of the classification variable on the model, the classification variable was removed and another multivariate regression with interactions was created using all 33 independent variables. The models for transverse, 45 degree, and longitudinal strains had overall R values of 0.8119, 0.8260, and 0.8430, respectively.

To determine the effect of the brake pressures on the model, the brake pressure variables were then removed from the model, leaving 30 independent variables. This yielded models for transverse, 45 degree, and longitudinal strains with overall R² values of 0.8106, 0.8243, and 0.8413, respectively.

The effect of the classification variable without the brake pressure variables was also studied by creating a multivariate regression and with interactions using the 30 independent variables left after the brake pressure variables were removed and the 1 classification variable. The models for transverse, 45 degree, and longitudinal strains had R² values of 0.8130, 0.8271, and 0.8442, respectively.

The equations for longitudinal strain regression models for Belgian Block at 15 mph with brakes disabled and enabled data without interaction effects that included the classification variable and the brake pressures both included and removed are shown in Equation (31) and Equation (32), respectively.
The predicted model is F3=211.0−311.3*F11+29.36*F12+2104*F13−119.1*F19−405.1*F18−3116*F16+190.2*F18+1809*F14+123.5*F17+95.51*F20+83.03*F21+445.3*F22−155.7*F23−55.40*F24+1.197*F25+213.9*F26+44.57*F27−120.1*F20−2.625*F29+0.752*F30−0.493*F31+99.08*F32+36.42*F33−1.683*F37+15.63*F4−882.8*F5+11.75*F6−930.4*F7+25.53*F8−5.679*F9+7.530*F10−61.15*(off=‘off’)+0.527*F34+3.781*F35−3.706*F36. (31)
The predicted model is F3=203.2−303.5*F11+30.98*F12+2055*F13−185.3*F19−306.5*F18−3077*F16+138.8*F15+1820*F14+102.4*F17+105.7*F20+80.42*F21+486.8*F22−138.5*F23−95.27*F24+17.91*F25+208.6*F26+44.67*F27−104.5*F28−2.571*F29+0.702*F30−0.363*F31+106.4*F32+46.60*F33−2.085*F37+16.26*F4−892.3*F5+11.64*F6−940.1*F7+26.72*F8−5.184*F9+10.66*F10−52.68*(off=‘off’). (32)

From Equation (31) you can see the brake pressure data parameters (F34, F35, F36) are small in comparison to the other parameters. The other parameters with large values do not drastically change when the brake pressure parameters are removed, as shown in Equation (32). The equations for longitudinal strain regression models for Belgian Block at 15 mph with brakes disabled and enabled data for Belgian Block at 15 mph, with brakes disabled and enabled data, without interaction effects or the classification variable and the brake pressures both included and removed are shown in Equation (33) and Equation (34), respectively.
The predicted model is F3=163.8−309.0*F11+32.70*F12+2090*F13−159.0*F19−394.3*F18−2935*F16+225.4*F15+1851*F14+116.9*F17+114.7*F20+76.95*F21+430.8*F22−180.8*F23−105.5*F24−194.7*F25+33 250.2*F26+60.10*F27−4.951*F28−2.610*F29+0.707*F30−0.519*F31+96.20*F32+37.81*F33−1.952*F37+15.72*F4−912.8*F5+12.77*F6−969.2*F7+25.70*F8−6.095*F9+6.964*F10+0.879*F34+2.993*F35−3.282*F36. (33)
The predicted model is F3=162.4−301.3*F11+33.47*F12+2039*F13−226.0*F19−292.7*F18−2903*F16+169.9*F15+1855*F14+95.62*F17+123.6*F20+74.90*F21+474.6*F22−161.2*F23−143.5*F24−161.0*F25+242.0*F26+58.99*F27+5.354*F28−2.561*F29+0.739*F30−0.389*F31+104.1*F32+47.79*F33−2.310*F37+16.28*F4−918.0*F5+12.58*F6−974.1*F7+27.01*F8−5.460*F9+10.35*F10. (34)

From Equation (33) it can be seen that the brake pressure data parameters (F34, F35, F36) are small in comparison to the other parameters. The other parameters with large values do not drastically change when the brake pressure parameters are removed, as shown in Equation (34). By comparing Equation (31) with Equation (33) and Equation (32) with Equation (34) it can be seen that the removal of the classification variable had little effect on the other model parameters. The equations for models with interaction effects are again not useful for comparison due to their length and complexity.

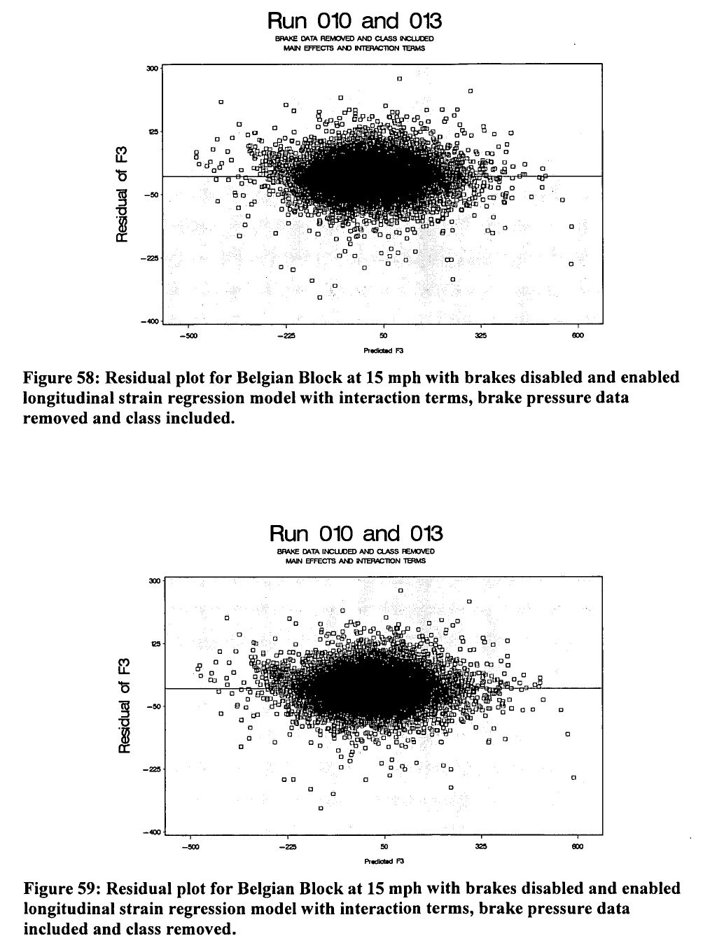

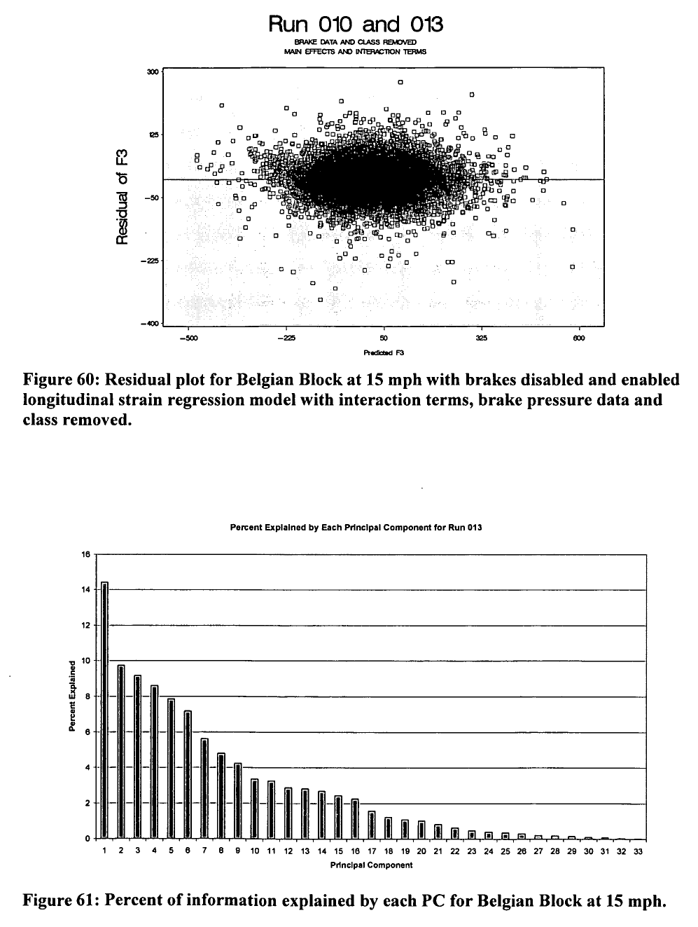

The fit of the regression models was also analyzed by looking at the residuals. Since the regression models for longitudinal strain are of particular interest in the prediction of fatigue life and failure of the trailer, they will be used for the analyses. As shown in FIG. 57, the linear regression model with interaction terms that included the brake pressure data and the classification variable is an appropriate model. Comparing FIG. 57 and FIG. 58, it can be seen that the removal of the brake pressure data had little effect on the fit of the regression model. From FIG. 59 it can be seen that the linear model is also appropriate with the classification term removed. Comparing FIG. 59 and FIG. 60, it can be seen that the removal of the brake pressure data also had little effect on the fit on the regression model with classification variable removed. Some outliers could be seen in all the residual plots.

As shown in Table 28 and Table 29, the models with interaction effects that included the brake pressure data and classification variable had the highest R² values. For the models with interaction terms, the removal of the brake pressure variables decreased the overall R² value of the models with the classification variable by an average of 0.0072, and an average of 0.0015 for the models without the classification variable. Therefore, the brake pressure variables can also be eliminated without having a significant effect on the model. The removal of the classification variable from the models with interaction terms decreased the R² value by an average of 0.0083 for the models with all 33 independent variables and 0.0027 for the models with the brake pressure data eliminated. Therefore the classification variable can be eliminated without having a significant effect on the model. The average R² value for the model with interaction terms and all 33 independent variables and 1 classification variable was 0.8353, with the brake pressure variables and classification variable removed, the R value drops to 0.8269. The difference between the values is only 0.0083. This means that the enabling or disabling the surge brake has very little effect on the strains. Therefore, modeling of the surge brake is not necessary for an analysis of the trailer.

TABLE 28
R² values for all Belgian Block at 15 mph with brakes disabled and
enabled regression model, with brake pressure variables included.

| | | | No Class | |
|---|---|---|---|---|
| | Class | | | No |
| | Interactions | No interactions | Interactions | interactions |
| Transverse | 0.8194 | 0.7427 | 0.8119 | 0.7427 |
| 45 Degree | 0.8351 | 0.7462 | 0.8260 | 0.7464 |
| Longitudinal | 0.8513 | 0.7660 | 0.8430 | 0.7655 |

TABLE 29
R² values for all Belgian Block at 15 mph with brakes disabled and
enabled regression models, with brake pressure variables removed.

| | | | No Class | |
|---|---|---|---|---|
| | Class | | | No |
| | Interactions | No Interactions | Interactions | Interactions |
| Transverse | 0.8130 | 0.7394 | 0.8106 | 0.7394 |
| 45 Degree | 0.8271 | 0.7424 | 0.8243 | 0.7424 |
| Longitudinal | 0.8442 | 0.7615 | 0.8413 | 0.7611 |

Principal Component Analysis for Belgian Block (Brakes Enabled)

To further look at the surge brake data, a principal component analysis (PCA) was used to determine the relevance of the pressure transducer data. PCA is a method used to reduce the size of the input data without losing a significant amount of variability, which contains the information in the data. PCA also makes the transformed vectors uncorrelated and orthogonal, which can be used in regressions without collinearity problems.

The given data, Belgian Block at 15 mph with brakes enabled, was used train and test a regression model using the PC scores determined by a singular value decomposition of the data to predict strain from the input variables. The PC scores provide an uncorrelated and orthogonal data set for the predictor variables, which eliminates collinearity and can be dimensionally reduced. The longitudinal strain was again the predicted variable and the predictor (input) variables were the same as for the multivariate regression, except the ground speed variable was removed yielding 33 input variables.

The singular value decomposition was performed on a standardized input training set to determine the principal components that are relevant for analysis. The relationship between the principal components and the longitudinal strain will be analyzed later. The percentage of data explained by each principal component is shown in FIG. 61. From the figure, we can see that the first 26 principal components explain over 99.2% of the information.

From the PC scores, shown in Tables 30 and 31 we can see that principal comments 2, 31, and 33 are weighted toward the brake data. From FIG. 61 it can be seen that principal component 2 explains 9.7328% of the information in the input data while principal components 31 and 33 explain only 0.0906% and 0.0201% of the information in the input data, respectively.

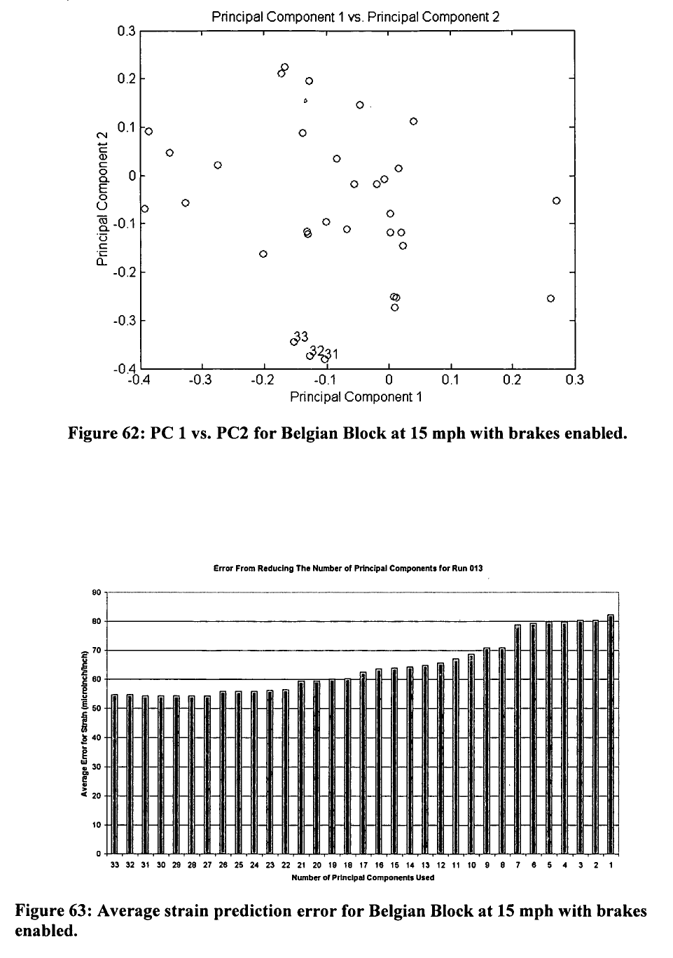

A plot of the first 2 Principal Components, FIG. 62, was made to check for nonlinearites in the training data. The points corresponding to the brake pressures are labeled: 31, 32, and 33 which correspond to the surge brake, CS wheel cylinder, and RS wheel cylinder pressures. From the figure it can be seen that the training data was linear.

To determine the relationship between the input data, and corresponding principal components, with longitudinal strain; a regression analysis was performed. The first regression was performed using the singular value decomposition and the y training set. The error in the training model was calculated to be 68.2306 μinch/inch. The regression model was then used to predict the y test set from the x test set. The error was the calculated to be 54.8989 μinch/inch. With the PCs that are weighted toward the brake data: 2, 31 and 33, removed the error drops to 54.3704 μinch/inch.

TABLE 30
PC scores for Belgian Block at 15 mph brake pressure variables.

| | PC SCORES | | |
|---|---|---|---|
| PC | Master Cyl. | CS Wheel Cyl. | RS Wheel Cyl. |
| 1 | −0.1036 | −0.1273 | −0.1528 |
| 2 | −0.3804 | −0.3742 | −0.3454 |
| 3 | −0.2724 | −0.2644 | −0.2524 |
| 4 | 0.1977 | 0.1963 | 0.2023 |
| 5 | −0.2124 | −0.2166 | −0.2229 |
| 6 | 0.0076 | −0.0012 | −0.0069 |
| 7 | 0.0014 | 0.0079 | 0.0199 |
| 8 | −0.0309 | −0.0200 | −0.0236 |
| 9 | 0.0182 | 0.0187 | 0.0280 |
| 10 | 0.0354 | 0.0559 | 0.0892 |
| 11 | −0.0884 | −0.1245 | −0.1618 |
| 12 | 0.0116 | 0.0156 | 0.0176 |
| 13 | 0.0387 | 0.0529 | 0.0837 |
| 14 | 0.0180 | 0.0290 | 0.0430 |
| 15 | −0.0211 | −0.0297 | 0.0509 |
| 16 | 0.0049 | 0.0135 | 0.0155 |
| 17 | −0.0256 | −0.0058 | 0.0240 |
| 18 | −0.0042 | 0.0030 | 0.0139 |
| 19 | 0.0050 | 0.0057 | 0.0092 |
| 20 | 0.0019 | −0.0040 | −0.0084 |
| 21 | −0.0431 | 0.0182 | 0.0656 |
| 22 | −0.0061 | 0.0004 | 0.0028 |
| 23 | −0.0043 | −0.0060 | 0.0080 |
| 24 | 0.0206 | 0.0073 | −0.0302 |
| 25 | −0.0175 | 0.0025 | 0.0164 |
| 26 | 0.0123 | −0.0112 | −0.0005 |
| 27 | 0.0090 | −0.0033 | −0.0189 |
| 28 | 0.0167 | −0.0060 | −0.0104 |
| 29 | 0.0130 | −0.0055 | −0.0025 |
| 30 | −0.2788 | −0.0012 | −0.2749 |
| 31 | −0.6526 | −0.0024 | 0.6334 |
| 32 | −0.0304 | 0.0155 | 0.0160 |
| 33 | 0.4508 | −0.8142 | 0.4137 |

TABLE 31
Input measurement components to PCs 2, 31, and 33, for Belgian
Block at 15 mph with brakes enabled.

| VAR. | PC 2 | PC 31 | PC 33 |
|---|---|---|---|
| 1 | 0.0875 | 0.0065 | 0.0027 |
| 2 | 0.0919 | −0.0117 | −0.0001 |
| 3 | −0.116 | 0.0021 | −0.0028 |
| 4 | −0.0687 | −0.0045 | 0.0084 |
| 5 | −0.0176 | 0.0042 | 0.0005 |
| 6 | −0.1182 | 0.0077 | 0.0002 |
| 7 | 0.0149 | 0.0161 | −0.0017 |
| 8 | 0.0352 | 0.024 | −0.002 |
| 9 | −0.2508 | −0.0045 | 0.0028 |
| 10 | 0.1111 | −0.0703 | −0.0025 |
| 11 | 0.0467 | 0.0452 | 0.0038 |
| 12 | −0.2735 | 0.0065 | −0.0109 |
| 13 | 0.1462 | −0.0765 | −0.0032 |
| 14 | 0.1954 | 0.0338 | −0.0058 |
| 15 | −0.1446 | 0.0217 | 0.0048 |
| 16 | −0.0968 | −0.1636 | 0.0026 |
| 17 | 0.0223 | −0.0095 | −0.0158 |
| 18 | −0.017 | 0.0342 | 0.0044 |
| 19 | −0.1116 | 0.2339 | −0.0054 |
| 20 | −0.122 | 0.0398 | 0.0148 |
| 21 | −0.1174 | −0.0225 | 0.0103 |
| 22 | 0.2106 | −0.1182 | −0.0009 |
| 23 | −0.0571 | −0.0599 | −0.0057 |
| 24 | −0.0068 | −0.0101 | −0.0033 |
| 25 | 0.2242 | 0.2046 | 0.0013 |
| 26 | −0.1617 | −0.0032 | 0.0059 |
| 27 | −0.2535 | −0.0037 | 0.0042 |
| 28 | −0.0788 | 0.0135 | 0.004 |
| 29 | −0.052 | 0.059 | −0.0012 |
| 30 | −0.2543 | 0.0964 | 0.0087 |
| 31 | −0.3804 | −0.6526 | 0.4058 |
| 32 | −0.3742 | −0.0024 | −0.8142 |
| 33 | −0.3454 | 0.6334 | 0.4137 |

The error when individual principal components are removed, starting with the last principal component (PC) was then determined, and is shown in FIG. 63. From the figure it can be seen that there is decrease in the average error to a minimum of 54.3424 μinch/inch when the last 4 principal components are removed which includes both principal components 31 and 33.

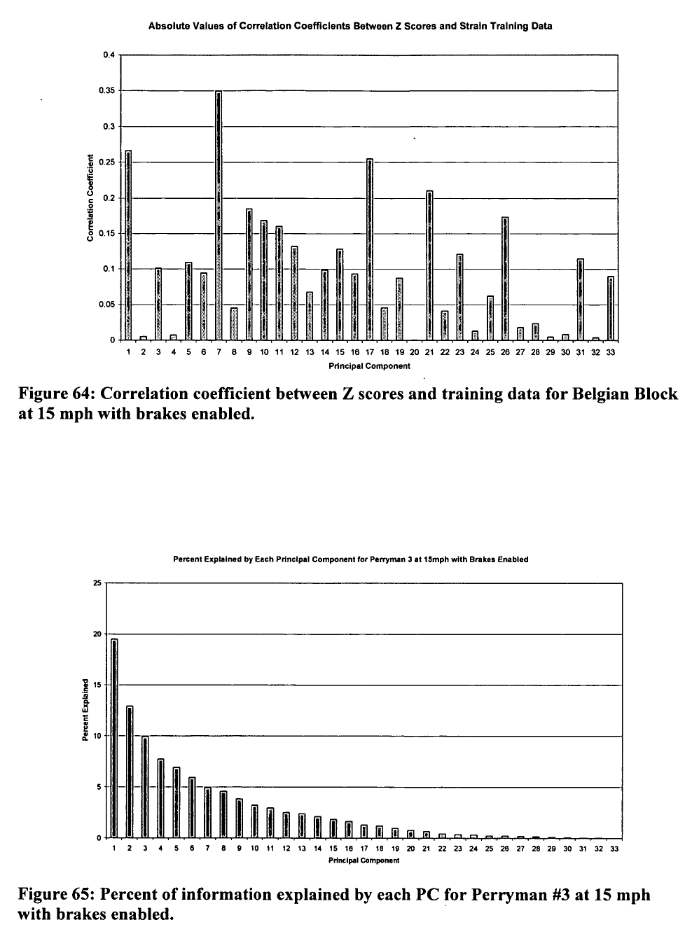

A correlation coefficient matrix of the Z scores and y training data was made to determine which principal components are most useful in predicting acceleration. The absolute values of the correlation coefficients are shown in FIG. 64. From the figure it can be seen that principal components 2, 4, 8, 18, 20, 22, 24, 27, 28, 29, 30, and 32 are the least correlated, below 0.05, with the data. With these PC's removed the error only increased to 55.3605 μinch/inch. Additional principal components: 6, 13, 14, 16, 19, 25, and 33 were removed and the error increased to 58.7066 μinch/inch. Principal components 3, 5, and 31 were then removed and yielded an error of 58.5525 μinch/inch.

The principal component analysis and regression also show that the brakes do not correlate to the longitudinal strain. The second, thirty-first and thirty-third principal components were weighted toward the brake pressure data. The second principal component did explain a large percentage of the input data relative to the other principal components, but it did not correlate to the strain data. The thirty-first and thirty-third principal components were slightly correlated to the strain data, but explained a negligible percentage of information from the input data. The removal of these three principal components reduced the average error by 0.5205 μinch/inch reinforcing the conclusion that the activation of the surge brake does not affect the life of the trailer.

Regression Analysis for Perryman #3 (Brakes Enabled)

To validate the regression results obtained during the Belgian Block data analysis; a second analysis was preformed using data from another test course. Since this is intended only to be a validation, all of the original detailed analysis was not performed. The data selected was from the Perryman #3 test course at 15 mph with the brakes enabled.

Three regression models, without interaction effects, were created to initially. The first strain model created was for the transverse strain. Using a stepwise regression model we can see that the R² value for the model with the brake pressure data included is 0.8044 and with the brake pressure data eliminated the R² is 0.8035.

The second strain model created was for the 45 degree strain. Using a stepwise regression model we can see that the R² value for the model with the brake pressure data included is 0.8305 and with the brake pressure data eliminated the R² is 0.8295.

The third strain model created was for the longitudinal strain. Using a stepwise regression model we can see that the R² value for the model with the brake pressure data included is 0.8382 and with the brake pressure data eliminated the R² is 0.8372.

A multivariate regression that included pairwise interaction effects was created to improve the fit of the model by accounting for interactions between the main effects in the model. The model for transverse, 45 degree, and longitudinal strains had overall R² values of 0.8858, 0.9002, and 0.9079, respectively.

A multivariate regression with main effects and pairwise interactions was then created with the brake pressure variables eliminated. The model for transverse, 45 degree, and longitudinal strains had overall R² values of 0.8854, 0.8996, and 0.9075, respectively.

As shown in Table 32, the models with interaction terms included had higher R² values than the models without interaction terms. The R² values for the models with the brake pressure data included had only slightly higher R² values than the models without the brake pressure data. For the models with interaction terms, elimination of the brake pressure data only reduced the R² value by an average of 0.000467. For the models without interaction terms, elimination of the brake pressure data only reduced the R value by an average of 0.000967. Therefore, the brake pressure data can be eliminated without having a significant effect on the model. This shows that the enabling or disabling of the surge brake does not have a significant effect on the life of the trailer.

TABLE 32
R² values for all models for Perryman #3 test course at 15 mph with
brakes enabled.

| | With Brake Pressures | | No Brake Pressures | |
|---|---|---|---|---|
| | Interaction | No Interaction | Interaction | No Interaction |
| Transverse | 0.8858 | 0.8044 | 0.8854 | 0.8035 |
| 45 Degree | 0.9002 | 0.8305 | 0.8996 | 0.8295 |
| Longitudinal | 0.9079 | 0.8382 | 0.9075 | 0.8372 |

Regression Analysis for Perryman #3 (Brakes Disabled)

A second analysis was performed to help explain and validate the findings from the analysis of Perryman #3 at 15 mph with brakes enabled. For this analysis the data from Perryman #3 at 15 mph with brakes disabled was used, since it corresponds to Perryman #3 at 15 mph with brakes enabled.

The results of the regression models with and without interaction terms for the data from the Perryman #3 test course taken at 15 mph with the brakes disabled are shown in Table 33. The results that are labeled ‘with brake pressures’ are only for showing the effect of the sensor error, since the brake pressures should have been constant and would have no effect on the regression model. The overall R² values for Perryman #3 at 15 mph with brakes disabled were higher than the R² values for Perryman #3 at 15 mph with brakes enabled, shown in Table 32.

The benefits of adding interaction terms can also be seen in Table 33. The models for Perryman #3 at 15 mph with brakes disabled that included interaction terms and no brake pressure data had overall R² values of 0.9007, 0.9067, and 0.9815, for transverse, 45 degree, and longitudinal strains, respectively. Without interaction terms and no brake pressure variables the models for transverse, 45 degree, and longitudinal strains, had R² values of 0.8841, 0.862, and 0.8712, respectively. The same models with interaction terms and brake pressure variables eliminated for Perryman #3 at 15 mph with brakes enabled had overall R² values of 0.8435, 0.8611, and 0.8711, for transverse, 45 degree, and longitudinal strains, respectively. Without interaction terms and brake pressure variables the models for Perryman #3 at 15 mph with brakes enabled transverse, 45 degree, and longitudinal strains, had R² values of 0.8435, 0.8611, and 0.8711, respectively. The average difference in the overall R² value for the models with interaction terms and brake pressure variables removed between Perryman #3 at 15 mph with brakes disabled and enabled was 0.0111 and 0.0352 for the models with no interaction terms and brake pressure variables removed.

TABLE 33
R² values for all Perryman #3 at 15 mph with brakes disabled
regression models.

| | With Brake Pressures | | No Brake Pressures | |
|---|---|---|---|---|
| | Interaction | No Interaction | Interaction | No Interaction |
| Transverse | 0.9043 | 0.8441 | 0.9007 | 0.8435 |
| 45 Degree | 0.9106 | 0.862 | 0.9067 | 0.8611 |
| Longitudinal | 0.9216 | 0.8712 | 0.9185 | 0.8711 |

Regression with Concatenated Data for Perryman #3

As shown in Tables 34 and 35, the models with interaction effects that included the brake pressure data and classification variable had the highest R² values. For the models with interaction terms, the removal of the brake pressure variables decreased the overall R value of the models with the classification variable by an average of 0.0015, and increased the overall R² value an average of 0.0001 for the models without the classification variable. Therefore the brake pressure variables can also be eliminated without having a significant effect on the model. The removal of the classification variable from the models with interaction terms increased the R² value by an average of 0.00003 for the models with all 33 independent variables and 0.0017 for the models with the brake pressure data eliminated. Therefore the classification variable can be eliminated without having a significant effect on the model. The average R² value for the model with interaction terms and all 33 independent variables and 1 classification variable was 0.8958, with the brake pressure variables and classification variable removed, the R value drops to 0.8974. The difference between the values is only 0.0016. This means that the enabling or disabling the surge brake has very little effect on the strains. Therefore, modeling of the surge brake is not necessary for an analysis of the trailer.

TABLE 34
R² values for Perryman #3 at 15 mph with brakes disabled and enabled
regression model, with brake pressure variables included.

| | | | No Class | |
|---|---|---|---|---|
| | Class | | | No |
| | Interactions | No interactions | Interactions | interactions |
| Transverse | 0.8854 | 0.8323 | 0.8854 | 0.8320 |
| 46 Degree | 0.8960 | 0.8540 | 0.8959 | 0.8540 |
| Longitudinal | 0.9061 | 0.8619 | 0.9061 | 0.8616 |

TABLE 35
R² values for Perryman #3 at 15 mph with brakes disabled and enabled
regression model, with brake pressure variables removed.

| | | | No Class | |
|---|---|---|---|---|
| | Class | | | No |
| | Interactions | No interactions | Interactions | interactions |
| Transverse | 0.8871 | 0.8317 | 0.8852 | 0.8312 |
| 45 Degree | 0.8976 | 0.8537 | 0.8959 | 0.8537 |
| Longitudinal | 0.9074 | 0.8616 | 0.9060 | 0.8613 |

Principal Component Analysis for Perryman #3 (Brakes Enabled)

To verify the analysis of the surge brake data from the Belgian Block test course at 15 mph, a principal component analysis (PCA) was again performed using another data set. For verification, the data set was from a different test course than the original analysis. The verification data set was from the Perryman #3 test course at 15 mph with the brakes enabled.

The singular value decomposition was again performed on a standardized input training set in order to determine the principal components that are relevant for analysis. As before, the relationship between the principal components and the longitudinal strain will be analyzed later. The percentage of data explained by each principal component is shown in FIG. 65. From the figure, we can see that the first 25 principal components explain over 99.1% of the information.

From the PC scores, shown in Tables 36 and 37 we can see that principal components 5, 22, and 33, are weighted toward the brake data. From FIG. 65 it can be seen that principal components 5, 32, and 33, explain 6.9329%, 0.035%, and 0.0066%, of the information in the input data, respectively. The total amount of information explained by these 3 principal components is only 6.9745%.

TABLE 36
PC scores for Perryman #3 at 15 mph with brakes enabled pressure
variables.

| | PC SCORES | | |
|---|---|---|---|
| | | CS Wheel | RS Wheel |
| PC | Master Cyl. | Cyl. | Cyl. |
| 1 | −0.1412 | −0.1564 | −0.1631 |
| 2 | −0.2879 | −0.2812 | −0.2784 |
| 3 | 0.1367 | 0.1388 | 0.134 |
| 4 | −0.1215 | −0.1233 | −0.124 |
| 5 | 0.3981 | 0.3872 | 0.3816 |
| 6 | −0.0177 | −0.0351 | −0.0374 |
| 7 | 0.0526 | 0.0487 | 0.0425 |
| 8 | −0.1458 | −0.1563 | −0.1605 |
| 9 | −0.0537 | −0.0572 | −0.0544 |
| 10 | 0.0605 | 0.0667 | 0.0712 |
| 11 | 0.0014 | −0.0029 | −0.0016 |
| 12 | −0.05 | −0.058 | −0.0671 |
| 13 | −0.0027 | 0.0057 | 0.0126 |
| 14 | 0.0472 | 0.0632 | 0.0665 |
| 15 | −0.041 | −0.0406 | −0.0452 |
| 16 | 0.0227 | 0.0251 | 0.025 |
| 17 | 0.0072 | 0.0075 | 0.006 |
| 18 | 0.0079 | 0.012 | 0.0018 |
| 19 | −0.0191 | −0.0201 | −0.0148 |
| 20 | 0.0276 | 0.0206 | −0.0004 |
| 21 | 0.0123 | −0.0011 | −0.0123 |
| 22 | −0.0355 | −0.0089 | 0.025 |
| 23 | −0.0079 | 0.0063 | 0.0141 |
| 24 | 0.0026 | −0.0083 | −0.0134 |
| 25 | 0.0079 | 0.0092 | 0.0119 |
| 26 | 0.0091 | −0.0006 | −0.0091 |
| 27 | −0.0205 | 0.0223 | 0.0482 |
| 28 | −0.0085 | −0.005 | 0.0045 |
| 29 | 0.0324 | −0.0182 | −0.0432 |
| 30 | −0.017 | 0.0001 | 0.011 |
| 31 | −0.1155 | 0.0259 | 0.091 |
| 32 | 0.763 | −0.1605 | −0.5997 |
| 33 | 0.2594 | −0.7988 | 0.5425 |

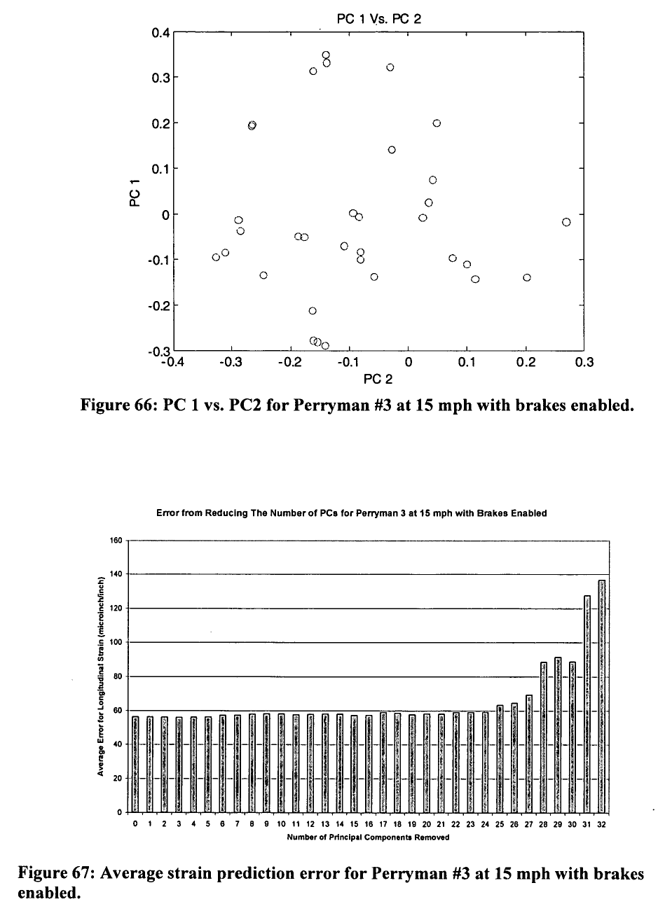

A plot of the first 2 Principal Components, FIG. 66, was made to check for nonlinearites in the training data. From the figure it can be seen that the training data was linear. To determine the relationship between the Perryman #3 input data, and corresponding principal components, with longitudinal strain; a regression analysis was performed. The first regression was performed using the singular value decomposition and the y training set. The error in the training model was calculated to be 51.8350 μinch/inch. The regression model was then used to predict the y test set from the x test set. The error was calculated to be 55.9815 μinch/inch. With the PCs that are weighted toward the brake data: 5, 32, and 33, removed the error increases to 75.5955 μinch/inch, and with only PCs 32 and 33 removed the error is 56.2774 μinch/inch. With only PC 5 removed the error is 74.9775 μinch/inch. The error when principal components are removed, starting with the last principal component (PC) was then determined, and is shown in FIG. 67. From the figure it can be seen that there is increase in the average error of only 2.2109 μinch/inch to a value 58.1924 μinch/inch when the last 21 principal components are removed, which includes PCs 32 and 33, which are weighted toward the brake data.

TABLE 37
Input measurement components to PCs 5, 32, and 33, for Perryman
#3 at 15 mph with brakes enabled.

| VAR. | PC 5 | PC 32 | PC 33 |
|---|---|---|---|
| 1 | −0.0549 | −0.0094 | 0.0038 |
| 2 | −0.1327 | 0.0349 | −0.0061 |
| 3 | −0.1328 | 0.0024 | −0.0028 |
| 4 | −0.2003 | −0.0047 | 0.0031 |
| 5 | −0.1858 | −0.0002 | −0.0022 |
| 6 | −0.1144 | 0.0003 | 0.0002 |
| 7 | 0.0535 | −0.0032 | −0.0003 |
| 8 | −0.1761 | −0.0056 | −0.0008 |
| 9 | −0.1631 | −0.0054 | 0.0014 |
| 10 | 0.0772 | 0.0236 | −0.0019 |
| 11 | −0.2164 | 0.0019 | −0.0014 |
| 12 | −0.1545 | −0.0567 | 0.0078 |
| 13 | 0.1418 | 0.002 | 0.0021 |
| 14 | −0.2161 | −0.0449 | −0.0037 |
| 15 | −0.1746 | 0.0384 | 0.0026 |
| 16 | 0.1109 | 0.0573 | −0.0015 |
| 17 | −0.0485 | 0.0161 | −0.0044 |
| 18 | −0.0359 | −0.0112 | 0.0008 |
| 19 | 0.1416 | −0.1019 | −0.0013 |
| 20 | −0.1385 | 0.0631 | 0.0016 |
| 21 | −0.1343 | 0.0458 | 0.001 |
| 22 | 0.0939 | 0.0162 | −0.0017 |
| 23 | −0.1422 | −0.0036 | −0.0011 |
| 24 | 0.0212 | 0.0013 | 0.0015 |
| 25 | 0.1264 | 0.0247 | 0.0017 |
| 26 | 0.0031 | −0.0247 | 0.0049 |
| 27 | −0.13 | 0.0369 | −0.005 |
| 28 | −0.1152 | −0.0189 | 0.0105 |
| 29 | 0.1836 | −0.0165 | −0.001 |
| 30 | 0.0565 | −0.0085 | −0.0039 |
| 31 | 0.3981 | 0.763 | 0.2594 |
| 32 | 0.3872 | −0.1605 | −0.7988 |
| 33 | 0.3816 | −0.5997 | 0.5425 |

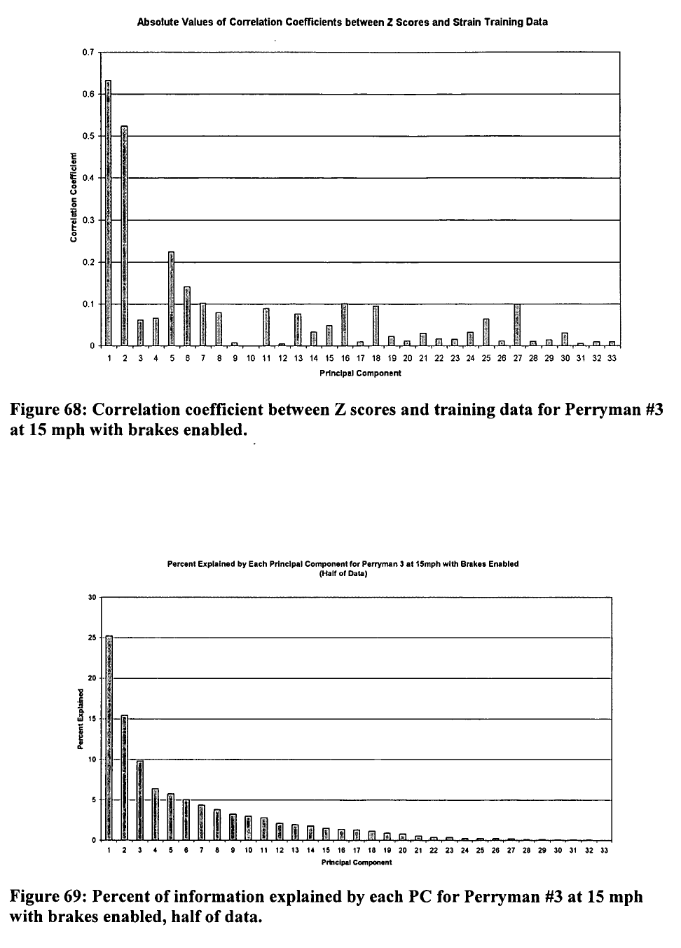

A correlation coefficient matrix of the Z scores and y training data was made to determine which principal components are most useful in predicting acceleration. The absolute values of the correlation coefficients are shown in FIG. 68. From the figure it can be seen that the principal components that are weighted toward the brake data (5, 32, and 33) are not correlated to the strain training data with correlation coefficients 0.2243, 0.0091, and 0.0097, respectively.

The principal component analysis and regression show for this data set that the brakes do not correlate to the longitudinal strain. The fifth, thirty-second, and thirty-third principal components were weighted toward the brake pressure data. These three principal components had an average correlation coefficient of 0.0810 between the Z scores and the longitudinal strain training data. The removal of these three principal components increased the average error by 19.614 μinch/inch to 75.5955 μinch/inch. From these results it cannot be determined if the activation of the surge brake effects the life of the trailer. This difference in the average error from the regression was not an expected result and indicates an error in the model.

This regression error can be explained by looking at the brake pressure data. As can be seen from FIG. 49, the surge brake was not activated (pressure increased above 0 psi) during the training data and was activated four times during the testing data. This can easily affect the regression model, since the brake pressure change would not be accounted for. This does not mean the brake pressure affects the strain, it means the model is effected by the variables used and the must be properly accounted for. Only removing the variable can determine if it affects the regression results.

To determine the effect of the brake activation on the data sets, the analysis was again preformed with the data set starting at 10.4061 seconds (data point 13140), which is slightly more than the second half of the data. The new training and testing data sets will be taken from this reduced data set that only accounts for a little over half of the original data.

As in the previous analyses, the relationship between the principal components and the longitudinal strain will be analyzed later. The percentage of data explained by each principal component is shown in FIG. 69. From the figure, we can see that the first 25 principal components explain over 99.21% of the information.

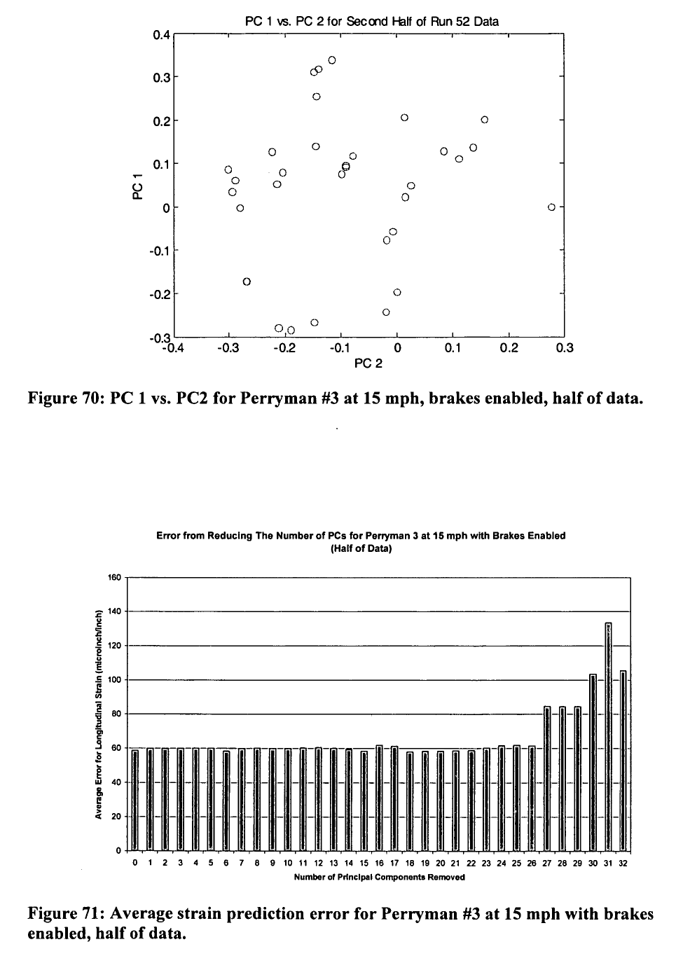

From the PC scores, shown in Tables 38 and 39 we can see that principal components 32 and 33, are now weighted toward the brake data. From FIG. 69 it can be seen that principal components 32 and 33, explain 0.0054%, and 0.0313%, of the information in the input data, respectively. The total amount of information explained by these 2 principal components is only 0.0367%. A plot of the first 2 principal components, FIG. 70, was made to check for nonlinearites in the training data used.

TABLE 38
PC scores for Perryman #3 at 15 mph with brakes enabled pressure
variables, half of data.

| | PC SCORES | | |
|---|---|---|---|
| | Master | CS Wheel | RS Wheel |
| PC | Cyl. | Cyl. | Cyl. |
| 1 | 0.1169 | −0.1399 | −0.1481 |
| 2 | 0.3388 | 0.318 | 0.3104 |
| 3 | 0.0595 | 0.0493 | 0.0423 |
| 4 | −0.1109 | −0.1091 | −0.1108 |
| 5 | −0.2431 | −0.2843 | −0.2889 |
| 6 | 0.245 | 0.2347 | 0.2326 |
| 7 | 0.0541 | 0.0369 | 0.0301 |
| 8 | −0.0024 | −0.0096 | −0.0097 |
| 9 | 0.0117 | 0.0212 | 0.0216 |
| 10 | 0.1488 | 0.1415 | 0.135 |
| 11 | −0.0464 | −0.0422 | −0.0396 |
| 12 | −0.0145 | 0.008 | 0.018 |
| 13 | −0.1108 | −0.1217 | −0.1232 |
| 14 | 0.0695 | 0.0692 | 0.0683 |
| 15 | −0.0594 | −0.0553 | −0.0563 |
| 16 | −0.096 | −0.0872 | −0.0847 |
| 17 | −0.0405 | −0.0373 | −0.0372 |
| 18 | 0.0039 | −0.0205 | −0.0329 |
| 19 | 0.0411 | 0.0338 | 0.0418 |
| 20 | −0.0122 | 0.0346 | 0.0273 |
| 21 | 0.0216 | 0.0448 | 0.0675 |
| 22 | 0.0271 | 0.0262 | 0.0238 |
| 23 | −0.0116 | −0.0151 | −0.0074 |
| 24 | −0.0048 | 0.081 | 0.129 |
| 25 | 0.0566 | 0.0364 | −0.0199 |
| 26 | 0.0114 | −0.0019 | 0.0038 |
| 27 | 0.0119 | −0.0046 | 0.0014 |
| 28 | −0.0316 | 0.03 | 0.0475 |
| 29 | −0.0119 | 0.0126 | 0.0315 |
| 30 | −0.0357 | 0.0119 | 0.0215 |
| 31 | −0.1595 | 0.03 | 0.1264 |
| 32 | 0.7443 | −0.1083 | −0.6067 |
| 33 | −0.2983 | 0.8039 | −0.5132 |

TABLE 39
Input measurement components to PCs 32 and 33 for Perryman
#3 at 15 mph with brakes enabled, half of data.

| VAR. | PC 32 | PC 33 |
|---|---|---|
| 1 | −0.0151 | 0.0024 |
| 2 | 0.0371 | 0.001 |
| 3 | 0.0006 | 0.0007 |
| 4 | −0.0031 | −0.0057 |
| 5 | −0.0076 | 0.0023 |
| 6 | 0.0056 | −0.0018 |
| 7 | 0.0054 | −0.0011 |
| 8 | −0.002 | −0.0001 |
| 9 | −0.0127 | 0.0013 |
| 10 | 0.0281 | −0.0038 |
| 11 | −0.0171 | −0.0006 |
| 12 | −0.0512 | 0.0051 |
| 13 | 0.0457 | −0.0021 |
| 14 | −0.0702 | 0.0061 |
| 15 | 0.0371 | −0.0017 |
| 16 | 0.0664 | −0.0039 |
| 17 | 0.0346 | 0.0137 |
| 18 | −0.0177 | −0.0021 |
| 19 | −0.163 | 0.008 |
| 20 | 0.073 | −0.0071 |
| 21 | 0.0471 | −0.0037 |
| 22 | 0.0214 | −0.0064 |
| 23 | −0.0385 | 0.0016 |
| 24 | −0.0059 | 0.0023 |
| 25 | 0.0593 | 0.0021 |
| 26 | −0.0005 | −0.0039 |
| 27 | 0.0522 | 0.0103 |
| 28 | 0.0048 | −0.0219 |
| 29 | 0.006 | 0.0161 |
| 30 | −0.0634 | 0 |
| 31 | 0.7443 | −0.2983 |
| 32 | −0.1083 | 0.8039 |
| 33 | −0.6067 | −0.5132 |

From FIG. 70, it can be seen that the training data was linear.

To determine the relationship between the Perryman #3 input data, and corresponding principal components, with longitudinal strain; a regression analysis was performed. The first regression was performed using the singular value decomposition and the y training set. The error in the training model was calculated to be 50.9988 μinch/inch. The regression model was then used to predict the y test set from the x test set. The error was the calculated to be 58.8997 μinch/inch. With the PCs that are weighted toward the brake data, 32 and 33, removed the error increases the error increases by 0.9099 μinch/inch (1.54%), to 59.8096 μinch/inch.

The error when principal components are removed, starting with the last principal component (PC) was then determined, and is shown in FIG. 71. From the figure it can be seen that there is a decrease in the average error of only 0.0864 μinch/inch to a value 58.8133 μinch/inch when the last 22 principal components are removed. These 22 principal components include both PCs 32 and 33, which are weighted toward the brake data.

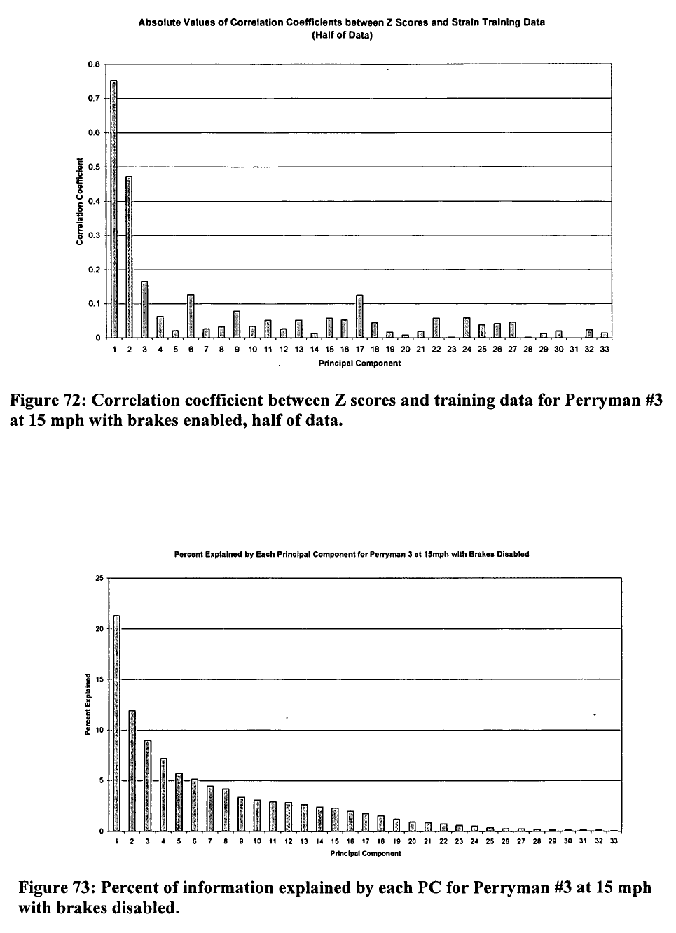

A correlation coefficient matrix of the Z score and y training data was made to determine which principal components are most useful in predicting acceleration. The absolute values of the correlation coefficients are shown in FIG. 72. From the figure, it can be seen that the principal components that are weighted toward the brake data (32 and 33) are not correlated to the strain training data with correlation coefficients of 0.0234 and 0.0143, respectively.

The principal component analysis and regression shows that the brakes do not correlate to the longitudinal strain. The thirty-second and thirty-third principal components were weighted toward the brake pressure data. These two principal components had an average correlation coefficient of 0.0189 between the Z score and longitudinal strain training data. The removal of these three principal components increase the average error by only 1.9099 μinch/inch, or 1.54%, reinforcing the conclusion of the analysis on the Belgian Block data taken at 12 mph with the brake enabled that the activation of the surge brake does not affect the life of the trailer.

Principal Component Analysis for Perryman #3 (Brakes Disabled)

To compare the PCA results from a data set with the brakes disabled another analysis was performed. The data set used for the analysis was from the Perryman #3 test course at 15 mph with the brakes disabled, which corresponds to the Perryman #3 data set taken at 15 mph with the brakes enabled.

The singular value decomposition was again performed on a standardized input training set in order to determine the principal components that are relevant for analysis. As before, the relationship between the principal components and the longitudinal strain will be analyzed later. The percentage of data explained by each principal component is shown in FIG. 73. From the figure, we can see that the first 27 principal components explain over 99.3% of the information.

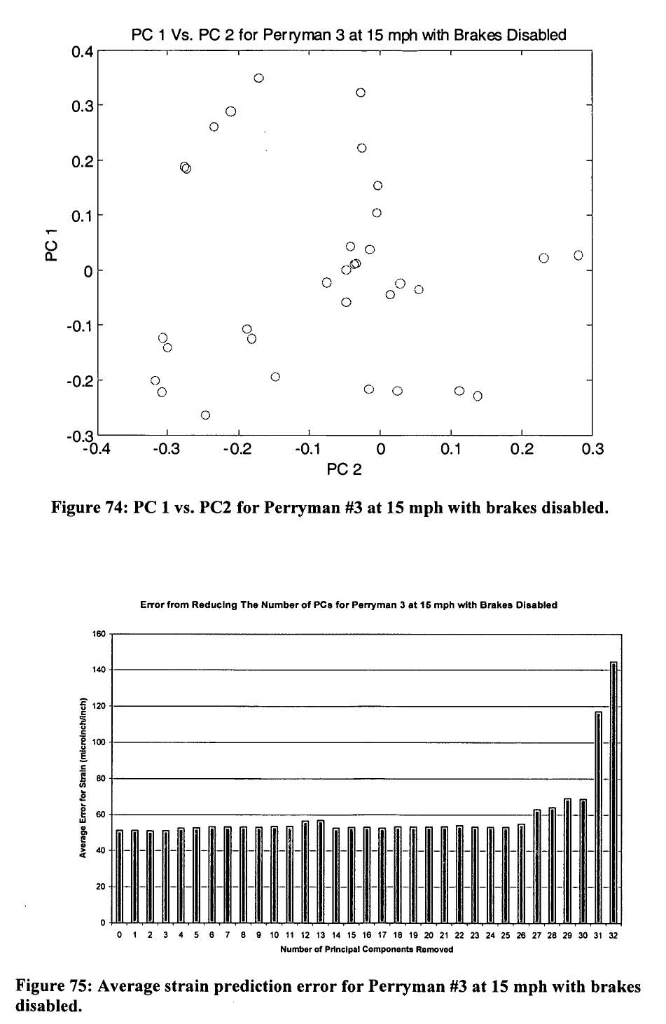

From the PC scores, shown in Tables 40 and 41 we can see that principal components 11, 12, 13, and 14, are weighted toward the brake data. From FIG. 73 it can be seen that principal components 11, 12, 13, and 14, explain 2.9078%, 2.8487%, 2.6314%, and 2.3851%, of the information in the input data, respectively. The total amount of information explained by these 4 principal components is only 10.763%. A plot of the first 2 Principal Components, FIG. 74, was made to check for nonlinearites in the training data. From the figure it can be seen that the training data was linear.

TABLE 40
PC scores for Perryman #3 at 15 mph with brakes disabled
pressure variables.

| | PC SCORES | | |
|---|---|---|---|
| | Master | CS Wheel | RS Wheel |
| PC | Cyl. | Cyl. | Cyl. |
| 1 | 0.0541 | −0.037 | −0.0158 |
| 2 | −0.0334 | 0.0124 | 0.0377 |
| 3 | 0.0335 | 0.0379 | −0.0175 |
| 4 | −0.0841 | −0.092 | 0.0023 |
| 5 | −0.1532 | −0.1841 | 0.0302 |
| 6 | 0.1266 | 0.1578 | 0.0317 |
| 7 | 0.0003 | −0.1014 | 0.0008 |
| 8 | 0.1022 | 0.3506 | −0.0102 |
| 9 | −0.0885 | −0.2053 | 0.1231 |
| 10 | −0.1691 | 0.1959 | −0.925 |
| 11 | 0.617 | 0.1311 | −0.0732 |
| 12 | 0.5417 | 0.3229 | 0.0642 |
| 13 | 0.4101 | −0.5909 | −0.3268 |
| 14 | 0.124 | −0.1343 | 0.0564 |
| 15 | −0.2049 | 0.3312 | 0.0166 |
| 16 | 0.0141 | −0.3261 | −0.0171 |
| 17 | 0.0034 | −0.0727 | −0.0187 |
| 18 | −0.0037 | −0.0367 | −0.0639 |
| 19 | 0.0204 | 0.0057 | 0.0142 |
| 20 | 0.0149 | 0.0274 | −0.0133 |
| 21 | 0.0121 | −0.0026 | −0.0095 |
| 22 | −0.0137 | 0.0435 | −0.0043 |
| 23 | −0.004 | −0.0013 | 0.0004 |
| 24 | −0.0076 | −0.043 | 0.0133 |
| 25 | 0.0036 | −0.0006 | 0.0011 |
| 26 | −0.0013 | −0.0031 | 0.0026 |
| 27 | −0.0181 | 0.0022 | −0.0018 |
| 28 | 0.0063 | −0.0032 | −0.0067 |
| 29 | −0.0058 | 0.0049 | 0.0023 |
| 30 | 0.0005 | 0.0073 | 0.0019 |
| 31 | 0.0022 | 0.0006 | −0.002 |
| 32 | 0.0033 | 0.0086 | −0.0016 |
| 33 | −0.004 | −0.0024 | 0.0002 |

TABLE 41
Input measurement components to PCs 11, 12, 13, and 14 for
Perryman #3 at 15 mph with brakes disabled.

| VAR. | PC 11 | PC 12 | PC 13 | PC 14 |
|---|---|---|---|---|
| 1 | 0.0944 | −0.0218 | 0.3149 | −0.1061 |
| 2 | 0.0764 | −0.0638 | 0.0484 | −0.019 |
| 3 | −0.3583 | 0.1991 | 0.0275 | −0.1398 |
| 4 | −0.0528 | 0.039 | −0.0359 | 0.0564 |
| 5 | 0.0467 | 0.0015 | −0.0234 | −0.0558 |
| 6 | −0.0206 | 0.0383 | −0.0272 | 0.2642 |
| 7 | −0.0781 | −0.1099 | 0.178 | 0.3999 |
| 8 | 0.1166 | 0.1157 | −0.1406 | −0.4393 |
| 9 | −0.1387 | −0.0438 | 0.0589 | 0.2438 |
| 10 | 0.0384 | 0.1022 | −0.0178 | −0.0292 |
| 11 | 0.0476 | 0.0188 | −0.0296 | −0.0222 |
| 12 | −0.0383 | −0.0499 | −0.0251 | 0.1222 |
| 13 | 0.0361 | 0.0929 | −0.0207 | −0.062 |
| 14 | 0.0317 | 0.006 | −0.0184 | 0.0889 |
| 15 | −0.0579 | −0.0737 | 0.0256 | −0.0456 |
| 16 | 0.032 | −0.0899 | 0.094 | −0.205 |
| 17 | 0.1222 | −0.2245 | 0.1023 | −0.1401 |
| 18 | 0.1169 | −0.2614 | 0.0701 | −0.0432 |
| 19 | −0.0025 | −0.0448 | 0.0766 | −0.24 |
| 20 | −0.0076 | −0.0704 | 0.0098 | 0.1616 |
| 21 | −0.0293 | −0.0325 | 0.0121 | −0.1746 |
| 22 | 0.0106 | 0.2246 | −0.0833 | 0.0982 |
| 23 | −0.1745 | 0.1848 | −0.0243 | 0.1896 |
| 24 | 0.3286 | −0.1952 | −0.1047 | −0.1487 |
| 25 | −0.0222 | 0.2321 | −0.0748 | 0.1152 |
| 26 | −0.3088 | 0.2686 | 0.2463 | −0.194 |
| 27 | −0.2011 | 0.0309 | 0.1148 | −0.0856 |
| 28 | −0.0107 | −0.1291 | 0.1353 | −0.2456 |
| 29 | −0.2014 | 0.275 | 0.1077 | −0.0968 |
| 30 | −0.2289 | 0.1395 | 0.2338 | −0.2009 |
| 31 | 0.617 | 0.5417 | 0.4101 | 0.124 |
| 32 | 0.1311 | 0.3229 | −0.5909 | −0.1343 |
| 33 | −0.0732 | 0.0642 | −0.3268 | 0.0564 |

To determine the relationship between the input data, and corresponding principal components, with longitudinal strain; a regression analysis was performed. The first regression was performed using the singular value decomposition and the y training set. The error in the training model was calculated to be 48.7864 μinch/inch. The regression model was then used to predict the y test set from the x test set. The error was the calculated to be 51.2092 μinch/inch. With the PCs that are weighted toward the brake data: 11, 12, 13, and 14, removed the error increases by 0.2987 μinch/inch (0.58%), to 51.5079 μinch/inch.

The error when principal components are removed, starting with the last principal component (PC) was then determined, and is shown in FIG. 75. From the figure it can be seen that there is increase in the average error of only 1.9026 μinch/inch to a value 53.1118 μinch/inch when the last 25 principal components are removed, which includes PCs 11, 12, 13, and 14, which are weighted toward the brake data.

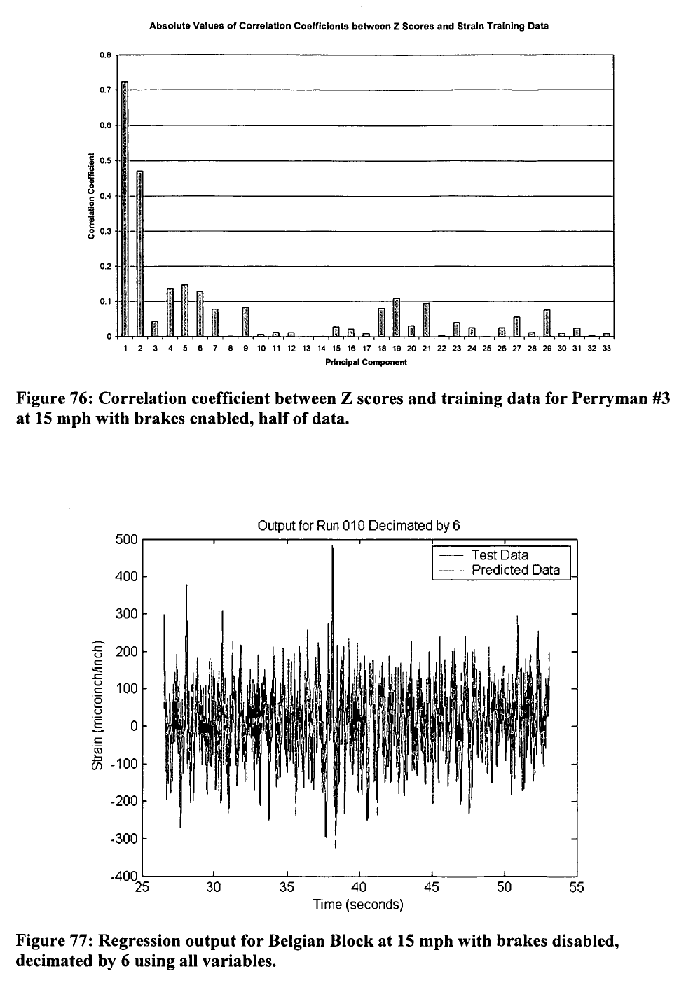

A correlation coefficient matrix of the z and y training data was made to determine which principal components are most useful in predicting acceleration. The absolute values of the correlation coefficients are shown in FIG. 76. From the figure it can be seen that the principal components that are weighted toward the brake data (11, 12, 13, and 14) are not correlated to the strain training data with correlation coefficients of 0.0119, 0.0115, 0.0001, and 0.0005, respectively.

The principal component analysis and regression also show for this data set that the brakes do not correlate to the longitudinal strain. The tenth, eleventh, twelfth, and thirteenth principal components were weighted toward the brake pressure data. These four principal components had an average correlation coefficient of 0.0008 between the Z score and longitudinal strain training data. The removal of these four principal components increase the average error by only 0.2987 μinch/inch, or 0.58%, reinforcing the conclusion that the activation of the surge brake does not affect the life of the trailer. This was expected since the brakes were disabled for this test run.

### E. Regression Analysis to Determine Input Variables

The regression models were initially created using the data from Belgian Block test runs at 15 mph decimated by 6 with the brakes both disabled and enabled, which are at 15 mph with the surge brake both disabled and enabled. By initially decimating by 6, this filtered the data to 84.175 Hz and re-sampled at 210.438 Hz. This decimation was purposely made lower than the strain gauge cutoff frequency of 100 Hz. The data was also divided into independent and dependent data sets. The dependent data was the calibrated aft longitudinal strain and the independent was from the non-strain data channels from the data collected. The channel for ground speed was eliminated since it was not a sensor located on the trailer. The dependent variables were numbered 1 through 33, as shown in Table 42, to simplify the analysis and graphs.

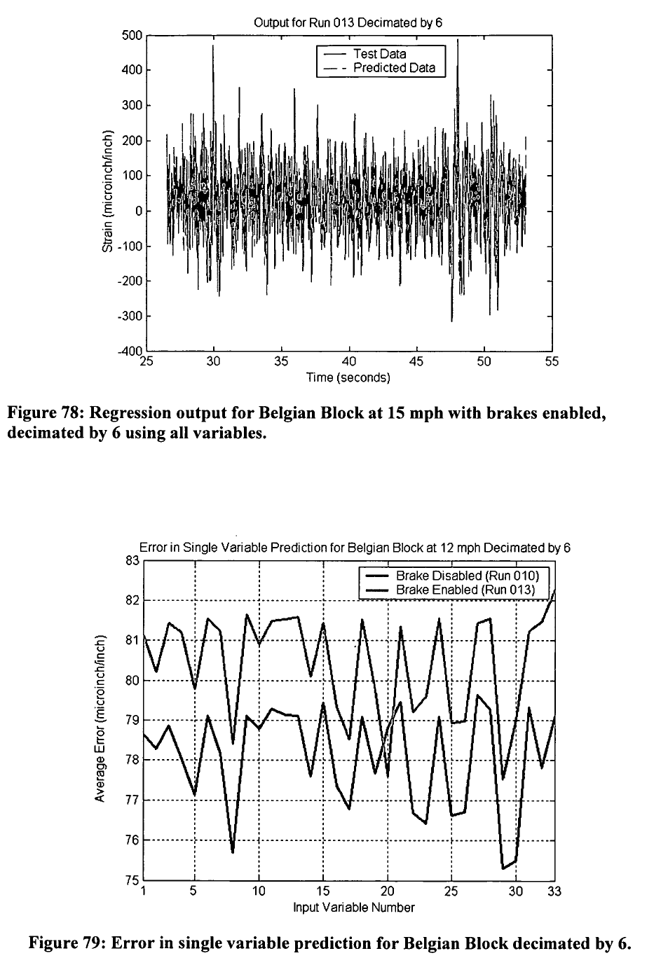

Once the data was selected and filtered, an initial regression model using all the possible input variables was created, as shown in FIGS. 77 and 78, to determine the least possible error that can be obtained with the current filtering of the data. The regressions using all the input variables had average errors of 53.9564 μinch/inch and 51.3792 μinch/inch for the Belgian Block test runs at 15 mph decimated by 6 with the brakes both disabled and enabled, respectively. This error is still higher than what is desirable.

TABLE 42
Input variables.

| Var # | Channel Description | Unit |
|---|---|---|
| 1 | CS Axle Accel (V) | g's |
| 2 | CS Frame Accel (V) | g's |
| 3 | RS Axle Accel (V) | g's |
| 4 | RS Frame Accel (V) | g's |
| 5 | Lunette Accel (V) | g's |
| 6 | Lunette Accel (T) | g's |
| 7 | Lunette Accel (L) | g's |
| 8 | Tongue Accel (V) | g's |
| 9 | Tongue Accel (T) | g's |
| 10 | Tongue Accel (L) | g's |
| 11 | Trailer CG Accel (V) | g's |
| 12 | Trailer CG Accel (T) | g's |
| 13 | Trailer CG Accel (L) | g's |
| 14 | CS Forward Accel (V) | g's |
| 15 | CS Forward Accel (T) | g's |
| 16 | CS Forward Accel (L) | g's |
| 17 | CS Aft Accel (V) | g's |
| 18 | CS Aft Accel (T) | g's |
| 19 | CS Aft Accel (L) | g's |
| 20 | RS Forward Accel (V) | g's |
| 21 | RS Forward Accel (T) | g's |
| 22 | RS Forward Accel (L) | g's |
| 23 | RS Aft Accel (V) | g's |
| 24 | RS Aft Accel (T) | g's |
| 25 | RS Aft Accel (L) | g's |
| 26 | Trailer CG Pitch Rate | deg/sec |
| 27 | Trailer CG Roll Rate | deg/sec |
| 28 | Trailer CG Yaw Rate | deg/sec |
| 29 | CS Shock Disp | inches |
| 30 | RS Shock Disp | inches |
| 31 | Surge Brake Press. | psi |
| 32 | CS Wheel Cyl. Press. | psi |
| 33 | RS Wheel Cyl. Press. | psi |

Regressions using one predictor variable for each input channel, channels other than strain, were then created. The average error for each variable was plotted as shown in FIG. 79. From the figure it can be easily seen that for the Belgian Block test runs at 15 mph decimated by 6 with the brakes both disabled and enabled, the channel for the CS shock absorber displacement had the lowest average errors of 75.2983 and 77.5264 μinch/inch, respectively, and the average errors have a consistent pattern between the two runs. For the Belgian Block test run at 15 mph decimated by 6 with the brakes disabled, the next two singles variables with the lowest average errors were the RS shock absorber displacement and the tongue vertical acceleration with errors of 75.4988 and 75.7006 μinch/inch, respectively. For the Belgian Block test run at 15 mph decimated by 6 with the brakes enabled, the next two singles variables with the lowest average errors were the RS forward and the tongue vertical accelerations with errors of 77.6032 and 78.4245 μinch/inch, respectively. It is interesting to note that the best average error for a single brake pressure variable was 81.2297 μinch/inch, for the surge brake pressure, 4.78% higher than the lowest average error. These average errors are still higher than what is desirable. From this result, it can be seen that a better value for the decimation of the data needs to be found.

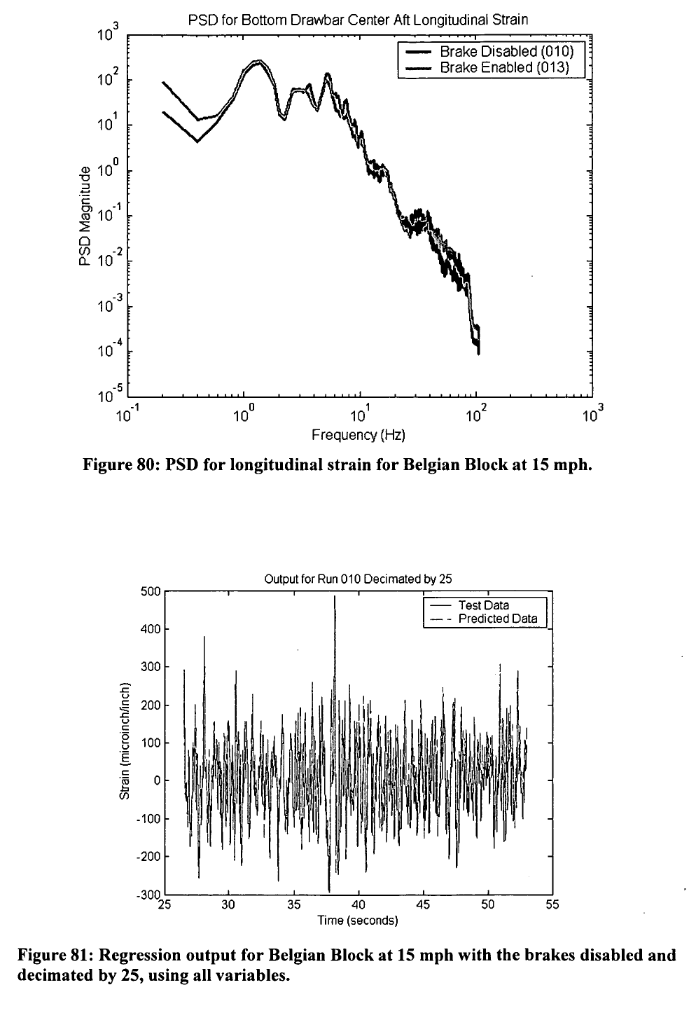

Since the errors are so high, the current filtering of the data allows too much ‘noise’ to be left in the data. To reduce the error, the ‘noise’ in the data needs to be eliminated. To determine a better frequency range for filtering, a PSD of the strain data decimated by 6 was calculated for both runs, as shown in FIG. 80. The PSD plot shows most of the energy to be in the 0 to 20 Hz range and then it begins to drops off. The data was then decimated by 25; this gave a filtered frequency of 20.202 Hz and a sampling frequency of 50.505 Hz.

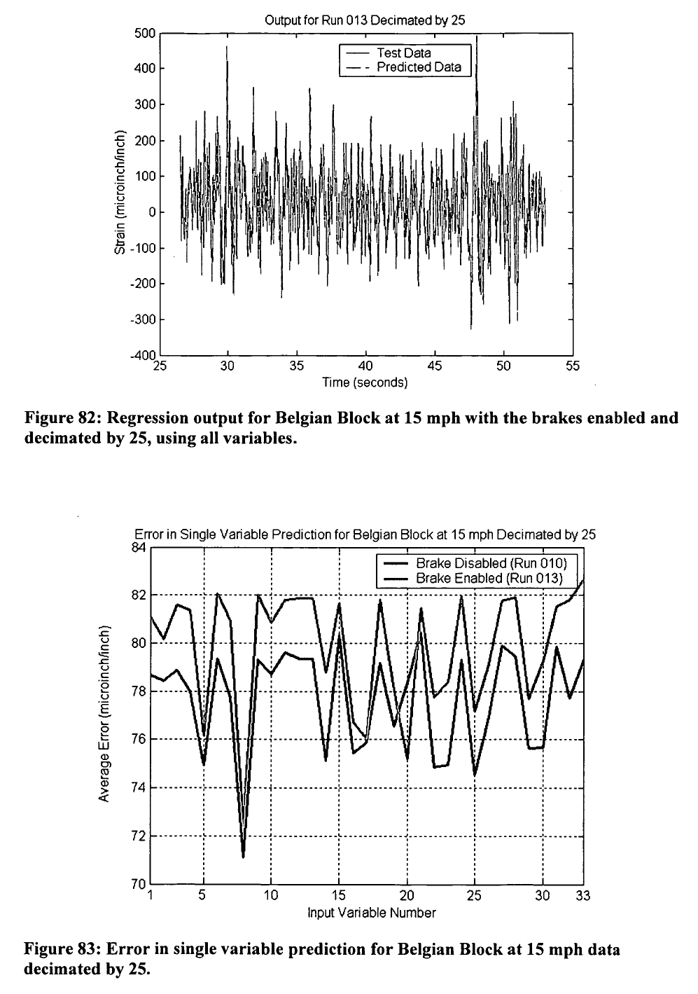

Once the data was filtered and re-sampled again, another set of initial regression models using all the predictor, input, variables were created and are shown in FIGS. 81 and 82. The new models had errors of 31.5985 μinch/inch and 16.1643 μinch/inch for Belgian Block test runs at 15 mph decimated by 25 with the brakes both disabled and enabled, respectively. These errors are much improved from the initial regressions. To determine which variables can be eliminated and still yield a good model, regressions with one predictor variable for each input channel, channels other than strain, were again created with the data now decimated by 25. The average error was plotted for each variable as shown in FIG. 83. From the figures it can be easily seen that for Belgian Block test runs at 15 mph decimated by 25 with the brakes both disabled and enabled, the channel for the tongue vertical acceleration had the lowest average errors of 71.0913 and 72.3969 μinch/inch, respectively and the average errors again have a consistent pattern between the two runs. For the Belgian Block test run at 15 mph decimated by 25 with the brakes disabled, the next single variables with the lowest average errors were the RS aft longitudinal and RS forward longitudinal, lunette vertical, and RS aft vertical accelerations with errors of 74.5518, 74.8586, 74.9232, and 74.9433 μinch/inch, respectively. For the Belgian Block test run at 15 mph decimated by 25 with the brakes enabled, the next single variables with the lowest average errors were the RS forward vertical, CS aft vertical, lunette vertical, and CS forward longitudinal accelerations with average errors of 75.2096, 76.0370, 76.1395, and 76.7431 μinch/inch, respectively. It is interesting to note that the best average error for a single brake pressure variable was 81.5349 μinch/inch, for the surge brake pressure, 12.623% higher than the lowest average error.

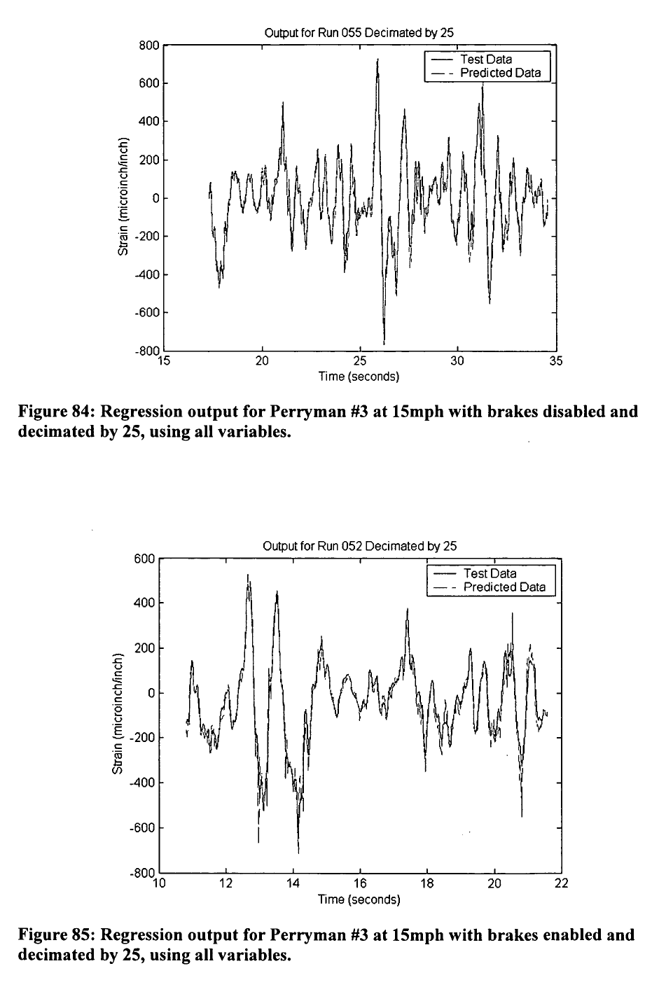

The data from the Perryman #3 test runs at 15 mph with the brakes both disabled and enabled was then analyzed. The analysis was conducted with the data decimated by 25, due to the results found from the Belgian Block data. The initial regression model using all the possible input variables was created, as shown in FIGS. 84 and 85, to determine the least possible error that can be obtained with the current filtering of the data. The regressions using all the input variables had average errors of 21.8781 μinch/inch and 33.3067 μinch/inch for Perryman #3 test runs at 15 mph decimated by 25 with the brakes both disabled and enabled, respectively. The data range of the strain Perryman #3 test runs at 15 mph decimated by 25 with the brakes both disabled and enabled was 1494.4 μinch/inch and 1242.7 μinch/inch, respectively. This error is 1.464% and 2.68% of the data range for Perryman #3 test runs at 15 mph decimated by 25 with the brakes both disabled and enabled, respectively, which can still be improved.

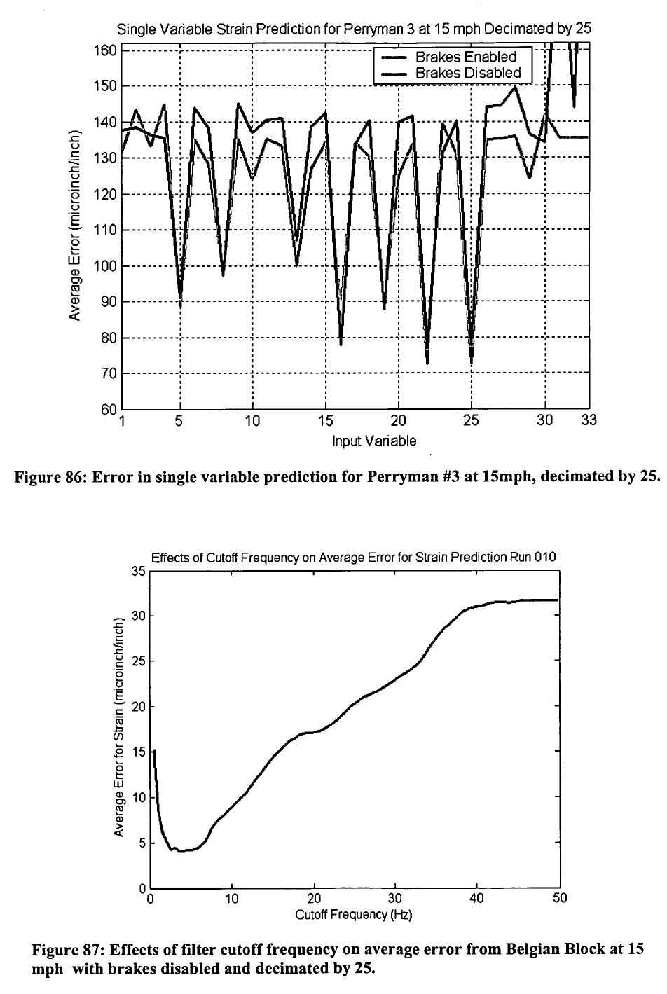

To determine which variables can be eliminated and still yield a good model, regressions with one predictor variable for each input channel, channels other than strain, were created. The average error was plotted for each variable as shown in FIG. 86. From the figures, it can be easily seen that for Perryman #3 test runs at 15 mph decimated by 25 with the brakes both disabled and enabled the channel for the RS forward longitudinal acceleration had the lowest average errors of 76.895 and 72.4 μinch/inch, respectively, and the average errors again have a consistent pattern between the two runs.

For Perryman #3 test run at 15 mph decimated by 25 with the brakes disabled, the next single variables with the lowest average errors were the RS aft longitudinal, CS forward longitudinal, CS aft longitudinal, lunette vertical, tongue vertical, and CG longitudinal accelerations, with errors of 77.658, 77.991, 87.74, 90.909, 97.279, and 107.14 μinch/inch, respectively. For Perryman #3 test run at 15 mph decimated by 25 with the brakes enabled, the next single variables with the lowest average errors were the with the lowest average errors were the RS aft longitudinal, CS forward longitudinal, lunette vertical, CS aft longitudinal, tongue vertical, and CG longitudinal accelerations, with errors of 72.583, 86.594, 88.591, 91.099, 97.36, and 99.765 μinch/inch, respectively. It is interesting to note that the best average error for a single brake pressure variable was 135.41 μinch/inch, for the surge brake pressure, 53.47% higher than the lowest average error.

The individual variables with the lowest errors from both the Belgian Block and Perryman #3 data with brakes enabled and disabled decimated by 25 are shown in Table 43. From the table, it can be seen that the lunette and tongue vertical accelerations have low prediction average prediction errors among all 4 test runs. CS forward longitudinal, RS forward, and RS aft accelerations have low prediction errors among 3 test runs. From this we can determine that these sensors should be used in any model created.

TABLE 43
Lowest average prediction errors for Belgian Block and
Perryman #3 test runs.

| | Average Prediction Error | | | |
|---|---|---|---|---|
| | Belgian Block | | Perryman #3 | |
| NAME | No Brakes | Brakes | No Brakes | Brakes |
| Lunette Accel. (V) | 74.9232 | 76.0370 | 90.909 | 88.591 |
| Tongue Accel. (V) | 71.0913 | 72.3967 | 97.279 | 97.36 |
| CG Accel. (L) | >75.0 | >77.0 | 107.14 | 99.765 |
| CS Forward Accel. (L) | >75.0 | 76.7431 | 77.991 | 86.594 |
| CS Aft Accel. (V) | >75.0 | 76.0370 | >131.0 | >124.0 |
| CS Aft Accel. (L) | >75.0 | >77.0 | 87.74 | 91.099 |
| RS Forward Accel. (V) | >75.0 | 75.2096 | >131.0 | >124.0 |
| RS Forward Accel. (L) | 74.8586 | >77.0 | 76.895 | 72.4 |
| RS Aft Accel. (V) | 74.9433 | >77.0 | >131.0 | >124.0 |
| RS Aft Accel. (L) | 74.5518 | >77.0 | 77.658 | 72.583 |

Data Filtering

From the regression analysis we can see that the increased decimation of the data decreases the average error of the model. Increased decimation lowers the frequency range of the input data, but information is lost as the data is re-sampled. To minimize this adverse effect of re-sampling and determine the effect of reducing the frequency range on the error, the data decimated by 25 was increasingly filtered using an 8-pole Butterworth filter.

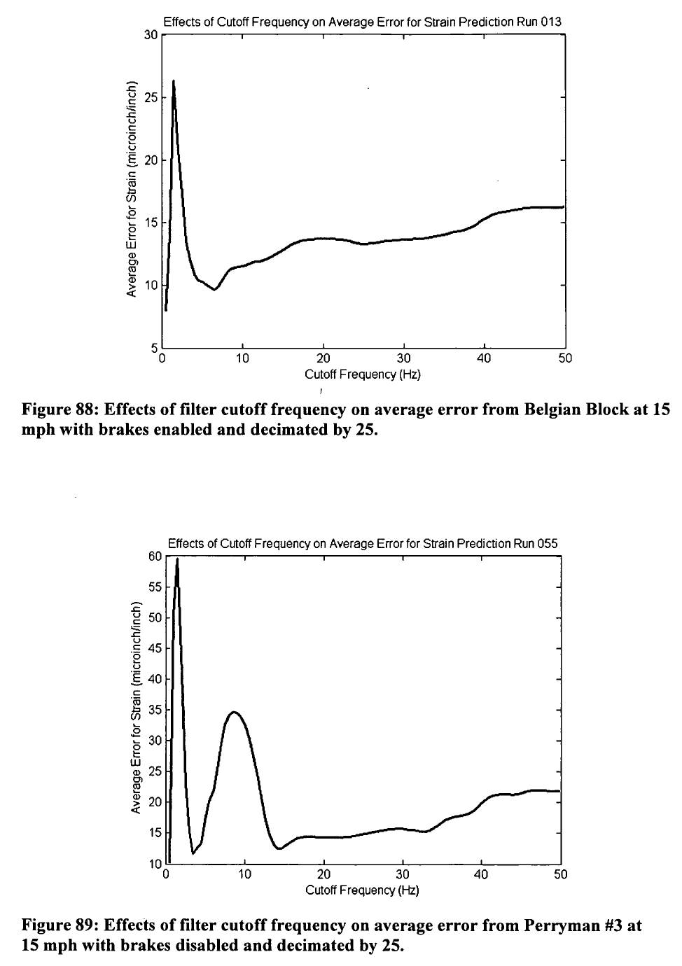

The effect of filtering the data at lower cutoff frequencies can be seen in FIGS. 87 through 90. From FIGS. 87 and 88, it can be seen that the average error, for the test data from the Belgian Block course at 15 mph with the brakes disabled and enabled, decreases continuously to minimums of 4.4989 μinch/inch and 9.6450 μinch/inch at frequencies of 3.5354 Hz and 6.5657 Hz, respectively, and then sharply rises.

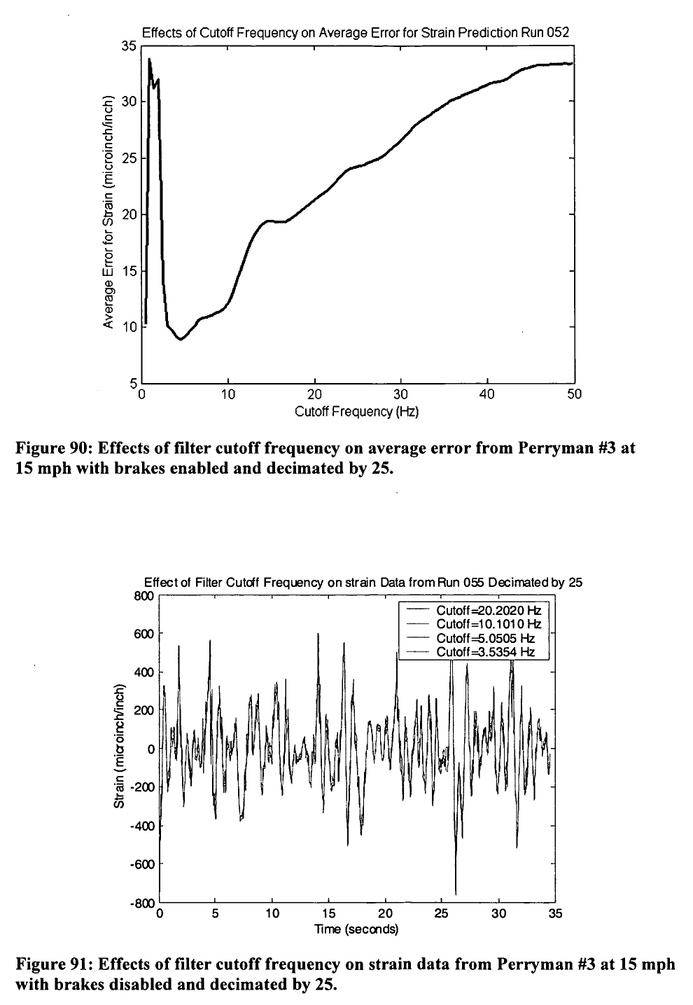

From FIGS. 89 and 90 it can be seen that the average error, for the test data from the Perryman #3 test course at 15 mph with the brakes disabled, decreases continuously to a minimum of 11.6794 μinch/inch at 3.5354 Hz, and then sharply rises and decreases once again. For the Perryman #3 test course at 15 mph with the brakes enabled, the error decreases continuously to a minimum of 8.8758 μinch/inch at 4.5455 Hz and then sharply rises, as seen with the Belgian Block test data. Also, from the figures it can be seen that the minimum average errors of 9.6450 μinch/inch and 8.8758 μinch/inch for predicting the test data from Belgian Block at 15 mph and Perryman #3 at 15 mph with the bakes enabled occur at filtered frequencies of 6.5657 Hz and 4.5455 Hz, respectively.

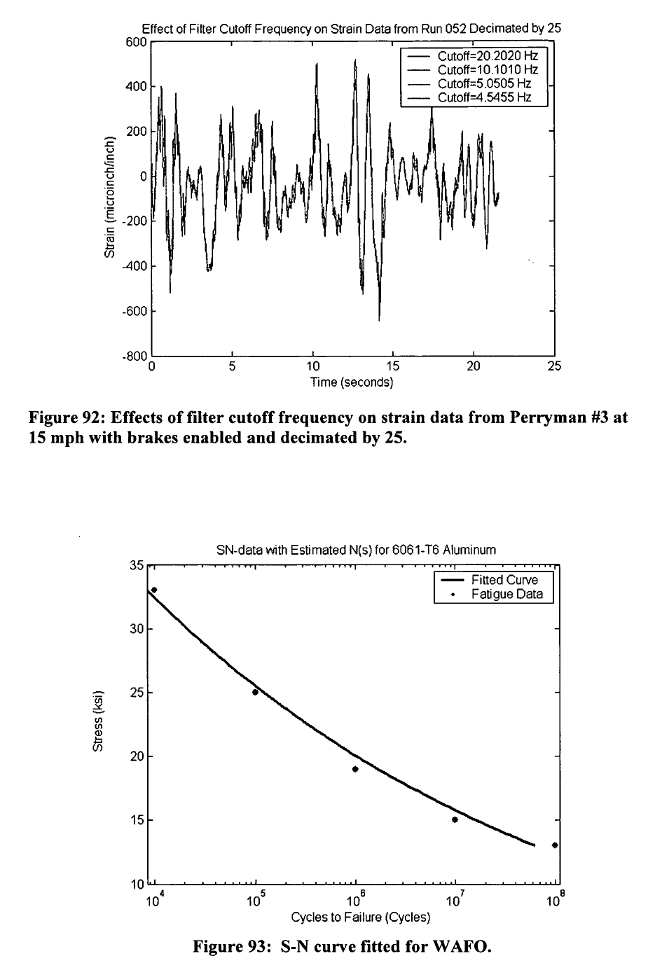

To determine the effects of filtering to lower frequencies on the strain data, the strains for several cutoff frequencies were compared, as shown in FIGS. 91 and 92. From the figures, it can be seen that effect of the filtering, to the cutoff frequency corresponding to the minimum average error, on the data is minimal.

Once it was determined that the cutoff frequency corresponding to the minimum average error was acceptable, the most appropriate model could be chosen. The most appropriate model was chosen using forward selection for the filtered data sets for Belgian Block at 15 mph and Perryman #3 at 15 mph with the brakes enabled that were decimated by 25. The cutoff frequency used for the Perryman #3 data at 15 mph with the brakes disabled and enabled was 3.5354 Hz and 4.5455 Hz, respectively. The cutoff frequency used for the Belgian Block data at 15 mph with the brakes enabled and disabled was 6.5657 Hz and 4.0404 Hz, respectively.

The forward selection R², component and total, values for the Perryman #3 and Belgian Block test runs at 15 mph, respectively, are shown in Table 44. As can be seen from the table, the first four variables hold most of the R² value. Therefore, an appropriate model can be created using a combination of only these four variables.

Variable 22 (RS forward longitudinal acceleration) appears as the first variable for both Perryman #3 test runs at 15 mph while variable 25 (RS aft longitudinal acceleration) appears as the first variable for both Belgian Block test runs at 15 mph. The acceleration values in the longitudinal direction should be the same for both sensors on the ends of a rigid structure. Therefore, the longitudinal acceleration on the RS appears as the first variables for all four test runs.

TABLE 44
Forward selection R² values for Belgian Block and Perryman #3.

| Perryman #3 15 mph | | | Perryman #3 15 mph | | | Belgian Block 15 mph | | | Belgian Block 15 mph | | |
|---|---|---|---|---|---|---|---|---|---|---|---|
| Brakes Enabled | | | Brakes Disabled | | | Brakes Enabled | | | Brakes Disabled | | |
| | R² | R² | | R² | R² | | R² | R² | | R² | R² |
| Var. | Comp. | Total | Var. | Comp. | Total | Var. | Comp. | Total | Var. | Comp. | Total |
| 22 | 0.9335 | 0.9335 | 22 | 0.9063 | 0.9063 | 25 | 0.7119 | 0.7119 | 25 | 0.6058 | 0.6058 |
| 19 | 0.037 | 0.9705 | 5 | 0.0651 | 0.9714 | 19 | 0.216 | 0.9279 | 19 | 0.2417 | 0.8475 |
| 8 | 0.0239 | 0.9944 | 19 | 0.0212 | 0.9926 | 5 | 0.0537 | 0.9816 | 5 | 0.1353 | 0.9828 |
| 17 | 0.0025 | 0.9969 | 10 | 0.0035 | 0.9961 | 22 | 0.0116 | 0.9932 | 16 | 0.0064 | 0.9892 |
| 29 | 0.0004 | 0.9973 | 29 | 0.0008 | 0.9969 | 13 | 0.0019 | 0.9951 | 8 | 0.0019 | 0.9911 |
| 2 | 0.0003 | 0.9976 | 8 | 0.0004 | 0.9973 | 26 | 0.0008 | 0.9959 | 2 | 0.0026 | 0.9937 |
| 25 | 0.0002 | 0.9978 | 1 | 0.0003 | 0.9976 | 21 | 0.0003 | 0.9962 | 22 | 0.0003 | 0.994 |
| 3 | 0.0004 | 0.9982 | 11 | 0.0002 | 0.9978 | 15 | 0.0004 | 0.9966 | 17 | 0.0003 | 0.9943 |
| 5 | 0.0001 | 0.9983 | 16 | 0.0004 | 0.9982 | 30 | 0.0001 | 0.9967 | 13 | 0.0004 | 0.9947 |
| 9 | 0.0001 | 0.9984 | 33 | 0.0002 | 0.9984 | 8 | 0.0001 | 0.9968 | 11 | 0.0003 | 0.995 |
| 15 | 0.0001 | 0.9985 | 25 | 0.0002 | 0.9986 | 11 | 0.0002 | 0.997 | 3 | 0.0003 | 0.9953 |

From the Table 44, it can be seen variable 19 (CS aft longitudinal acceleration) appears within the first four variables of all four runs. The CS aft longitudinal acceleration contributes the second highest amount to the R² value for the Perryman #3 at 15 mph and Belgian Block test runs at 15 mph with the brakes disabled. The CS aft longitudinal acceleration also contributes the second highest amount to the R² value for the Belgian Block test run at 15 mph with the brakes enabled, and the third highest amount to the R² value for the Perryman #3 test run at 15 mph with the brakes enabled.

Variable 5 (lunette vertical acceleration) contributes the third highest amount to the R value for the Belgian Block test runs at 15 mph with the brakes both enabled and disabled. The lunette vertical acceleration contributes the second highest amount to the R² value for the Perryman #3 test run at 15 mph with the brakes enabled.

Variable 8 (tongue vertical acceleration) contribute the third highest amount to the R² value for the Perryman #3 test run at 15 mph with the brakes disabled. The fourth highest contributor to the R² value for the Perryman #3 test runs at 15 mph with the brakes both enabled and disabled were variables 10 (tongue vertical acceleration) and 17 (CS aft vertical acceleration), respectively. The fourth highest contributors to the R value for the Belgian Block test runs at 15 mph with the brakes disabled and enabled were 22 (RS forward longitudinal acceleration), and 16 (CS forward longitudinal acceleration), respectively.

From this analysis, it can determined that the RS forward longitudinal, CS aft longitudinal, and lunette vertical accelerations should be used for any further models. To determine if a fourth variable should be used, a series of regressions were made. The regressions were created for Perryman #3 at 15 mph and Belgian Block at 15 mph test runs with the brakes enabled. As shown in Table 45, the regressions compared combinations of the first 4 variables that contributed the highest amount to the R value.

From Table 45, it can be seen that a fourth variable should be used. The models with the lowest average error for both test runs include the variables: 5, 10, 19, and 22. These are for lunette vertical, tongue vertical, CS aft longitudinal, and RS forward longitudinal accelerations, respectively. These four sensors can be used to accurately predict the longitudinal strain at the drawbar failure location.

TABLE 45
Average regression error for selected variables using test data from
Belgian Block and Perryman #3 at 15 mph with brakes enabled.

AVERAGE ERROR (μinch/inch)

| VARIABLES USED | PERRYMAN #3 | BELGIAN BLOCK |
|---|---|---|
| ALL | 8.8758 | 9.6450 |
| 5, 22 | 24.632 | 22.8946 |
| 5, 19, 22 | 11.7328 | 5.5161 |
| 5, 10, 19, 22 | 8.916 | 5.0092 |
| 5, 10, 16, 19, 22 | 9.1131 | 4.9749 |
| 5, 8, 16, 22, 25 | 14.7574 | 9.2955 |
| 5, 16, 19, 25 | 19.2532 | 7.3962 |

### F. Effect of Filtering on Fatigue Life Prediction

One of the primary goals of this research is to show that the fatigue damage, at the drawbar location on the trailer, can be determine accurately from predicted strain data. This will allow the use of a group of accelerometers to be used to monitor the fatigue damage to the part. This allows the direct monitoring of the changes in the fatigue life of the part.

In order to determine the accuracy of the strain predicted from the model; the predicted fatigue life was calculated and compared to the life calculated from the original data. The effect of filtering on the fatigue life calculation was also analyzed to determine if filtering has a significant effect on the results. From this the frequency range that the damage occurs can also be analyzed.

To calculate fatigue life, the Matlab toolbox Wave Analysis for Fatigue and Oceanography (WAFO) was used. WAFO uses routines based on extreme value and crossing analysis to analyze random waves and loads. To calculate fatigue, WAFO calculates the rainflow cycles from a series of turning points calculated from the load data. The Stress-Life (S-N) curve is then used to calculate the material specific parameters used in the damage calculation, based on the Wohler curve and the Palmgren-Miner rule.

The material used in the trailer was 6061-T6 aluminum. The S-N curve data for the trailer material was created from fatigue data taken from the Structural Alloys Handbook edited by Holt, Mindlin, and Ho (1996). The S-N curve was then plotted and fitted for use in WAFO, as shown in FIG. 93.

The maximum stress was well below the yield stress, therefore, a linear relationship between stress and strain was used. The strain, ε, data was converted to stress, σ, data by relating the stress and strain by the elastic modulus, E, for aluminum of 10*10⁶ ksi.
σ=ε*E (35)

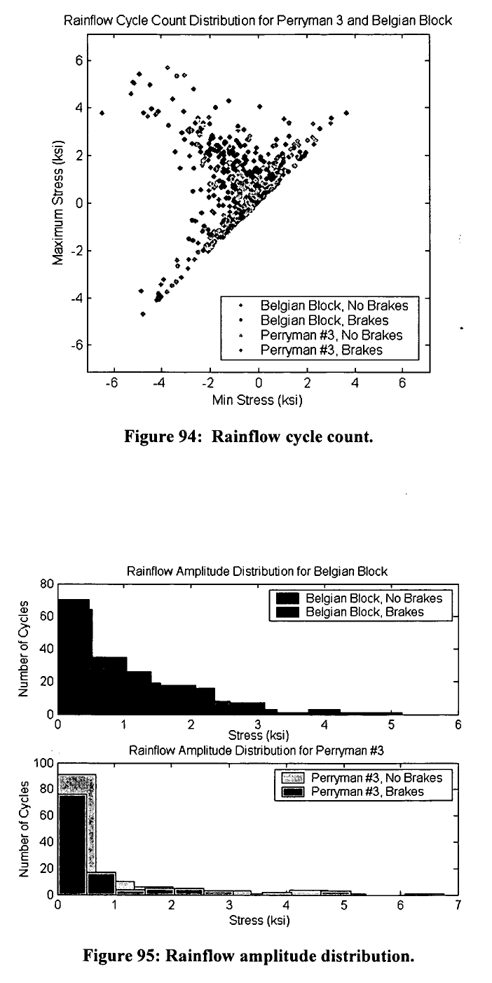

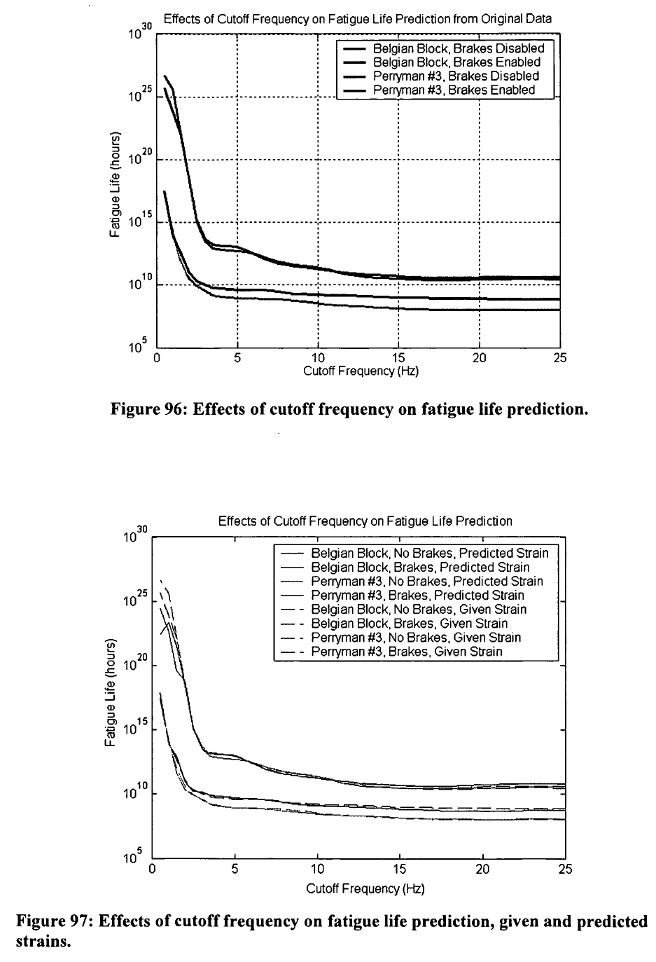

The rainflow cycles were then calculated by WAFO for both Belgian Block and Perryman #3 test courses at 15 mph, with the brakes both enabled and disabled, as shown in FIGS. 94 and 95. For FIGS. 94 and 95, only the first 1100 data points were used so that comparisons could be made. FIG. 94, it can be seen that the cycle count distribution is very similar for all four test runs, with the cycles being over a wider range for the Perryman #3 test data. FIG. 95 shows the rainflow amplitude distribution to decrease in cycle count as stress increases, for Belgian Block. The figure also shows the cycle count to drastically decrease with an increase in stress above 1 ksi for the Perryman #3 test course. This would be expected since the Perryman #3 test course is more randomly distributed than the more normally distributed Belgian Block test course. The brakes do not seem to have a definite effect on the cycle count for either test course. The fatigue life was then calculated in both hours and distance, as shown in Tables 46 and 47, respectively. As can be seen from both Tables, the fatigue life estimates for all four test runs indicated infinite life. The fatigue life value increased for the data sets that had been filtered to their optimum frequency. The percent differences between the test and predicted life improved, as can be seen from Table 46 for the optimized frequencies. As expected the use of only the four variables: lunette vertical acceleration, tongue vertical acceleration, curbside aft longitudinal, and roadside aft longitudinal acceleration, did not significantly change the predicted life results.

TABLE 46
Fatigue life estimates in hours.

| | | | | | | | Optimum Filtering with | | |
|---|---|---|---|---|---|---|---|---|---|
| | Decimated by 25 | | | Optimum Filtering | | | Selected Variables | | |
| | Life (hours) | | | Life (hours) | | | Life (hours) | | |
| Run Data | Test | Pred. | % Diff. | Test | Pred. | % Diff. | Test | Pred. | % Diff. |
| BB w/o | 3.52E+10 | 6.36E+10 | 80.80 | 1.37E+13 | 1.12E+13 | 18.33 | 1.37E+13 | 1.13E+13 | 17.39 |
| Brakes | | | | | | | | | |
| BB with | 2.49E+10 | 2.57E+10 | 3.19 | 1.81E+12 | 1.86E+12 | 2.54 | 1.81E+12 | 1.96E+12 | 8.48 |
| Brakes | | | | | | | | | |
| Perry 3 w/o | 1.04E+08 | 1.10E+08 | 5.45 | 1.51E+09 | 1.74E+09 | 15.03 | 1.51E+09 | 1.64E+09 | 8.11 |
| Brakes | | | | | | | | | |
| Perry 3 with | 7.35E+08 | 3.43E+08 | 53.33 | 4.66E+09 | 6.17E+09 | 32.51 | 4.66E+09 | 6.29E+09 | 35.05 |
| Brakes | | | | | | | | | |

TABLE 47
Fatigue life estimates in miles.

| | | | | | Optimum Filtering | |
|---|---|---|---|---|---|---|
| | | | | | with | |
| | Decimated by 25 | | Optimum Filtering | | Selected Variables | |
| | Life (miles) | | Life (miles) | | Life (miles) | |
| Run Data | Test | Predicted | Test | Predicted | Test | Predicted |
| BB w/o Brakes | 5.28E+11 | 9.54E+11 | 2.05E+14 | 1.68E+14 | 2.05E+14 | 1.69E+14 |
| BB with Brakes | 3.74E+11 | 3.86E+11 | 2.71E+13 | 2.78E+13 | 2.71E+13 | 2.94E+13 |
| Perry 3 w/o | 1.56E+09 | 1.65E+09 | 2.27E+10 | 2.61E+10 | 2.27E+10 | 2.45E+10 |
| Brakes | | | | | | |
| Perry 3 with | 1.10E+110 | 5.14E+09 | 6.99E+10 | 9.26E+10 | 6.99E+10 | 9.43E+10 |
| Brakes | | | | | | |

The calculated fatigue life predictions are close, but need to be closer for improved accuracy for on-line prediction. The data filter needs to be set at a value that not only produces accurate strain prediction, but also produces accurate life prediction. From FIG. 96, it can be seen that the fatigue life prediction value stays fairly constant and then rises sharply at a low cutoff frequency for both the predicted and given strains. This shows that the fatigue damage occurs below a given frequency. This frequency can be used as the cutoff frequency for filtering. From FIG. 97, it can also be seen that the fatigue life prediction is very close between the predicted and given strains. This supports the use of the regression model previously found, and allows the determination to be made that the filtering should be based upon the predicted fatigue life and not the predicted strain. The errors in strain prediction are lowest at a frequency below which the fatigue life prediction errors are at a minimum.

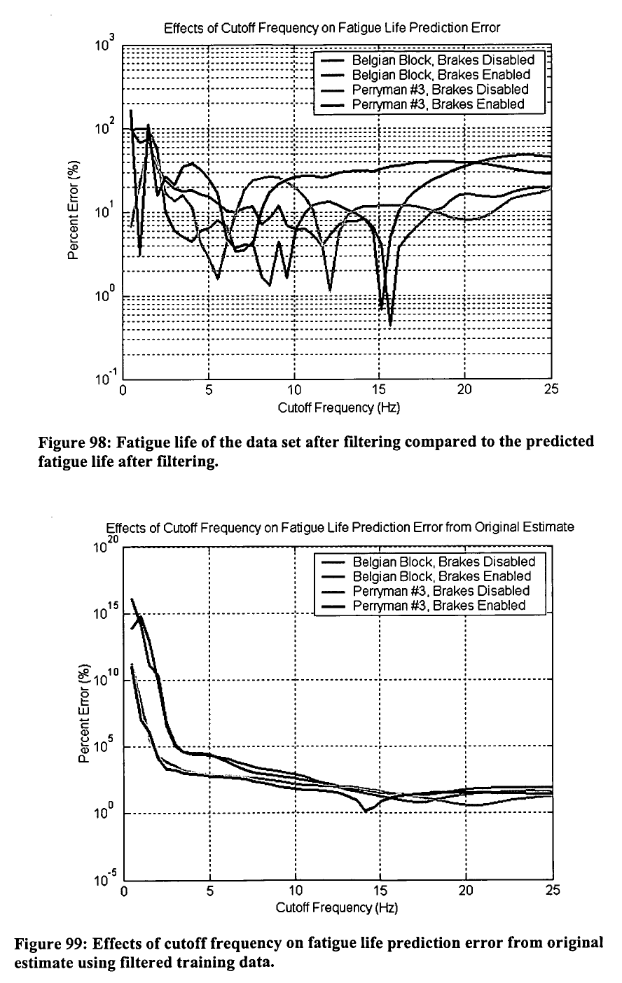

To determine the frequency that allows the lowest fatigue life prediction, the fatigue life of the data set after filtering was compared to the predicted fatigue life after filtering. As can be seen from FIG. 98, the frequency that allows the most accurate prediction of the fatigue life yielding average error of 6.58%, from filtered test data is 6.5657 Hz, as would be expected from the low frequency results of the regression analysis. The percent errors at this frequency are 9.955%, 3.420%, 9.202%, and 3.724%, for the Belgian Block test runs at 15 mph with the brakes both disabled and enabled and the Perryman #3 test runs at 15 mph, with the brakes both disabled and enabled, respectively. The minimum error and corresponding frequencies can be found in Table 48.

TABLE 48
Minimum error and from original life prediction
and corresponding cutoff frequencies.

| | Minimum | Cutoff |
|---|---|---|
| Run Data | Error (%) | Freq. (Hz) |
| BB w/o Brakes | 0.672 | 15.152 |
| BB with Brakes | 1.33 | 8.5859 |
| Perry 3 w/o Brakes | 1.334 | 12.121 |
| Perry 3 with Brakes | 3.084 | 1.0101 |

With the results of the life prediction errors using filtered data showing adequate results for prediction and decreasing errors corresponding to low frequencies, a final determination of the appropriate cutoff frequency was made. The determination was based upon the error in life prediction as it relates to the life estimate from the data that was only decimated by a factor of 25. As can be seen from FIG. 99, the most appropriate filter cutoff frequency for all 4 test runs was found to be 17.172 Hz. This shows that the data can be filtered to this level and the filtering has not significantly changed the estimated life from the original data without further filtering from the initial decimation by 25. This accounts for both the error in prediction and the effect of filtering on the life estimate due to lost peaks in the strain. As shown in Table 49, for 2 test runs: Belgian Block at 15 mph, with the brakes both disabled and enabled the error is at a minimum error at 17.172 Hz, and the minimum error for the Perryman #3 test course at 15 mph with the brakes both disabled and enabled was 20.707 Hz and 14.141 Hz, respectively. With these frequencies corresponding to the minimum errors, it can be concluded that the fatigue damage takes place at or below these frequencies.

TABLE 49
Minimum error and corresponding cutoff frequencies.

| | Minimum | Cutoff |
|---|---|---|
| Run Data | Error (%) | Freq. (Hz) |
| BB w/o Brakes | 22.29 | 17.172 |
| BB with Brakes | 6.277 | 17.172 |
| Perry 3 w/o Brakes | 3.658 | 20.707 |
| Perry 3 with Brakes | 1.437 | 14.141 |

From the fatigue life estimates and prediction errors, the cutoff frequency should be set at a value close to 17.172 Hz. As shown in Table 50, this frequency accounts for majority of the fatigue damage and yields an average prediction error of 18.21% of the original life estimate; with errors of 22.29%, 6.277%, 16.844%, and 27.444%, for Belgian Block at 15 mph with the brakes both disabled and enabled and Perryman #3 at 15 mph with the brakes both disabled and enabled, respectively. The estimated fatigue life predicted from the data filtered at 17.172 Hz, and the original life estimate from the data decimated by 25 can also be found in Table 50.

TABLE 50
Fatigue life estimates and prediction errors
at a cutoff frequency of 17.172 Hz.

Life (hours)

| Run Data | Predicted | Original | % Difference |
|---|---|---|---|
| BB w/o Brakes | 4.2988E10 | 3.5153E10 | 22.29 |
| BB with Brakes | 2.6494E10 | 2.4929E10 | 6.277 |
| Perry 3 w/o Brakes | 1.2156E8 | 1.0404E8 | 16.844 |
| Perry 3 with Brakes | 5.3312E8 | 7.3477E8 | 27.444 |

The model based upon the error in life prediction, as it relates to the life estimate from the data that was only decimated by a factor of 25, was trained using both filtered acceleration and strain data. A final analysis of the life prediction from the data that was only decimated by a factor of 25, using a model trained with filtered acceleration and strain data that was decimated by a factor of 25. With the results of the life prediction errors based upon the error in life prediction as it relates to the life estimate from the data that was only decimated by a factor of 25, a final determination of the appropriate cutoff frequency and model training data can be made.

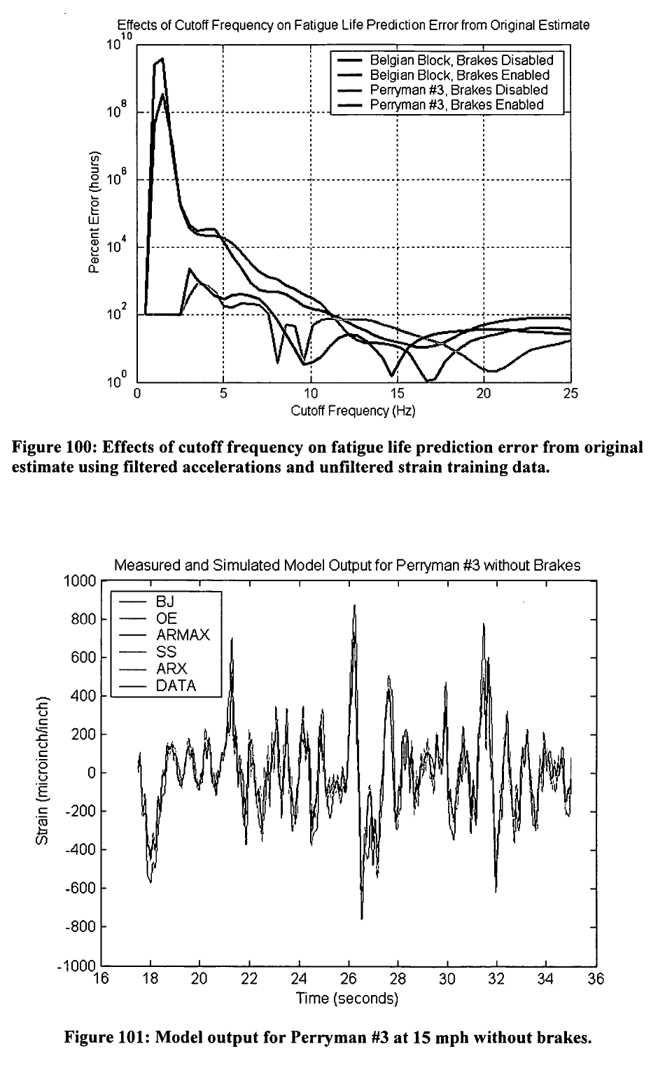

As before, the determination was based upon the error in life prediction as it relates to the life estimate from the data that was only decimated by a factor of 25. As can be seen from FIG. 100, the most appropriate filter cutoff frequency for the acceleration data for all 4 test runs was found to be 16.667 Hz which is only one data point away, with a resolution of 0.0505 Hz, from the prior result of 17.172 Hz. This supports the result that the data can be filtered to this level and the filtering has not significantly changed the estimated life from the original data without further filtering from the initial decimation by 25. This again accounts for both the error in prediction and the effect of filtering on the life estimate due to lost peaks in the strain. As shown in Table 51, for 2 test runs: Belgian Block at 15 mph, with the brakes both disabled and enabled the error is at a minimum error at 16.667 Hz, and for the Perryman #3 test course at 15 mph with the brakes disabled and enabled was 20.707 Hz and 14.646 Hz, respectively. These minimum frequencies are all within 1 data point of the minimums found with the model trained from filtered data. With these frequencies corresponding to the minimum errors, it can be concluded that the fatigue damage takes place at or below these frequencies.

TABLE 51
Minimum error and corresponding cutoff frequencies for model
using unfiltered strain data for model training.

| | Minimum | Cutoff |
|---|---|---|
| Run Data | Error (%) | Freq. (Hz) |
| BB w/o Brakes | 10.647 | 16.667 |
| BB with Brakes | 1.076 | 16.667 |
| Perry 3 w/o Brakes | 2.092 | 20.707 |
| Perry 3 with Brakes | 1.535 | 14.646 |

From the fatigue life estimates and prediction errors from this model, filtered acceleration and strain decimated by 25, the cutoff frequency should be set at a value close to 16.667 Hz. As shown in Table 52, this frequency accounts for majority of the fatigue damage and yields an average prediction error of 13.44% of the original life estimate; with errors of 10.647%, 1.076%, 19.476%, and 22.557%, for Belgian Block at 15 mph with the brakes both disabled and enabled and Perryman #3 at 15 mph with the brakes both disabled and enabled, respectively.

The estimated fatigue life predicted from the acceleration data filtered at 16.667 Hz, and the training strain and original life estimate from the data decimated by 25 can also be found in Table 52. The estimated fatigue life predicted from the strain and acceleration data filtered at 17.172 Hz, and the original life estimate from the data decimated by 25 can be found in Table 53. This cutoff frequency yields an average prediction error of 13.98%, which is only 0.53% above the error for a cutoff frequency of 16.667 Hz. Therefore, the more conservative cutoff frequency of 17.172 Hz should be used.

TABLE 52
Fatigue life estimates and prediction errors from model trained
with unfiltered strain data, at a cutoff frequency of 16.667 Hz.

Life (hours)

| Run Data | Predicted | Original | % Difference |
|---|---|---|---|
| BB w/o Brakes | 3.8896E10 | 3.5153E10 | 10.647 |
| BB with Brakes | 3.0054E19 | 2.4929E10 | 1.076 |
| Perry 3 w/o Brakes | 1.243E8 | 1.0404E8 | 19.476 |
| Perry 3 with Brakes | 5.6903E8 | 7.3477E8 | 16.667 |

The error for the life prediction using filtered acceleration and strain decimated by 25 decreased by 4.23% from the model that used filtered strain for model training. From this result it can be concluded that the model should be created using acceleration data filtered at 17.127 Hz and strain data decimated by 25. The data used for fatigue life calculation, stress, should also be filtered at 17.127 Hz. Since the failure criteria of a 2 mm crack is assumed to be 70% of the total fatigue life, the average error of 13.98% can be an acceptable error level to determine the useful life the drawbar.

TABLE 53
Fatigue life estimates and prediction errors from model trained
with unfiltered strain data, at a cutoff frequency of 17.172 Hz.

Life (hours)

| Run Data | Predicted | Original | % Difference |
|---|---|---|---|
| BB w/o Brakes | 3.9358E10 | 3.5153E10 | 11.961 |
| BB with Brakes | 2.9516E10 | 2.4929E10 | 1.208 |
| Perry 3 w/o Brakes | 1.2075E8 | 1.0404E8 | 16.061 |
| Perry 3 with Brakes | 5.3865E8 | 7.3477E8 | 26.691 |

### G. Determining Dynamic Model Using Input Variables and Filtering

Using the input variables determined above and the filtering determined above, the appropriate dynamic model will be determined. The strain and acceleration data for the Belgian Block and Perryman #3 courses at 15 mph with the brakes both disabled and enabled was decimated by 25, and filtered with a cutoff frequency of 17.172 Hz. A concatenated data set was also created by combining equal amounts of data for all 4 test runs. The concatenated data set was created so that all 4 data sets would appear in both the training and test data, allowing different terrains to be predicted (simulated) by the model. The order of the test sets was: Perryman #3 without brakes, Belgian Block with brakes, Perryman #3 with brakes, and Belgian Block without brakes, all at 15 mph.

A general model for a time discrete data with a noise-free input u(t), a noise source e(t), and an output y(t) can be written as:
y(t)=G(q,θ)u(t)+H(q,θ)e(t) (36)
where
G(q,θ)=B(q)/F(q) (37)
and
H(q,θ)=C(q)/D(q) (38)

Equation (36) is the Box-Jenkins (BJ) model. If the disturbance signal is not modeled, then H(q,θ)=1 and equation (36) becomes:
y(t)=G(q,θ)u(t)+e(t) (39)
which is the output error (OE) model. If the same denominator is used for G and H:
F(q)=D(q)=A(q) (40)
From 36 we obtain the auto-regression moving average with exogenous inputs (ARMAX) model:
A(q)y(t)=B(q)u(t)+C(q)e(t) (41)
For the case C=1, we have the auto-regression with exogenous inputs (ARX) model:
A(q)y(t)=B(q)u(t)+e(t) (42)
Another type of model is the state-space (SS) model:
ti x(t+1)=Ax(t)+Bu(t)+Ke(t) (43)
y(t)=Cx(t)+Du(t)+e(t) (44)
where x(t) is a state vector and A, B, C, D, and K, are matrices of parameters.

Using the Matlab ident toolbox, several models were created and analyzed to determine the most appropriate model to be used: ARX, ARMAX, Box-Jenkins (BJ), output error (OE), and state-space (SS). The state-space model was created using a prediction error/maximum (PEM) model with K=0, this removes the disturbance term and creates an OE model that can easily be used and transformed into a transfer function for use in a control system. The data was mean centered, detrended, and divided into training and test sets of equal length. The training (model) data was used to create the model, and the test set was used to validate the model.

The appropriate model will be determined by using the best fit of the model. The fit of the model is determined by the equation:

$$FIT = \frac{1 - NORM ( Y - Yhat )}{NORM [ Y - Mean ( Y ) ]} \cdot 100 \% \qquad ( 45 )$$

where Y is the measured output and Yhat is the predicted model output. The fit is the percent of the output variations reproduced by the model.

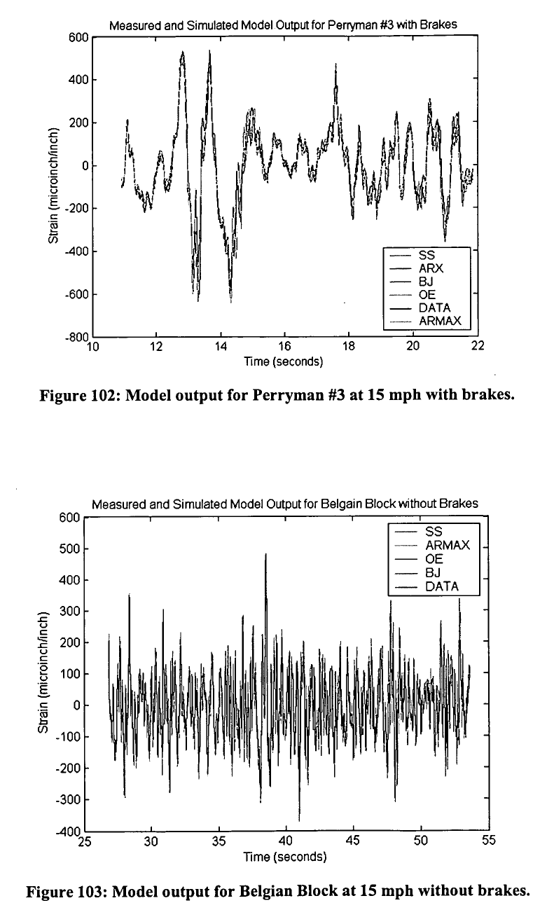

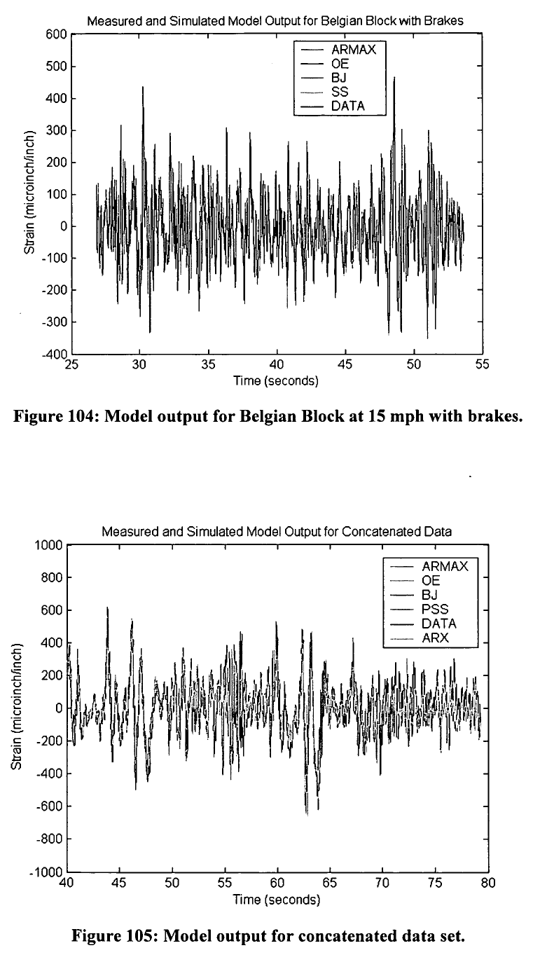

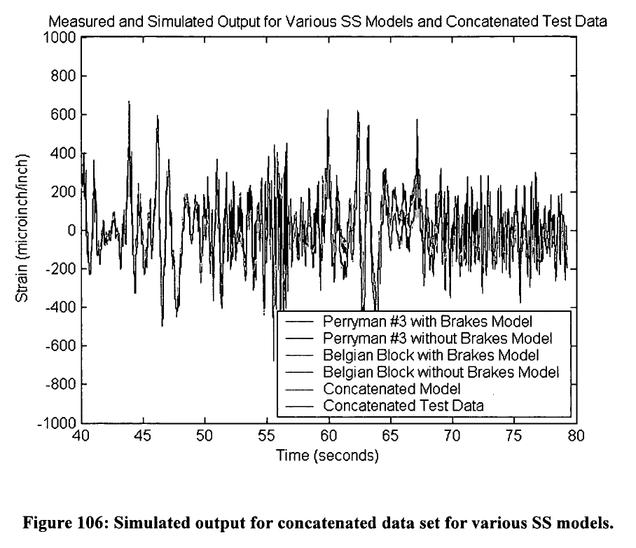

From Table 54 and FIGS. 101 through 105, it can be seen that the state-space model has the best fit for the Belgian Block, Perryman #3, and concatenated data sets. The model best fits were then determined for each state-space model created and validated, using each data set. From Table 55 and FIG. 106, it can be seen that the best state-space model fits were for the Perryman #3 test data. It can also be seen that the state-space models created using the Belgian Block and Perryman #3 model data fit the concatenated test data very poorly. This shows that a model created from training data from a single terrain cannot be used to effectively predict the response from a continuous signal with varying terrain, although the model may predict the response from separate signals effectively.

TABLE 54
Best fit for each model type and data set.

| | Best Fit (%) for Test Data | | | | |
|---|---|---|---|---|---|
| | Perryman #3 | | Belgian Block | | Concate- |
| Model | No Brakes | Brakes | No Brakes | Brakes | nated |
| ARMAX | 82.166 | 70.376 | 58.936 | 53.219 | 52.010 |
| ARX | 71.823 | 68.897 | −7.532 | −18330 | 58.944 |
| BJ | 47.133 | 79.420 | 65.353 | 68.520 | 43.285 |
| OE | 86.752 | 81.307 | 72.745 | 76.761 | 64.473 |
| SS | 88.697 | 82.718 | 77.631 | 78.034 | 72.754 |

TABLE 55
Best fit for SS model for each training (model) and test data set.

| | Best Fit (%) for Test Data | | | | |
|---|---|---|---|---|---|
| | Perryman #3 | | Belgian Block | | |
| Model Data | No Brakes | Brakes | No Brakes | Brakes | Concatenated |
| Perryman #3 | 88.697 | 79.965 | 74.730 | 74.730 | 46.468 |
| No Brakes | | | | | |
| Perryman #3 | 83.963 | 82.718 | 62.437 | 62.437 | 37.759 |
| Brakes | | | | | |
| Belgian | 83.049 | 76.730 | 77.631 | 65.879 | 46.933 |
| Block | | | | | |
| No Brakes | | | | | |
| Belgian | 86.072 | 79.676 | 69.429 | 69.429 | 48.794 |
| Block | | | | | |
| Brakes | | | | | |
| Concate- | 82.448 | 77.65 | 71.721 | 72.314 | 72.754 |
| nated | | | | | |

TABLE 56
Error and life prediction for SS model of concatenated data for
various test data sets.

| | Life Estimate | | Errors | |
|---|---|---|---|---|
| | Original | Predicted | | Average Strain |
| Test Data | (hours) | (hours) | Life (%) | (μinch/inch) |

| | | | | |
|---|---|---|---|---|
| Perryman #3 | 1.040E8 | 2.947E8 | 170 | 25.205 |
| No Brakes | | | | |
| Perryman #3 | 7.354E8 | 8.408E8 | 14.33 | 27.923 |
| Brakes | | | | |
| Belgian Block | 3.517E10 | 8.808E10 | 141 | 21.490 |
| No Brakes | | | | |
| Belgian Block | 2.498E10 | 3.895E10 | 56.46 | 22.030 |
| Brakes | | | | |
| Concatenated | 1.612E9 | 1.993E10 | 23.06 | 31.166 |

Using the concatenated model to predict individual fatigue lives had mixed results, as shown in Table 56. The model created using concatenated data performed effectively for some test data sets, but not others. The data sets that had the lowest fatigue life errors were for the training data in the middle of the concatenated data set, these were not the lowest average errors for strain prediction. The life and strain prediction errors were not correlated to each other. The data sets were from different test courses, but the brakes were enabled in both sets with the lowest fatigue life prediction errors. From the results above, it can be seen that the acceleration data for the brakes enabled tests were greater in amplitude. These results show that an optimized iteration process needs to be used in creating the model and/or separate models need to be used, and an algorithm would determine the model to use based on the amplitude of the signal. If one model is to be used, the model (training) data should include as many possible sets of data from separate terrains as possible.

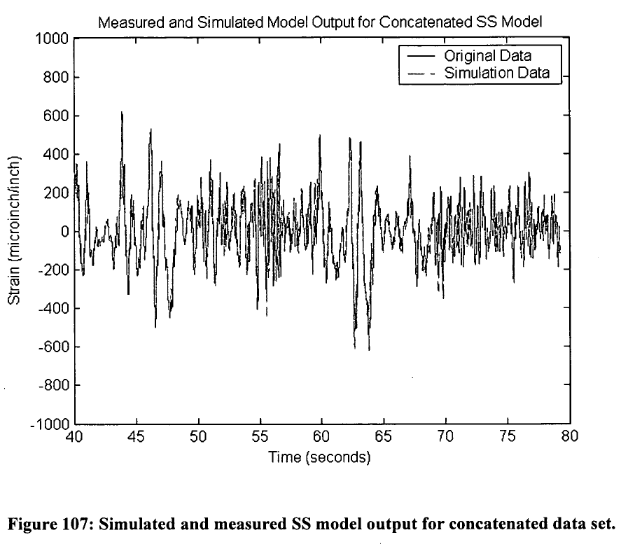

FIG. 107 shows the original and simulated model output for the concatenated model and concatenated test data. This model has an average absolute prediction error of 31.1655 μinch/inch for strain. From the predicted strain we get a life estimation of 1.9934*10⁹ hours, which is 23% different than the life estimate from the test data of 1.6199*10⁹ hours. This error is acceptable for the failure prediction criteria of a 2 mm crack, which is assumed to be 70% of the life until failure.

From this analysis, it has been shown that a dynamic model can be used to predict the strain of a concatenated data set, and therefore the fatigue life from a continuous signal of varying terrain data. The dynamic model is currently not as accurate as the regression model, and should be improved by optimizing the iteration and selection techniques.

It will be understood that various details of the disclosed subject matter may be changed without departing from the scope of the disclosed subject matter. Furthermore, the foregoing description is for the purpose of illustration only, and not for the purpose of limitation.

### List of Abbreviations

deg/sec degrees per. second
ft feet
g's gravity
Hz hertz
ksi thousand pounds per. square inch
mph miles per. hour
psi pounds per. square inch
sec seconds
μinch microinch
μinch/inch microinch per. inch
Accel. Acceleration
ARMAX Auto-Regression Moving Average with eXogenous inputs
ARX Auto-Regression with eXogenous inputs
ATC Aberdeen Test Center
BJ Box Jenkins
CG Center of Gravity
CS Curbside
Cyl. Cylinder
DADS Dynamic Analysis Design System
DRAW Durability and Reliability Analysis Workspace
E Elastic Modulus
FFT Fast Fourier Transform
For. Forward
Fs Sampling Frequency
HMMWV High Mobility Multi-purpose Wheeled Vehicle
HMT High Mobility Trailer
L Longitudinal
Long. Longitudinal
N/A Not Applicable
OE Output Error
PC Principal Component
PCA Principal Component Analysis
Press. Pressure
PSD Power Spectral Density
R² Coefficient of Determination
RMS Root Mean Square
RS Roadside
S-N Stress-Life
SS State-Space
SVD Singular Value Decomposition
T Transverse
Trans. Transverse
V Vertical
Var. Variable
Vert. Vertical
WAFO Wave Analysis for Fatigue and Oceanography

### LIST OF REFERENCES

1. Dowling, N. (1999) ‘Mechanical behavior of materials: engineering methods for deformation, fracture, and fatigue—2nd ed.’, Prentice-Hall.
2. Hines, J. (1998) ‘Principal component analysis’, Class notes from The University of Tennessee.
3. Holt, J., Mindlin H., and Ho C. (1996) ‘Structural Alloys Handbook’, CINDAS/Purdue University
4. Ljung, L. and Glad, T. (1994) ‘Modeling of dynamic systems’, Prentice Hall.
5. Neter, J., Kutner, M., Nachtsheim, C. and Wasserman, W. (1996) ‘Applied linear statistical models-4 ed.’, McGraw-Hill.
6. Press, W. et al. (1992) ‘Numerical Recipes in Fortran: The Art of Scientific Computing-2^{nd} ed.’, Cambridge Press.
7. WAFO Group (2000) ‘WAFO a Matlab Toolbox for Analysis of Random Waves and Loads’, Lund University.

1. A system for determining useful life status of a structure by predicting failure at a specific location on the structure, the system comprising:
(a) one or more sensors placed at one or more selected locations on the structure, the selected locations being apart from the specific location, for generating data signals related to one or more variables measured at the selected locations;
(b) a network for gathering and combining the data signals generated by the one or more sensors; and
(c) a processor for comparing the data signals with a predetermined expected failure value in order to predict failure at the specific location on the structure, thereby determining the useful life status of the structure.

2. The system according to claim 1 wherein the structure is a vehicular trailer including a lunette, drawbar, and a box container portion having front, rear, and road-side and curb-side edges.

3. The system according to claim 2 wherein the sensors are placed on the lunette and drawbar for vertical direction measurement and on the road-side front and curb-side rear edges for longitudinal direction measurement.

4. The system according to claim 1 wherein the sensors are selected from the group consisting of accelerometers, chemical sensors, and piezoceramic sensors.

5. The system according to claim 1 wherein the network is operable to remove data signals deemed to be in error.

6. The system according to claim 5 wherein the network is operable to identify defective sensors that produce the erroneous data signals.

7. The system according to claim 1 wherein the predetermined expected failure value is generated from a linear regression model.

8. The system according to claim 1 wherein the predetermined expected failure value is generated from a ready-made model.

9. The system according to claim 8 wherein the ready-made model is selected from the group consisting of Box-Jenkins, ARX, ARMAX, and Output-Error.

10. The system of claim 1 further comprising a display for observing the data signals and the predetermined expected failure value.

11. The system of claim 10 wherein the display is an oscilloscope.

12. The system of claim 1 further comprising a threshold indicator for producing a warning when the data signals are at least equal to the predetermined expected failure value.

13. The system of claim 12 wherein the indicator produces an audible warning.

14. The system of claim 12 wherein the indicator produces a visual warning.

15. A system for determining useful life status of a structure by predicting failure at a specific location on the structure, wherein the structure is a vehicular trailer including a lunette, drawbar, and a box container portion having front, rear, and road-side and curb-side edges, the system comprising:
(a) sensors placed at selected locations on the structure, the selected locations being apart from the specific location, for generating data signals related to one or more variables measured at the selected locations, wherein the sensors are placed on the lunette and drawbar for vertical direction measurement and on the road-side front and curb-side rear edges for longitudinal direction measurement;
(b) a network for gathering and combining the data signals generated by the sensors, wherein the network is operable to remove data signals deemed to be in error and is operable to identify defective sensors that produce the erroneous data signals;
(c) a processor for comparing the data signals with a predetermined expected failure value in order to predict failure at the specific location on the structure, thereby determining the useful life status of the structure; and
(d) a display for observing the data signals and the predetermined expected failure value.

16. The system according to claim 15 wherein the sensors are selected from the group consisting of accelerometers, chemical sensors, and piezoceramic sensors.

17. The system according to claim 15 wherein the predetermined expected failure value is generated from a linear regression model.

18. The system according to claim 15 wherein the predetermined expected failure value is generated from a ready-made model.

19. The system according to claim 18 wherein the ready-made model is selected from the group consisting of Box-Jenkins, ARX, ARMAX, and Output-Error.

20. The system of claim 15 wherein the display is an oscilloscope.

21. The system of claim 15 further comprising a threshold indicator for producing a warning when the data signals are at least equal to the predetermined expected failure value.

22. The system of claim 21 wherein the indicator produces an audible warning.

23. The system of claim 21 wherein the indicator produces a visual warning.

24. A method for determining useful life status of a structure by predicting failure at a specific location on the structure, the method comprising the steps of:
(a) providing a structure;
(b) placing one or more sensors at one or more selected locations on the structure, the selected locations being apart from the specific location;
(c) generating data signals in relation to one or more variables measured at the selected locations;
(d) gathering and combining the data signals generated by the one or more sensors; and
(e) comparing the data signals with a predetermined expected failure value in order to predict structural failure at the specific location on the structure, thereby determining the useful life status of the structure.

25. The method of claim 24 wherein the structure is a vehicular trailer including a lunette, drawbar, and a box container portion having front, rear, and road-side and curb-side edges and the sensors are placed on the lunette and drawbar for vertical direction measurement and on the road-side front and curb-side rear edges for longitudinal direction measurement.

26. The method of claim 24 wherein the predetermined expected failure value is generated from a linear regression model.

27. The method of claim 24 wherein the predetermined expected failure value is generated from a ready-made model selected from the group consisting of Box-Jenkins, ARX, ARMAX, and Output-Error.

28. The method of claim 24 further comprising the step of displaying the data signals and the predetermined expected failure value.

29. The method of claim 24 further comprising the step of recording the data signals.

30. The method of claim 24 further comprising the step of producing a warning when the data signals are at least equal to the predetermined expected failure value.

31. The method of claim 30 wherein the warning is an audible warning.

32. The method of claim 30 wherein the warning is a visible warning.

33. A method for determining useful life status of a vehicular trailer structure by predicting failure at a specific location on the structure, the method comprising the steps of:
(a) providing a vehicular trailer structure including a lunette, drawbar, and a box container portion having front, rear, and road-side and curb-side edges;
(b) placing sensors at selected locations on the structure, the selected locations being apart from the specific location, wherein the sensors are placed on the lunette and drawbar for vertical direction measurement and on the road-side front and curb-side rear edges for longitudinal direction measurement;
(c) generating data signals in relation to one or more variables measured at the selected locations;
(d) gathering and combining the data signals generated by the one or more sensors;
(e) comparing the data signals with a predetermined expected failure value in order to predict structural failure at the specific location on the structure, thereby determining the useful life status of the structure; and
(f) displaying the data signals and the predetermined expected failure value.

34. The method of claim 33 wherein the predetermined expected failure value is generated from a linear regression model.

35. The method of claim 33 wherein the predetermined expected failure value is generated from a ready-made model selected from the group consisting of Box-Jenkins, ARX, ARMAX, and Output-Error.

36. The method of claim 33 further comprising the step of producing a warning when the data signals are at least equal to the predetermined expected failure value.

37. The method of claim 36 wherein the warning is an audible warning.

38. The method of claim 36 wherein the warning is a visible warning.

39. The method of claim 33 further comprising the step of recording the data signals.
